(19) United States
(12) Patent Application Publication
(10) Pub. No.: US 2009/0187414 A1
(43) Pub. Date: Jul. 23, 2009

(54) METHODS AND APPARATUS TO RECRUIT PERSONNEL

(76) Inventors: Clara Elena Haskins, Safety Harbor, FL (US); Donna Lynn Bluestone, Tarpon Spring, FL (US); Robert Joseph Smith, Oldsmar, FL (US); Kyle Dianne Vallar, Palm Harbor, FL (US); Paul John Lavrakas, Stamford, CT (US); Erik Camayd-Freixas, Miami, FL (US); Pamela Y. Skyrme, Dunedin, FL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/160,183

(22) Filed: Jul. 7, 2008

Related U.S. Application Data
(63) Continuation of application No. PCT/US2007/000810, filed on Jan. 11, 2007.
(60) Provisional application No. 60/757,995, filed on Jan. 11, 2006.
(60) Provisional application No. 60/757,996, filed on Jan. 11, 2006.

(51) Int. Cl. G06Q 10/00; G06Q 50/00; G06F 3/16

(52) U.S. Cl. 705/1; 715/727

(57) ABSTRACT

Methods and apparatus to recruit personnel are disclosed. A disclosed example recruiting system includes an electronic test administrator to present a test to a candidate and to record at least one of the candidate's answers to the test; and a recruiter interface to provide a recruiter with access to the at least one of the candidate's answers, to facilitate manual scoring of the at least one of the candidate's answers and to receive an assessment of the candidate's speaking voice.

### RELATED APPLICATIONS

This patent claims priority from U.S. Provisional Application Ser. No. 60/757,995, which was filed on Jan. 11, 2006, and from U.S. Provisional Application Ser. No. 60/757,996, which was filed on Jan. 11, 2006, and from PCT Application Serial No. PCT/US2007/000810 which was filed Jan. 11, 2007. All are hereby incorporated by reference in their entirety.

### FIELD OF THE DISCLOSURE

This disclosure relates generally to telemarketing and personnel recruiting, and, more particularly, to methods and apparatus to recruit call center personnel for telemarketing and/or personnel recruiting.

### BACKGROUND

Over the years, the telephone has become a common vehicle for commerce. For example, companies and individuals selling products and/or services frequently place telephone calls to other businesses and/or individuals in an effort to make sales. Such activity is commonly referred to as telemarketing. As another example, companies sometimes use the telephone to attempt to recruit additional employees, contractors and/or volunteers. For example, in the audience measurement industry, Nielsen Media Research commonly telephones individuals and/or families in an effort to recruit them to become “Nielsen families.” (Nielsen families are members of an audience measurement panel that have been demographically selected and whom agree to participate in the audience measurement data collection process. The data collected via this process reflects media (e.g., television, radio, Internet, etc.) consumption by one or more populations of interest and can be used to develop ratings for broadcast programming.) The persons placing the calls to the potential Nielsen family is sometimes referred to a as a research interviewer. Other examples of telephone based recruiting abound. For example, career placement recruiters (colloquially referred to as “headhunters”) frequently attempt to recruit professionals such as lawyers from an existing place of employment for placement with another company by cold calling the professional at their current office location.

As telemarketing and telephone based recruiting has become increasingly important in the marketplace, the value of telemarketers, recruiters, research interviewers, and/or telephone operators (collectively and/or individually referred to herein as “call center personnel”) has likewise increased. Accordingly, the ability to locate and hire competent call center personnel has become important to many businesses.

Hiring the wrong person for a call center position is a costly mistake. Selection errors can negatively affect many aspects of the business including time, money, and morale. Additionally there is risk of litigation if selection decisions prove to be discriminatory or biased in any way.

There are many factors that affect whether or not respondents decide to cooperate when they are sampled for a survey. There are also many factors that affect the quality of data that are gathered from cooperative respondents. Past research has shown that among the most influential of these are the (a) topic of the survey, (b) length of the interview, (c) mode of contact, (d) confidentiality guarantees, (e) use of non-contingent and contingent incentives, (f) number of contacts made, (g) whether or not efforts are made to convert initial refusals, and (h) quality of the interviewing staff in interviewer-administered surveys.

On the latter point, it has long been recognized that the ability of the interviewers who work on telephone survey research projects plays a major role in determining the quality of the data that are gathered. Poor quality telephone interviewers can increase non-response (and thereby non-response error) by generating many more refusals than completions. They also can increase measurement error by not properly administering the questionnaire. This has led some to suggest that hiring high caliber telephone interviewers, despite the greater expense that may be incurred, is truly a cost-effective practice from a total survey error perspective. Certainly, hiring “the best” quality telephone interviewers one's budget allows for is a goal all telephone survey researchers can embrace.

The increasingly difficult nature of conducting telephone research has highlighted the importance of employing effective telephone interviewers. An increased array of technological obstacles, such as answering machines, voice mail, privacy manager, etc., and the reluctance of the public to participate in research (due to privacy concerns, telephone scams, large number of telemarketing calls, etc.), forces research organizations to make the most of a contact with a respondent. Additionally, there are real costs associated with hiring ineffective interviewers; not only wasted wages and training, but also in the loss of cooperative respondents, who otherwise might have participated had they been contacted by a higher caliber interviewer. These challenges require a larger sample of numbers to reach target sample sizes. And, subsequent contacts to households that have previously refused to participate are less likely to result in a completed survey than are re-contacted households that never refused.

Many research organizations hire telephone interviewers through a series of personal and/or telephone interviews and by having candidates read sample scripts.

### BRIEF DESCRIPTION OF THE DRAWINGS

FIG. 1 is a schematic illustration of an example recruiting system to recruit call center personnel shown in an example environment of use.

FIG. 2 is a more detailed illustration of the example recruiting system of FIG. 1.

FIG. 3 is a screen shot of an example login interface that is displayed by the example recruiting system of FIGS. 1 and 2.

FIG. 4 is a screen shot of an example voice and speech prescreening interface that is displayed by the example recruiting system of FIGS. 1 and 2.

FIG. 5 is a screen shot of an example session setup interface that is displayed by the example recruiting system of FIGS. 1 and 2.

FIG. 6 is a screen shot of an example applicant test scheduling interface that is displayed by the example recruiting system of FIGS. 1 and 2.

FIG. 7 is a screen shot of an example summary interface that is displayed by the example recruiting system of FIGS. 1 and 2.

FIG. 8 is a screen shot of an example details interface that is displayed by the example recruiting system of FIGS. 1 and 2.

FIG. 9 is a screen shot of an example background check interface that is displayed by the example recruiting system of FIGS. 1 and 2.

FIG. 10 is a screen shot of an example interview interface that is displayed by the example recruiting system of FIGS. 1 and 2.

FIG. 11 is a screen shot of an example offer interface that is displayed by the example recruiting system of FIGS. 1 and 2.

FIG. 12 is a screen shot of an example typing test assessment interface that is displayed by the example recruiting system of FIGS. 1 and 2.

FIG. 13 is a screen shot of an example written test scoring interface that is displayed by the example recruiting system of FIGS. 1 and 2.

FIG. 14 is a screen shot of an example listening scoring interface display that is displayed by the example recruiting system of FIGS. 1 and 2.

FIGS. 15A-15B are screen shots of an example oral reading evaluation interface that is displayed by the example recruiting system of FIGS. 1 and 2.

FIGS. 16A-16B are a screen shot of an example oral persuasion evaluation interface that is displayed by the example recruiting system of FIGS. 1 and 2.

FIG. 17 is a flowchart representative of example machine executable instructions that may be executed to implement the example recruiting system of FIGS. 1 and 2.

FIGS. 18A-18B are a flowchart representative of example machine executable instructions that may be executed to implement the example typing test routine of FIG. 17.

FIGS. 19A-19B are a flowchart representative of example machine executable instructions that may be executed to implement the example English written test routine of FIG. 18B.

FIG. 20 is a flowchart representative of example machine executable instructions that may be executed to implement the example personality inventory test routine of FIG. 19B.

FIGS. 21A-21B are a flowchart representative of example machine executable instructions that may be executed to implement the example English oral reading test routine of FIG. 20.

FIGS. 22A-22B are a flowchart representative of example machine executable instructions that may be executed to implement the example English listening test routine of FIG. 21B.

FIGS. 23A-23C are a flowchart representative of example machine executable instructions that may be executed to implement the example English oral persuading test routine of FIG. 22B.

FIGS. 24A-24D are flowcharts representative of example machine executable instructions that may be executed to implement the example voice and speech prescreening routine of FIG. 17.

FIG. 24E is a flowchart representative of example machine executable instructions that may be executed to implement the example menu routine of FIG. 24D.

FIG. 25 is a flowchart representative of example machine executable instructions that may be executed to implement the example session setup routine of FIG. 24C.

FIGS. 26A-26B are a flowchart representative of example machine executable instructions that may be executed to implement the example scheduler routine of FIG. 24D.

FIG. 27 is a flowchart representative of example machine executable instructions that may be executed to implement the example summary routine of FIG. 24E.

FIGS. 28A-28D are a flowchart representative of example machine executable instructions that may be executed to implement the example details routine of FIG. 24E.

FIG. 29 is a flowchart representative of example machine executable instructions that may be executed to implement the example typing test assessment routine of FIG. 28A.

FIG. 30 is a flowchart representative of example machine executable instructions that may be executed to implement the example written test assessment routine of FIG. 28A.

FIG. 31 is a flowchart representative of example machine executable instructions that may be executed to implement the example oral reading test assessment routine of FIG. 28B.

FIG. 32 is a flowchart representative of example machine executable instructions that may be executed to implement the example oral persuading test assessment routine of FIG. 28C.

FIG. 33 is a flowchart representative of example machine executable instructions that may be executed to implement the example English listening evaluation routine of FIG. 28C.

FIGS. 34A-34B are a flowchart representative of example machine executable instructions that may be executed to implement the example interview routine of FIG. 24E.

FIGS. 35A-35B are a flowchart representative of example machine executable instructions that may be executed to implement the example background check routine of FIG. 24E.

FIG. 36 is a flowchart representative of example machine executable instructions that may be executed to implement the example offers routine of FIG. 24E.

FIG. 37 is a schematic illustration of an example processor platform that may be used and/or programmed to execute the example machine readable instructions represented by FIGS. 17-36 to implement the example recruiting system of FIG. 1 and/or FIG. 2.

### DETAILED DESCRIPTION

### Overview

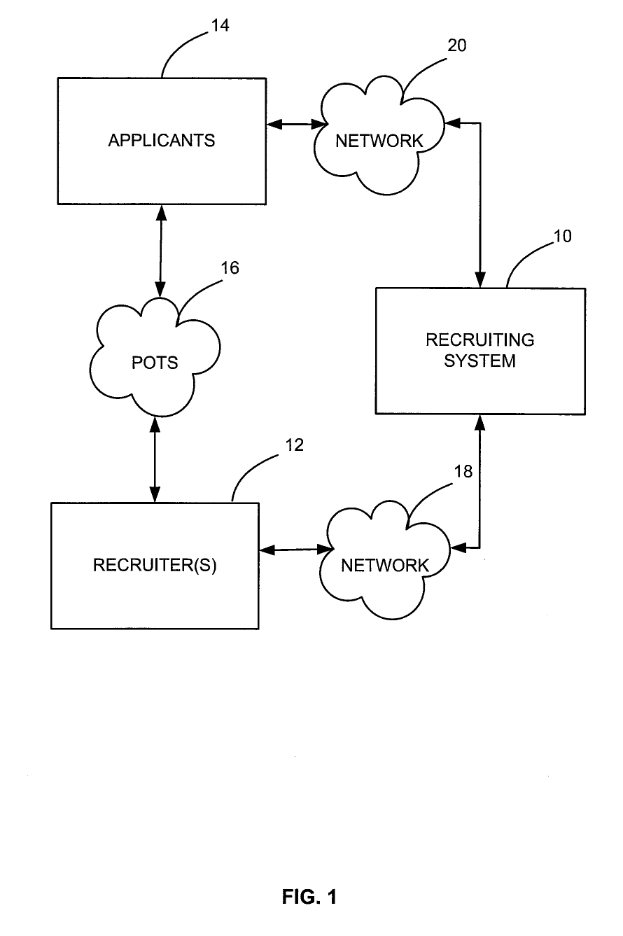

FIG. 1 is a schematic illustration of an example recruiting system 10 to recruit call center personnel shown in an example environment of use. The example recruiting system of FIG. 1 provides an automated system for assessing the capabilities of applicants for one or more call center recruiting and/or marketing positions. The recruiting system 10 of the illustrated example ensures applicants are assessed in a uniform and objective manner, thereby improving the process of hiring call center personnel.

In the example of FIG. 1, one or more recruiter(s) 12 interact with the recruiting system 10 to evaluate one or more applicant(s) 14 for one or more call center recruiting/marketing positions. As shown in FIG. 1, the recruiter(s) 12 can interact with the applicant(s) 14 directly via a communication system. In the example of FIG. 1, this direct communication is by telephone, for example, via the plain old telephone system (POTS) 16. However, persons of ordinary skill in the art will readily appreciate that this communication could additionally or alternatively be via an alternative telecommunication system such as a voice over Internet Protocol system (VoIP) and/or a cellular phone system. Such persons will also appreciate that the direct communication between recruiter(s) 12 and applicant(s) 14 can additionally or alternatively be conducted via other communication mediums such as traditional mail, electronic mail (email), etc.

In the illustrated example, the recruiter(s) 12 are able to interact with the recruiting system 10 via an electronic communication medium. For example, the recruiter(s) 12 may communicate with the recruiting system 10 using a communication device that is communicatively coupled to the recruiting system 10 via, for example, a public network such as the Internet, a local network, a dedicated connection, a cable system, a wireless connection (e.g., a local WiFi (e.g., Bluetooth) connection and/or a cellular network), etc. Although in the example of FIG. 1, the communication device(s) of the recruiter(s) 12 are illustrated as being communicatively connected to the recruiting system 10 through a network 18, persons of ordinary skill in the art will readily appreciate that the communication device(s) of the recruiter(s) 12 may alternatively or additionally be connected directly to the recruiting system 10 and/or the recruiting system 10 could be resident on the recruiter's communication device. In the illustrated example, the communication device(s) of the recruiter(s) 12 are implemented by personal computer(s), but persons of ordinary will readily appreciate that other communication devices such as, for example, work stations, personal digital assistants (PDAs), Blackberry's, cell phones, laptops, etc. can additionally or alternatively be used in this role.

In the illustrated example, the applicant(s) 14 are also able to interact with the recruiting system 10 via an electronic communication medium. For example, the applicant(s) 14 may communicate with the recruiting system 10 using a communication device that is communicatively coupled to the recruiting system via, for example, a public network such as the Internet, a local network, a dedicated connection, a cable system, a wireless connection (e.g., a local WiFi (e.g., Bluetooth) connection and/or a cellular network), etc. Although in the example of FIG. 1, the communication device(s) of the applicant(s) 14 are illustrated as being communicatively connected to the recruiting system 10 through a network 20, persons of ordinary skill in the art will readily appreciate that the communication device(s) of the applicant(s) 14 may alternatively or additionally be connected directly to the recruiting system 10. In the illustrated example, the communication device(s) of the applicant(s) 14 are implemented by personal computer(s), but persons of ordinary will readily appreciate that other communication devices such as, for example, work stations, personal digital assistants (PDAs), Blackberry's, cell phones, laptops, etc. can alternatively or additionally be used in this role.

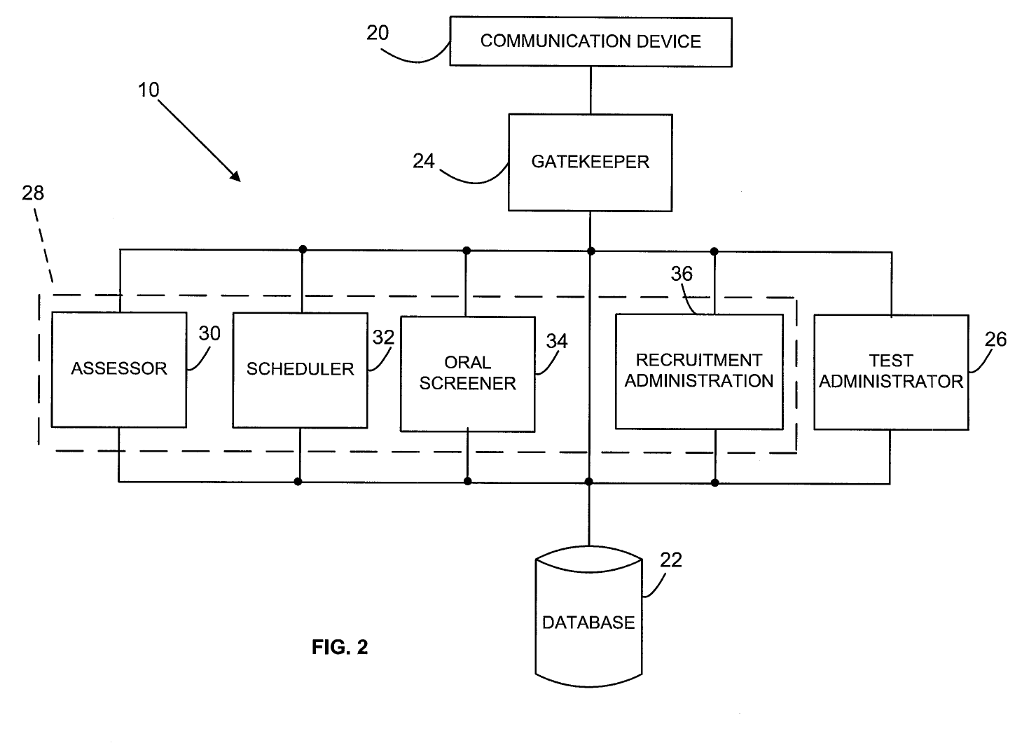

The example recruiting system 10 of FIG. 1 is shown in greater detail in FIG. 2. As mentioned above, the recruiting system 10 of the illustrated example is structured for electronic communication with one or more recruiter(s) 12 and/or one or more applicant(s) 14. To this end, the example recruiting system 10 includes a communication device 20. The communication device 20 can be implemented in any desired fashion. For example, it can be implemented by a modem or network interface card.

The example recruiting system of FIG. 2 includes a database 22 to store data collected concerning one or more applicant(s) 14 for the position(s) of interest. Because this data will likely be confidential, in the illustrated example, access to the database 22 or portions thereof is controlled by a gatekeeper 24. The gatekeeper 24 of the illustrated example authenticates users (i.e., applicant(s) 14 and/or recruiter(s) 12) and limits access to the data in the database 22 based on the authenticated identity of the user seeking the access. For example, the gatekeeper 24 of the illustrated example enforces a password protected security system that limits permissions of users in accordance with a predetermined security protocol. For example, a recruiter 12 may only be permitted to access the records of certain applicant(s) 14 (e.g., the applicant(s) 14 assigned to that particular recruiter 12 for evaluation), a recruiter 12 and/or system administrator may be able to access all of the data in the database 22, and/or an applicant 14 may only be able to access the database 22 indirectly (e.g., by taking tests, filling out forms, etc.).

As mentioned above, the recruiting system 10 provides a vehicle for evaluating and distinguishing between applicants 14 for a call center recruiting or telemarketing position. To this end, the recruiting system 10 is structured to administer one or more tests of skills relevant to the position at issue, to automatically grade/score at least some of those tests, to provide a portal for manual grading the results of at least some of those tests, and to compile the application materials (including the graded test materials) to facilitate hiring decisions. The tests, grading mechanisms and application materials of the recruiting system 10 are selected to correspond to the position of interest. For example, call center personnel require a collection of specific skills to be effective, including, for example, verbal skills, reading and/or writing skills, keyboard/typing aptitude, and an appropriate phone personality. In the illustrated example, the recruiting system 10 is structured to facilitate the hiring of one or more applicant(s) 14 meeting these requirements. Thus, the recruiting system 10 of the illustrated example is structured to facilitate (1) voice and speech prescreening of applicant(s) 14, (2) a typing skills assessment of applicant(s) 14, (3) one or more written tests in one or more languages (e.g., English, Spanish, etc.) to test proficiency of reading written questions, (4) a personality assessment of applicant(s) 14, and (5) an oral skills assessment of applicant(s) 14.

In the illustrated example, voice and speech prescreening is conducted during an initial telephone screening call between a recruiter 12 and an applicant 14. This prescreening assessment provides an objective method of assessing voice and speech skills to pre-screen a pool of applicants 14 to be brought in for further recruitment screening. To this end, and as explained in further detail below, the recruiting system 10 provides an interface for the recruiter 14 to grade the applicant's voice and speech characteristics during the call.

In the illustrated example, the typing skills assessment is performed to determine if an applicant 14 has the minimum familiarity with a computer keyboard required for the position at issue. For instance, in the illustrated example, a typing skills test could be used to determine if the applicant 14 has sufficient skills to enter respondents' names and addresses correctly. Other skills and/or levels of skill may alternatively be tested. For example, a typing rate (e.g., words per minute) could be tested.

In the illustrated example, the written tests are multiple-choice assessments to determine if an applicant 14 has the necessary reading comprehension skills to communicate effectively with respondents (e.g., via the telephone). After successful completion of the other assessments, the illustrated recruiting system 10 permits a bilingual applicant to complete a second written test in a second language such as Spanish.

In the illustrated example, the personality assessment is a questionnaire to determine if an applicant's aptitudes and characteristics indicate a good fit for the position at issue. This assessment is based on characteristics found to be most relevant for the position of interest and most likely to predict success on that particular job.

The oral skills assessment includes one or more audio recorded tests structured to determine if an applicant 14 has the necessary listening and/or speaking skills to communicate effectively via the telephone. The test(s) may be structured to test for particular speaking skills. For instance, in the illustrated example, the oral test(s) are structured to record the applicant's speaking voice to facilitate evaluation of the applicant's ability to explain and the applicant's persuasiveness. After successful completion of the other assessments including one or more English oral tests, a bilingual applicant can complete one or more second language oral tests (e.g., Spanish, German, etc.).

In the illustrated example, if the applicant reaches the manual scoring level, the English oral tests are scored first. If the applicant 14 is “Recommended” (i.e., successfully passes the English oral test), then the recruiter 12 scores the second language oral tests.

In the illustrated example, the above noted assessments are administered in the order listed above, namely, 1) voice and speech prescreening, 2) typing skills assessment, 3) written tests, 4) personality tests, and then 5) oral tests. However, persons of ordinary skill in the art will readily appreciate that the order may be changed, assessments may be added, and/or assessments may be eliminated to suit the particular application.

In the illustrated example, and as explained in further detail below, the written tests (i.e., the English and the second language test(s)) are multiple-choice and are scored automatically by the recruiting system 10. Similarly, the personality inventory is a multiple choice test that is automatically scored. However, in the illustrated example, the voice and speech prescreening, the typing test and the oral tests are at least partially manually scored by a recruiter 12.

After completion of the above tests, the recruiting system 10 of the illustrated example lists the recommended applicants 14 for personal interview. The recruiter(s) 12 then interview the applicant(s) 14 and input the interview details into the system 10. The interview details indicate whether the interviewed applicant in question is recommended or not recommended, and also indicates whether the applicant requires a background check. Those applicants 14 requiring a background check are automatically listed in a background check display. The applicants 14 that are recommended upon completion of the background checks are listed in an offer display.

### Example Implementation

Turning in more detail to FIG. 2, the recruiting system 10 of the illustrated example includes two general components, namely, a testing administrator 26 and a recruiter interface 28. The test administrator 26 is the portion of the recruiting system 10 with which the applicant(s) 14 interact. In particular, the test administrator 26 of the illustrated example administers the various tests that applicant(s) 14 must take during the recruitment process.

The recruiting interface 28 is the portion of the recruiting system 10 that the recruiter 12 interacts with either separately from, or while communicating with, the applicant(s) 14. The recruiter interface 28 of the illustrated example facilitates and at least partially automates the tasks of the recruiter 12. As shown in FIG. 2, the recruiter interface 28 of the illustrated example includes an assessor 30, a scheduler 32, an oral screener 34 and a recruitment administrator 36.

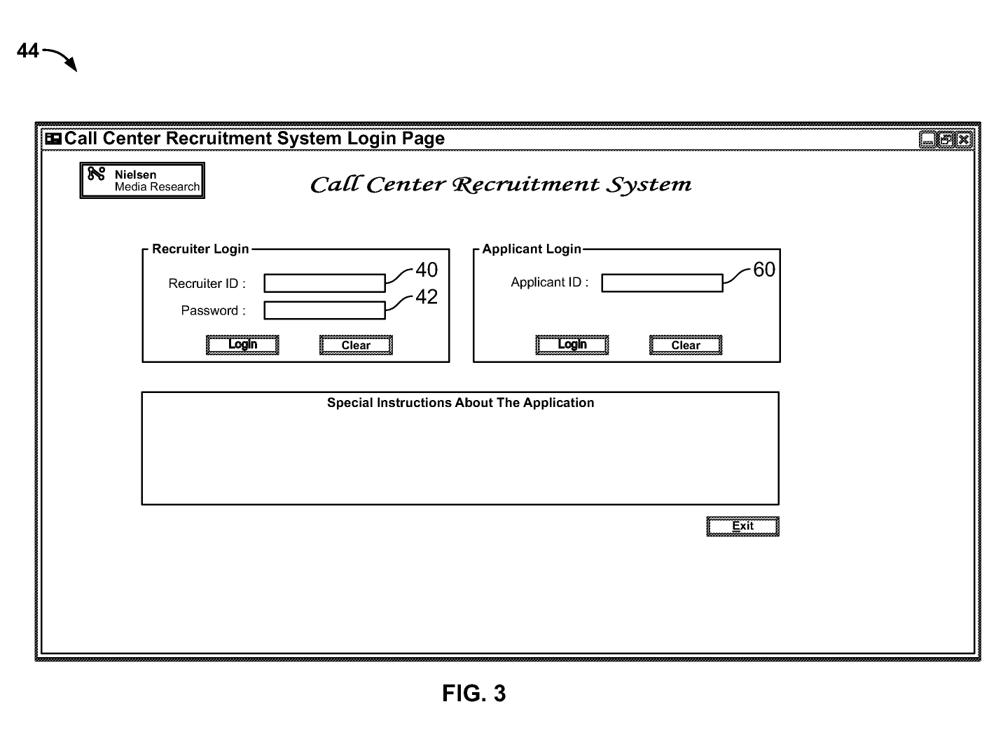

In the illustrated example, the recruiting process begins when a recruiter 12 logs into the system 10. For example, the recruiter 12 logs into the illustrated example recruiting system 10 by entering a recruiter identification code and a password into the recruiter identification field 40 and the password field 42 of the example login interface screen 44 shown in FIG. 3. The gatekeeper 24 compares the entered login information to the login information stored in the database 22 to verify the identity of the recruiter 12 and to set the access permissions for the interaction with the recruiter 12.

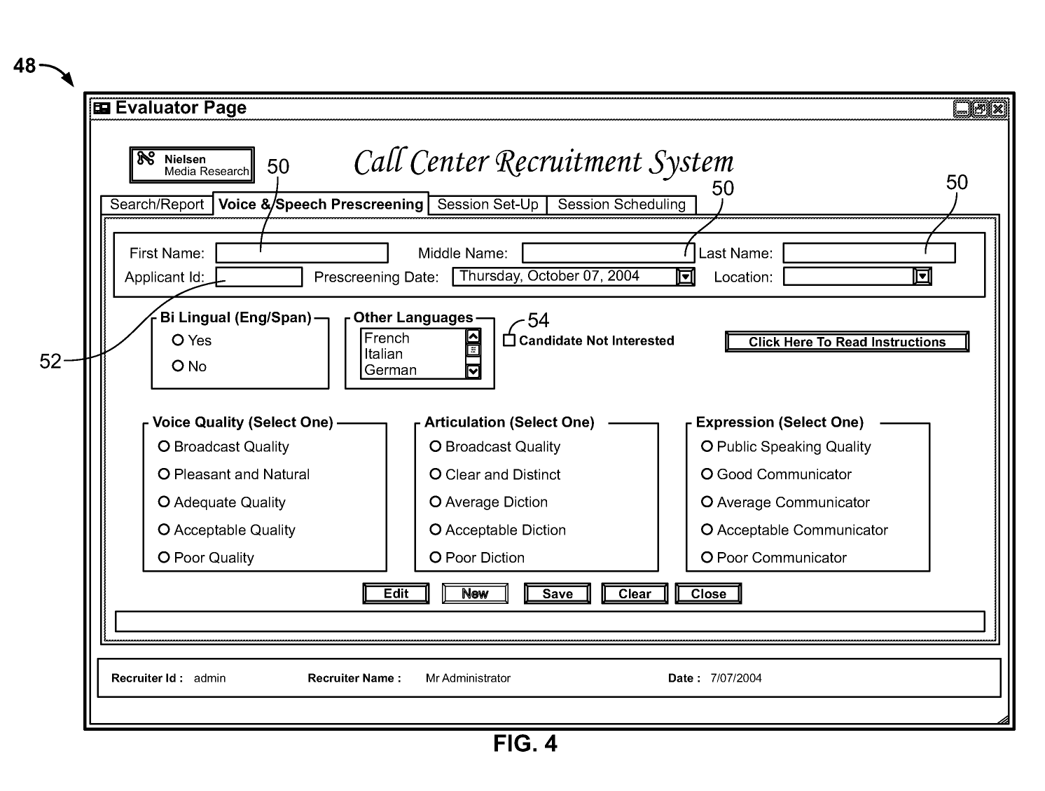

After the gatekeeper 24 authenticates the recruiter 24, the recruiting administrator 36 displays a voice and speech prescreening screen such as the example voice and speech prescreening screen 48 shown in FIG. 4 to enable the recruiter 12 to enter a new applicant 14 into the recruiting system 10. Assuming, for purposes of discussion, that the recruiter 12 enters a new applicant into the system 10 by, for example entering the name of the new applicant 14 into appropriate name field(s) 50 of the voice and speech prescreening screen 48, the recruiting administrator 36 assigns a unique applicant identification code (e.g., an alphanumeric number) to the new applicant 14 and creates a record corresponding to the new applicant 14 in the database 22. The voice and speech prescreening screen 48 can then be used to complete a pre-screening evaluation of the applicant 14.

If the recruiter 12 wishes to access information about an existing applicant 14, the recruiter 12 may enter the applicant's identification number into the applicant id field 52 of the voice and speech prescreening interface 48, or may enter some or all of the names of the applicant 14 into the corresponding name fields 50. The recruitment administrative 36 will then search the database 22 for matching records.

### Voice and Speech Prescreening Assessment

The purpose of the voice and speech prescreening assessment is to provide a substantially objective and uniform way to pre-select a pool of applicants 14 for further recruitment screening. This initial contact between the recruiter 12 and the applicant 14 takes place over the telephone via, for example the POTS 16. Based on this brief telephone conversation, the recruiter 12 will (1) assess the applicant's voice and speech skills, and (2) gather information regarding the applicant 14. The voice and speech prescreening assessment is preferably completed by the recruiter 12 during the call and/or immediately after the call. With respect to assessing the applicant's voice and speech skills, in the illustrated example the recruiter 12 assesses if the applicant: (1) has a good voice (referred to herein as “voice quality”), (2) has diction or pronunciation that is clear and easy to understand (referred to herein as “articulation”), and (3) has adequate facility to express himself or herself (referred to herein as “expression”). Each of these factors (i.e., voice quality, articulation, and expression), is separately evaluated and scored.

As used herein, “voice quality” refers to those aspects of the voice that make it pleasant or unpleasant to a listener. Generally, these aspects include pitch (tone), volume, clarity, and resonance. Even though these features can be consciously controlled to a greater or lesser extent for some period of time, most people will forget to regulate these voice characteristics after awhile and will routinely go back to their old speech habits. Excess in any of these traits results in a voice that sounds affected and unnatural. The voice and speech prescreening interface 48 enables the recruiter 12 to note any trait so excessive as to render the voice too affected or unpleasant for the call center position. In the example of FIG. 4, such notation is performed by selecting a category (e.g., poor quality, acceptable quality, adequate quality, pleasant and natural and/or broadcast quality) corresponding to the perceived voice quality of the applicant 14.

Pitch (tone)—A voice can be excessively high-pitched (strident) and, thus, sound irritating, screechy, piercing, even aggressive. More rarely, a voice can be excessively low-pitched (orotund) and sound ghostly and menacing. The desired pitch for the typical call center position is moderate, flexible and somewhat varied so as to be meaningfully expressive but natural and sincere sounding. The desired pitch for the typical call center position is neither exaggerated nor monotonous.

Volume (force)—The desired volume of the voice of a call center employee is neither too soft (meek) nor too loud (boisterous). The combination of high pitch and soft volume results in a childish or “juvenile” voice, devoid of authority and, therefore, lacking persuasiveness. The combination of low pitch and high volume may sound authoritarian, bullish, impatient, and too pushy, instead of persuasive.

Clarity & Resonance—Whether by habit or organic impediment, a voice's clarity and resonance can also be compromised. Clarity and resonance depend on each other, but they are somewhat different. Clarity problems may result in a voice that is excessively or unpleasantly harsh, hoarse, raspy, or throaty (pronouncing in the back of the throat). Resonance problems may result in a voice that is excessively or unpleasantly nasal or muffled; breathy and whispery (like “Marilyn Monroe”) or the opposite—starved of air. Ideally, the voice of a call center employee should sound clear, crisp, and bright.

“Articulation” refers to diction and pronunciation. The aspects of articulation relevant to the typical call center position are clarity, contrast, and pace (both speed/rate of speech, and rhythm, including phrasing and pauses). It does not typically matter whether one has a foreign or regional accent. The issue for most call center positions is whether the listener must strain too much in order to understand the speech.

Clarity & Contrast—Good articulation is clear, sharp, distinct, and easy to understand. No vowel or consonant sounds are omitted, added, substituted, or distorted. There is adequate contrast between similar or neighboring syllables and sounds. Pronunciation is correct but natural, not exaggerated or overly precise. Poor articulation may be slurred, mumbled, indistinct, imprecise, incorrect, and unclear. If the listener must strain to understand the applicant 14, the applicant 14 is exhibiting “poor diction” under the articulation evaluation.

Pace—The pace of speech may be too fast or jerky (fast in spurts), or may be exasperatingly slow and without energy. The pace of speech for the typical call center position should be smooth, and of moderate speed. Such speech should follow a natural and meaningful rhythm of intonation and stress, otherwise it may be perceived as either monotonous or patterned (sing-song) speech. Phrases used by the call center speaker should be smooth and complete, with the pauses in the right place. In the example of FIG. 4, the recruiter 12 notes the articulation quality of the applicant's voice by selecting a category (e.g., poor diction, acceptable diction, average diction, clear and distinct, and/or broadcast quality) corresponding to the perceived voice quality of the applicant 14 in the articulation section of the voice and speech prescreening interface 48.

“Expression” refers in this context to the ability to communicate properly (grammatically), fluidly (articulately), and with natural emphasis and energy (enthusiasm). The desired expression for the typical call center position is engaging, dynamic, eloquent, correct, precise, and intelligent. It should not sound apathetic (tired, bored, irritated), ungrammatical, substandard, imprecise, unclear, stumbling and/or inarticulate. In the example of FIG. 4, the recruiter 12 notes the expression quality of the applicant's voice by selecting a category (e.g., poor communicator, acceptable communicator, average communicator, good communicator, and/or public speaking quality) corresponding to the perceived voice quality of the applicant 14 in the expression section of the voice and speech prescreening interface 48.

Using the above criteria, the recruiter 12 enters their assessment of the applicant's voice and speech skills into the voice and speech prescreening interface 48 provided by the recruitment administrator 36. In the illustrated example, the recruiter 12 scores the applicant 14 on the characteristics of voice quality, articulation and expression as discussed above. The recruiter's scores are assigned values from 1-5.

The assessor 30 of the example recruitment system 10 uses the numeric values corresponding to the entries of the recruiter 12 to compute a voice and speech prescreening score for the applicant 14. This score may be computed, for example, by computing a weighted or unweighted average of the numeric criteria scores entered by the recruiter 12 into the voice and speech prescreening interface 48. By comparing this voice and speech prescreening score to a threshold, the assessor 30 can then provide an automatic recommendation as to whether or not the applicant 14 is permitted to advance further in the recruiting process. If the applicant's pre-screening score is too low (i.e., less than the threshold), the applicant 14 will not be invited for further testing. If the applicant's pre-screening score is sufficiently high, the assessor 30 displays a message to the recruiter 12 indicating that the applicant 14 should be scheduled for testing.

It is, of course, possible that the applicant 14 will indicate during the initial voice and speech pre-screening that he/she is uninterested in the position. The recruiter 12 can set a “candidate not interested” field of the voice and speech prescreening interface 48 if the applicant 14 is not interested in taking further tests.

### Test Scheduling

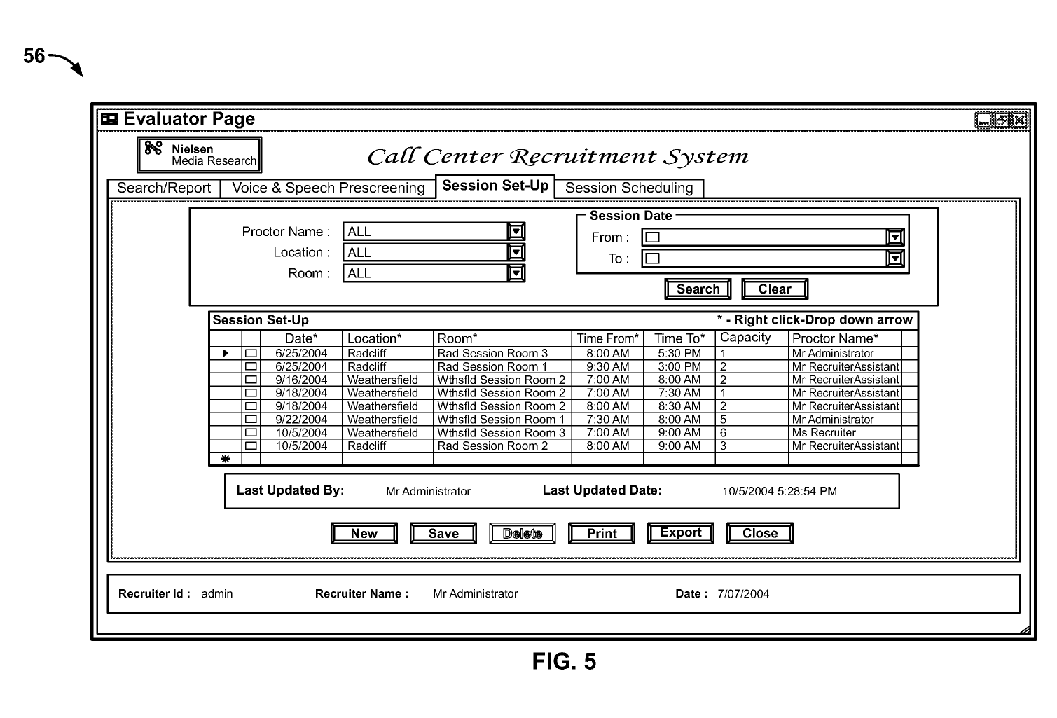

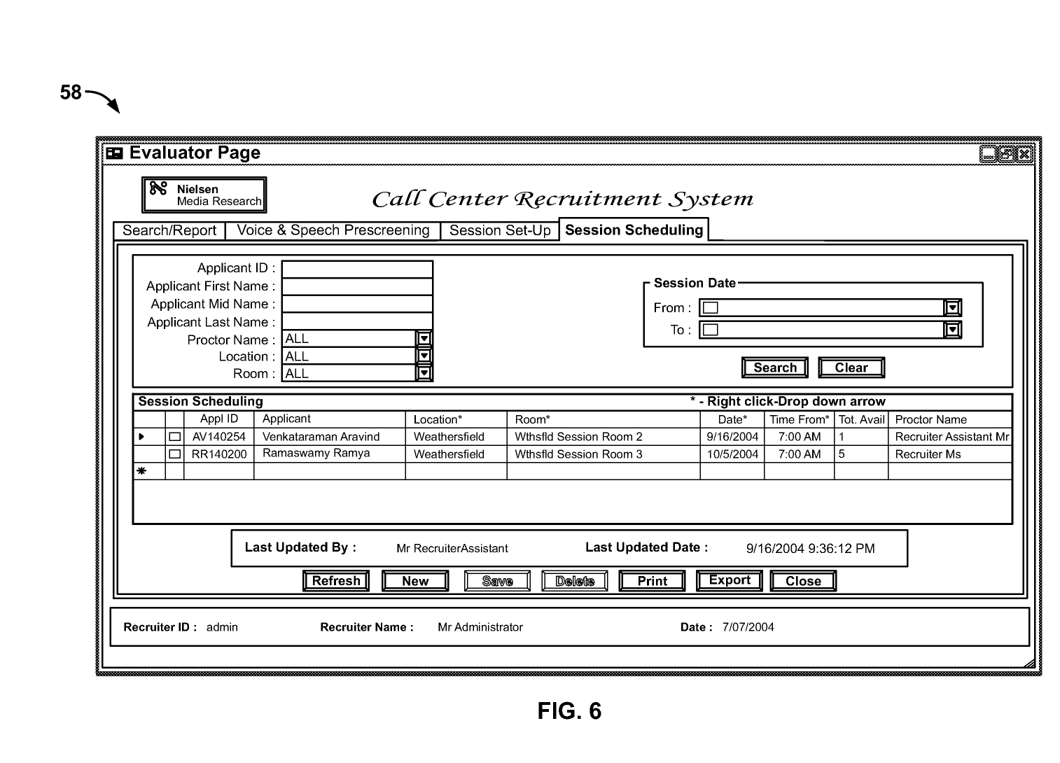

Assuming, for purposes of discussion, that the applicant's overall voice and speech pre-screening score are sufficiently high (i.e., above the threshold) to merit further testing, in the illustrated example, the recruiter 12 may wish to access a session set-up interface (e.g., the example session set-up interface 56 of FIG. 5) and/or an applicant test scheduling interface (e.g., the example applicant test scheduling interface 58 of FIG. 6), both of which are provided by the scheduler 32 of the recruiting system 10. The example session set-up interface 56 of FIG. 5 assists the recruiter 12 with the logistics of creating and setting the parameters of a test session. For example, the recruiter 12 is able to set and/or adjust the times, locations and capacities (i.e., number of permitted applicants 14) of new and/or existing test sessions and/or to assign proctors to administer tests at those test sessions. On the other hand, the example applicant test scheduling interface 58 of FIG. 6 enables the recruiter 12 to assign applicant(s) 14 to scheduled test sessions that are not already filled to capacity.

### Testing

Once the applicant 14 is scheduled for a test session, the recruiter 12 terminates the phone call and does nothing further with respect to that applicant 14 until the applicant 14 completes the necessary tests. The interested applicant 14 will then attend the scheduled test session where the applicant 14 will take a series of standardized tests under the supervision of a proctor. Although in the illustrated example, the tests are supervised and, thus, occur at specific test locations, persons of ordinary skill in the art will recognize that the tests could alternatively be administered remotely via computer, with or without supervision. In the illustrated example, the following tests are administered: (1) a typing test, (2) an English written test, (3) a personality inventory test, (4) an English oral reading test, (5) an English oral listening test, (6) an English oral persuading test, and, if the applicant 14 is bilingual, (7) a Spanish written test, (8) a Spanish oral reading test, (9) a Spanish oral listening test, and (10) a Spanish oral persuading test (although another language could be substituted for Spanish and/or English, if desired).

In the illustrated example, the tests are administered by the test administrator 26 of the recruiting system 10. As noted above, in the illustrated example, this is done by providing the applicant 14 with access to a personal computer which is located at a supervised facility and which is communicatively coupled to the recruiting system 10. Therefore, to initiate the tests, the proctor logs the applicant into the system 10 via the login interface 44 of the gatekeeper 24. For example, the applicant 14 can be logged in by entering the applicant's identification number into the Applicant Id field 60 of the example login interface 44 of FIG. 3. In the illustrated example, the personal computer includes a headset which enables the applicant 14 to hear played recordings and which includes a microphone to record voice responses of the applicant 14. If remote testing is permitted, the applicant 14 would log himself/herself into the system.

### Typing Test

Once the applicant 14 is logged in, the typing test is initiated. The typing test is used to evaluate the typing skills of the applicant 14. This assessment is designed to screen out those applicants who lack basic keyboard familiarity to such a degree that their skill deficiency is not likely to be remedied by a few days' training. It is also a measure of complex cognitive skills requiring the ability to follow directions, listen, type, and remember auditory information. It is therefore included in the overall composite score for the assessment battery.

The example test administrator 26 of the example recruiting system first displays an instruction page to explain the test to the applicant 14. In the illustrated example, the instructions are also provided to the applicant via the headset by playing a predetermined audio file. The instructions presented to the applicant in the illustrated example are listed in the following paragraph:

“Instructions to the applicant: This is a short test to see how you type and how familiar you are with the computer keyboard. Pretend that you are getting a person's name and address on the phone. Start typing as soon as you hear each name and address, and try to type was much of it as possible. The names of persons, streets, and cities (but not states) will be spelled. You can type-in either the full name of the state or an accepted abbreviation, whichever you prefer. For example, “Florida,” “FL,” and “Fla.” are all correct. First, there will be one practice address that does not count in the scoring. You will hear each address and the spelling once. Then, the address will be repeated a second time but not spelled. You cannot take hand-written notes. This is a pre-recorded test that lasts only a few minutes. Once the test begins, the recording will not be stopped or replayed.”

Once the instruction audio file has played completely, the test administrator 26 displays a START button. When the applicant 14 clicks the START button (e.g., by selecting it with a point and click input device such as a mouse or touchpad), the test administrator 26 displays the typing test interface on the computer being used by the applicant 14.

In the illustrated example, the typing test interface provides an address entry field wherein, using a keyboard, the applicant 14 can type in a name and address that is audibly played via the headset, but not displayed on the typing test page.

In the illustrated example, a voice recording reciting a sample address is first played in the hearing of the applicant 14 and the applicant 14 is instructed to type the sample address into the address entry field as practice for the following test. A few seconds after the audio stops playing, the input field is locked so that no further entries are accepted and the correct address is displayed in the “Correct Address” box of the typing test interface adjacent the address entry field. The applicant 14 is, thus, provided with a sample of how the address should be typed.

The typing test then proceeds similarly to the practice example explained above. In the illustrated example, the typing test includes four addresses. The applicant 14 is expected to type an audibly spoken name and address (heard through, for example, the headset) as correctly as possible within a given time period. The names and addresses are pre-recorded in voices of different regional and ethnic accents. The test administrator 26 of the illustrated recruiting system 10 automatically saves the typed answer of the applicant 14 into the database 22 once the allocated time is over. After the entered data is saved, the test administrator 26 displays a pop-up message asking if the applicant is ready to proceed to the next portion of the test. By clicking an OK button associated with the pop-up message, the applicant 14 can automatically proceed to the next portion of the test. In other implementations, the typing test is timed as a whole, not on a question by question basis. Once all of the addresses are played and the applicant's answers are recorded, the applicant 14 is asked to proceed to the next test session by selecting an appropriate button.

### English Written Test

In the illustrated example, upon completion of the typing test, the test administrator 26 administers an English written test to the applicant 14. The English written test of the illustrated example is structured to evaluate the cognitive skills of the applicant 14. Unlike most language assessments, which only test for correctness of grammar, vocabulary, and usage, the English written test of the illustrated example also measures higher communicative functions like grasping underlying, connotative, or implicit meaning, and selecting responses with the highest order of cultural, professional, public relations, and business propriety. This part of the assessment focuses on reading comprehension, syntax manipulation, semantic inference, communicative decision making, and response appropriateness. In the illustrated example, content is based on authentic job-related materials, which have been modified to include specific target structures. As such, it ultimately measures readiness for learning and for successful job performance

Upon initiation of the English written test, the test administrator 26 of the recruiting system first displays an instruction page to explain the test to the applicant 14. In the illustrated example, the instructions are also provided to the applicant via the headset by playing a predetermined audio file. Once the instruction audio file has played completely, the test administrator 26 displays a START button. When the applicant 14 clicks the START button (e.g., by selecting it with a point and click input device such as a mouse or touchpad), the test administrator 26 displays the English written test interface on the computer being used by the applicant 14.

In the illustrated example, the English written test contains twenty multiple choice questions. The applicant 14 is expected to choose what he/she believes to be the correct answer for each question within a set time frame (e.g., 20 minutes). In the illustrated example, the time remaining to complete the test is displayed to the applicant in the top right corner of the English written test page.

In the illustrated example, only one question and the possible answers to select from are displayed to the applicant 14 at any given time. If the applicant 14 clicks the next button without choosing an answer to the displayed question, then he/she will be prompted to select whether he/she wishes to proceed without answering the current question or to select an answer to the current question before proceeding. By clicking the “proceed without answering” button, the applicant 14 can advance to the next question without answering the current question, but the current question will be scored as wrongly answered. In some implementations, the prompt asking the applicant to select whether he/she wishes to proceed without answering the current question or to select an answer to the current question before proceeding is eliminated and skipped questions are simply marked as incorrectly answered.

After completion of the questions of the English written test, or upon expiration of the allotted test time (whichever occurs first), the test administrator 26 saves the test entries in the database 22.

In the illustrated example, the test administrator 26 automatically scores the English written test by comparing the applicant's answers to the correct answers as reflected in an answer key. The test administrator 26 stores the computed English written test score in the database 22 with the applicant's answers.

After the English written test results are saved, the test administrator 26 displays a pop-up message asking if the applicant is ready to proceed to the next test. By clicking an OK button associated with the pop-up message, the applicant 14 can automatically proceed to the next test.

### Personality Inventory Test

In the illustrated example, upon completion of the English written test, the test administrator 26 administers a personality inventory test to the applicant 14. The personality inventory test of the illustrated example is structured to evaluate whether the personality traits and aptitudes of the applicant 14 suggest the applicant 14 will succeed in the position of interest. Upon initiation of the personality inventory test, the test administrator 26 of the recruiting system first displays an instruction page to explain the test to the applicant 14. In the illustrated example, the instructions are also provided to the applicant via the headset by playing a predetermined audio file. Once the instruction audio file has played completely, the test administrator 26 displays a START button. When the applicant 14 clicks the START button (e.g., by selecting it with a point and click input device such as a mouse or touchpad), the test administrator 26 displays the personality inventory test page on the computer being used by the applicant 14.

In the illustrated example, the personality inventory test is a commercially available test administered over the Internet by a third party. In the current implementation, the personality inventory test is the Personality Perspective Inventory (PPI) test provided by A&M Psychometrics, LLC.

The Performance Perspectives Inventory (PPI) A) is a 155 item instrument that measures the Big Five components of personality and 22 subscales (Abraham and Morrison, 2002). Each item in the PPI is rated on a five-point scale ranging from very inaccurate to very accurate. The test of the illustrated example is administered over the Internet in a proctored environment, with standardized instructions and conditions. It takes approximately 20 minutes, on average, to complete.

The example recruiting system 10 of the illustrated example is structured to encrypt communications to the personality test website to protect the confidentiality of the applicant. Similarly, the recruiting system 10 of the illustrated example identifies the applicant 14 to the personality test website by applicant identification number only, thereby hiding the identity of the applicant 14 from the personality test vendor.

The personality test website automatically compiles test results based on the applicant's test responses and returns the personality inventory test results to the recruiting system 10 of the illustrated example. Again, in the illustrated example, the test results are returned in encrypted form, and identify the applicant 14 only by applicant identification number. The name and address of the applicant 14 are neither provided to, nor received from, the personality test website.

Upon receiving the personality test results, the test administrator 26 of the illustrated example stores those results in the database 22 in association with the applicant's identification number.

After the applicant 14 completes the personality test, the test administrator 26 of the illustrated example displays a pop-up message asking if the applicant 14 is ready to proceed to the next test. By clicking an OK button associated with the pop-up message, the applicant 14 can automatically proceed to the next test.

### English Oral Reading Test

In the illustrated example, upon completion of the personality inventory test, the test administrator 26 administers an English oral reading test to the applicant 14. The English oral reading test of the illustrated example is designed to measure various aspects of the applicant's speech such as tone and/or clarity (the latter including diction, articulation, phrasing, pauses, pacing and/or volume). Further, the English oral reading test was constructed to measure higher communicative functions such as grasping underlying meaning and selecting appropriate responses, but with the added element of effective voice expression. The assessment focuses on skills for reading out loud, listening comprehension, semantic inference, communicative decision making, response appropriateness, effective vocal expression, and appropriate persuasion.

Upon initiation of the English oral reading test, the test administrator 26 of the illustrated example recruiting system 10 first displays an instruction page to explain the test to the applicant 14. In the illustrated example, the instructions are also provided to the applicant via the headset by playing a predetermined audio file. Example instructions are provided in the following paragraph:

“Instructions to the applicant: Silently read each passage once for practice, and then read it out loud a second time, so that your voice can be recorded. Make sure that your tone of voice is enthusiastic but natural.”

Once the instruction audio file has played completely, the test administrator 26 displays a START button. When the applicant 14 clicks the START button (e.g., by selecting it with a point and click input device such as a mouse or touchpad), the test administrator 26 displays the English oral reading test interface on the computer being used by the applicant 14.

The English oral reading test requires the applicant 14 to read passages aloud. The applicant's reading of the passages are recorded via a microphone (e.g., the microphone of the headset) for later evaluation by a recruiter 12. In the illustrated example, the applicant 14 is provided with some time to read and understand each passage before he/she is expected to read the corresponding passage aloud.

Upon completion of a pre-read time, the RECORD button is displayed on the English oral reading test interface. When the applicant clicks the RECORD button (e.g., with a point and click device such as a mouse or touchpad) the test administrator 26 begins recording the signal received from the microphone. This signal should correspond to the voice signal of the applicant reading the corresponding passage aloud.

Once the applicant 14 finishes recording a given passage, or upon expiration of the record time provided for that given passage, the test administrator 26 stops recording and displays the NEXT button on the English oral reading test page. The applicant 14 can then continue with the next passage by clicking NEXT button. This process is continued until a recording of the applicant 14 reading each passage aloud has been made. The test administrator 26 automatically saves the captured voice files to the database 22 in association with the applicant's identification number. In the illustrated example, the audio files are compressed before they are stored in the database 22 using any desired compression algorithm.

After the applicant 14 completes the English oral reading test, the test administrator 26 displays a pop-up message asking if the applicant 14 is ready to proceed to the next test. By clicking an OK button associated with the pop-up message, the applicant 14 can automatically proceed to the next test.

### English Oral Listening Test

In the illustrated example, upon completion of the English oral reading test, the test administrator 26 administers an English oral listening test to the applicant 14. The English oral listening test of the illustrated example is designed to measure the cognitive ability of the applicant 14 based on his/her interpretation of pre-recorded conversations. Upon initiation of the English oral listening test, the test administrator 26 of the illustrated example recruiting system 10 first displays an instruction page to explain the test to the applicant 14. In the illustrated example, the instructions are also provided to the applicant via the headset by playing a predetermined audio file. Once the instruction audio file has played completely, the test administrator 26 displays a START button. When the applicant 14 clicks the START button (e.g., by selecting it with a point and click input device such as a mouse or touchpad), the test administrator 26 displays the English oral listening test interface on the computer being used by the applicant 14.

In the illustrated example, the English oral listening test is conducted by playing an audio file representative of a pre-recorded alternative exchange between a call center employee such as a research interviewer and a respondent. The applicant 14 is to listen to the audio exchange and then select the most appropriate answer from the presented choices by clicking on the selected choice on the English oral listening test interface.

If the applicant 14 clicks the NEXT button without choosing an answer to the displayed question, then the applicant will be prompted to select whether he/she wishes to proceed without answering the current question or to select an answer to the current question before proceeding. By clicking the “PROCEED WITHOUT ANSWERING” button, the applicant 14 can advance to the next question without answering the current question, but the question will be recorded as wrongly answered.

After completion of the questions of the English oral listening test, the test administrator 26 saves the test entries in the database 22.

In the illustrated example, the test administrator 26 automatically scores the English oral listening test by comparing the applicant's answers to the correct answers in a stored answer key. The test administrator 26 stores the computed English oral listening test score in the database 22 with the applicant's answers.

After the applicant 14 completes the English oral listening test, the test administrator 26 displays a pop-up message asking if the applicant 14 is ready to proceed to the next test. By clicking an OK button associated with the pop-up message, the applicant 14 can automatically proceed to the next test.

### English Oral Persuading Test

In the illustrated example, upon completion of the English oral listening test, the test administrator 26 administers an English oral persuading test to the applicant 14. The English oral persuading test of the illustrated example is designed to measure the skills of persuasion of the applicant. Upon initiation of the English oral persuading test, the test administrator 26 of the illustrated example recruiting system 10 first displays an instruction page to explain the test to the applicant 14. In the illustrated example, the instructions are also provided to the applicant via the headset by playing a predetermined audio file. Once the instruction audio file has played completely, the test administrator 26 displays a START button. When the applicant 14 clicks the START button (e.g., by selecting it with a point and click input device such as a mouse or touchpad), the test administrator 26 displays the English oral persuading test interface on the computer being used by the applicant 14.

In the illustrated example, the applicant 14 is provided a list of alternative responses on the English oral persuading test interface and given an opportunity to read those responses for a short period of time (e.g., 5 minutes). The test administrator 26 then plays a pre-recorded exchange between a call center personnel such as a research interviewer and a respondent. The applicant 14 is required to listen to the pre-recorded exchange, to select an appropriate alternate response from the list of responses by clicking the selection on the English oral persuading test page, and to read the selected response aloud.

More specifically, after the pre-recorded exchange is played, the test administrator 26 displays a RECORD button. The applicant 14 is to click the RECORD button and read aloud the response they selected (i.e., the response they clicked with the mouse). The applicant 14 must read the selected response within a predetermined recording time. The remaining time to record is shown in the right corner of the English oral persuading test page. After expiration of the recording time period, the test administrator 26 automatically moves on to the next exchange in the English oral persuading test.

If the applicant 14 clicks the RECORD button without selecting a response to the displayed question, then the applicant 14 will be prompted to select whether he/she wishes to proceed without answering the current question or to select an answer to the current question before proceeding. By clicking the “PROCEED WITHOUT ANSWERING” button, the applicant 14 can advance to the next question without answering the current question and the question will be scored as answered incorrectly. In some implementations, the prompt asking the applicant to select whether he/she wishes to proceed without answering the current question or to select an answer to the current question before proceeding is eliminated and skipped questions are simply marked as incorrectly answered.

The test administrator 26 automatically saves the responses selected by the applicant 14 and the captured voice recordings of the applicant's readings in the database 22 in association with the applicant's identification number. In the illustrated example, the audio recordings are compressed before being stored.

In the illustrated example, the test administrator 26 automatically scores the multiple choice responses selected during the English oral persuading test by comparing the applicant's answers to the correct answers in a stored answer key. The test administrator 26 stores the computed English oral persuading test score in the database 22 with the applicant's answers. The audio recordings are not scored by the recruiting system 10. Instead, a recruiter 12 interacts with the recruiting system 10 as explained below to score the audio recordings.

Upon completion of the English oral persuading test, the test administrator 26 of the illustrated example could display a pop-up message asking if the applicant is bilingual. By clicking a YES button associated with the pop-up message, the applicant 14 could then automatically proceed to the second language tests. Alternatively, the bilingual test can be automatically started upon completion of the English test without an intervening pop-up display.

### Second Language Tests

In the illustrated example, the second language tests are presented and processed analogously to the English language written test, the English language oral reading test, and the English language oral listening test explained above. Therefore, in the interest of brevity, those tests are not re-described here. Instead, the interested reader is referred above to the corresponding English tests for a full explanation of how the second language tests are handled. In the illustrated example, the second language tests are in Spanish, but persons of ordinary skill in the art will appreciate that any other language could be used as the second language. Similarly, although the first language used in the illustrated example is English, persons of ordinary skill in the art will appreciate that any other language could alternatively be employed. While, in the illustrated example, the second language tests are not direct translations of the corresponding first language (e.g., English) tests, they are similar in content and scope and have the same level of difficulty.

### Test Assessments

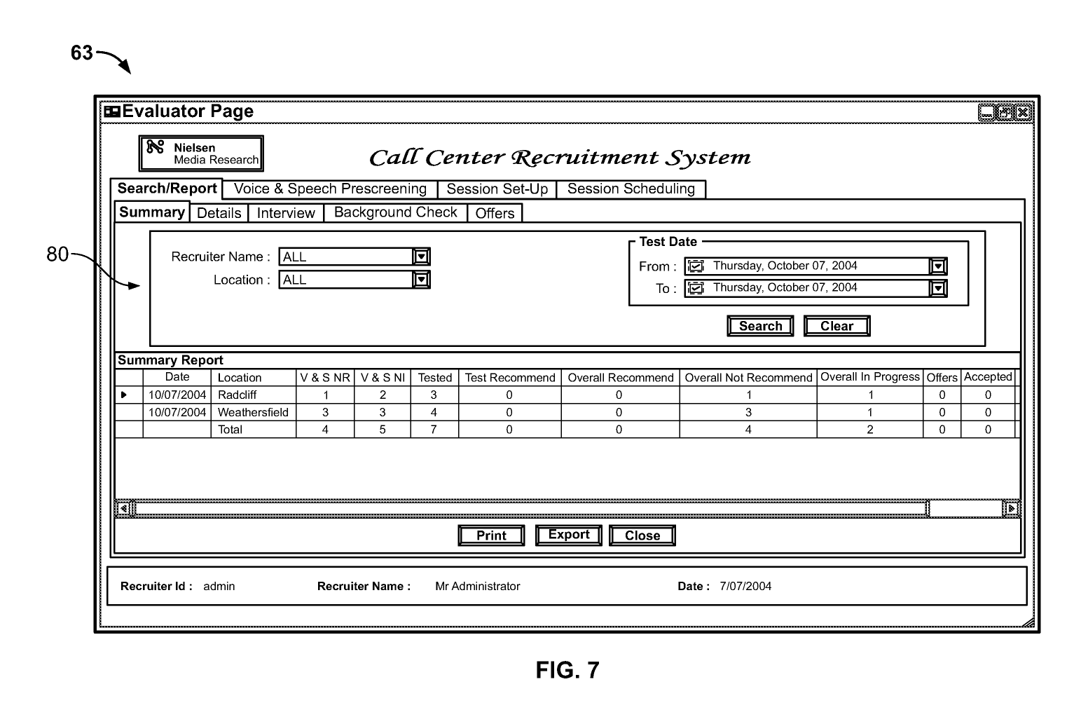

After the date of the test session for a given applicant 14, the recruiter 12 assigned to evaluate that applicant 14 accesses the recruiter interface 26 of the recruiting system 10 to continue the evaluation of the applicant 14. In particular, the recruiter logs into the illustrated example recruiting system 10 by entering the required login information (e.g., name and password) into the example login interface 44 provided by the gatekeeper 24. Once the gatekeeper 24 authenticates the recruiter 12, and/or upon selection of the search/report tab of FIG. 4, the example recruitment administrator 36 of the example recruitment system 10 displays the example summary report interface 63 of FIG. 7 on the recruiter's communication device.

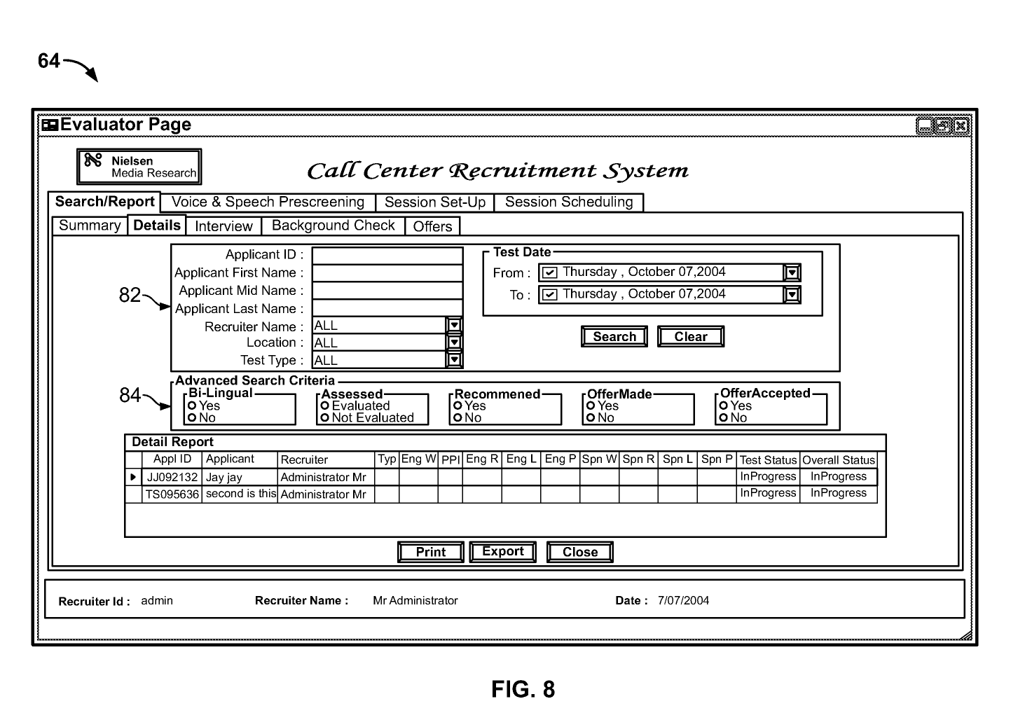

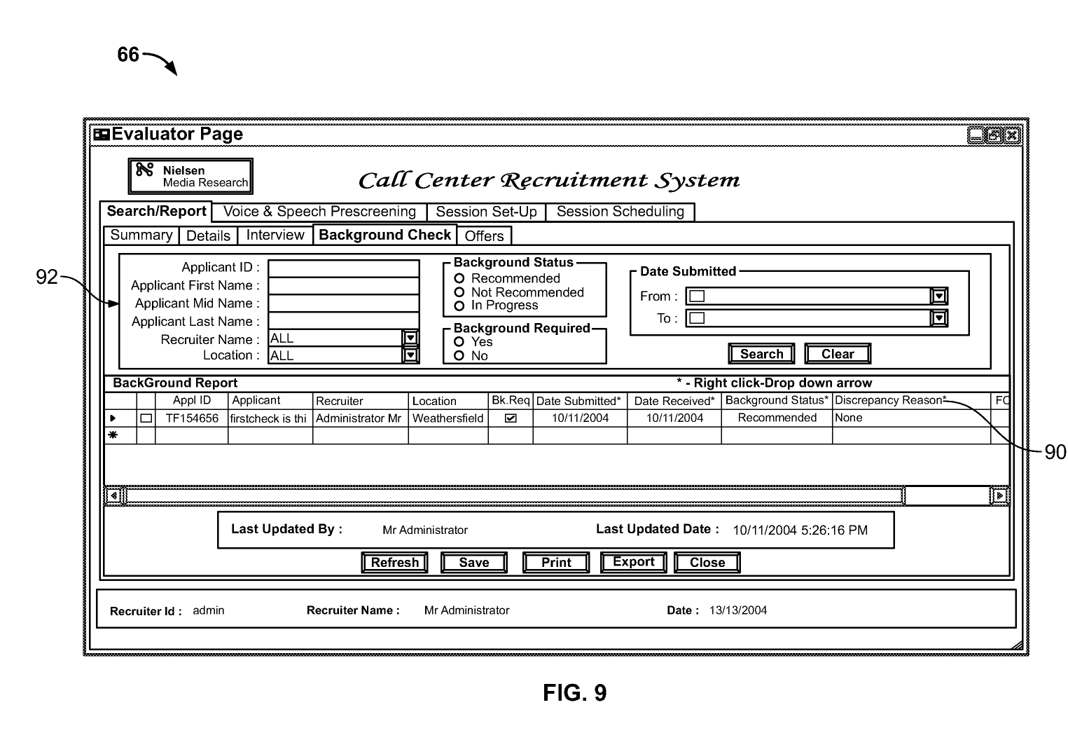

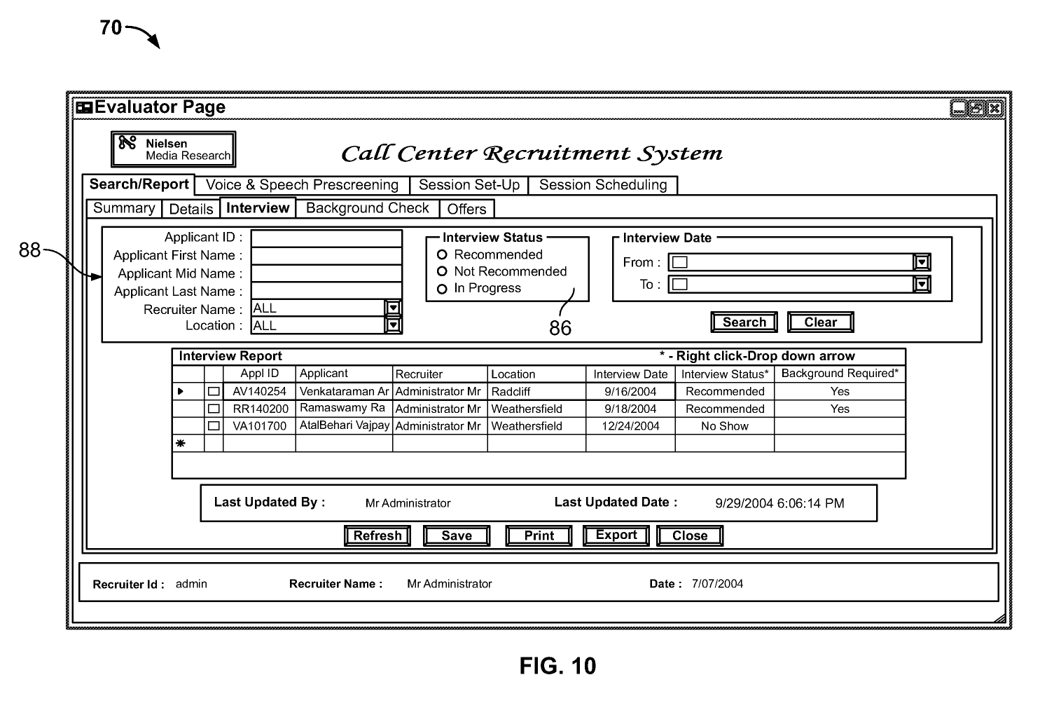

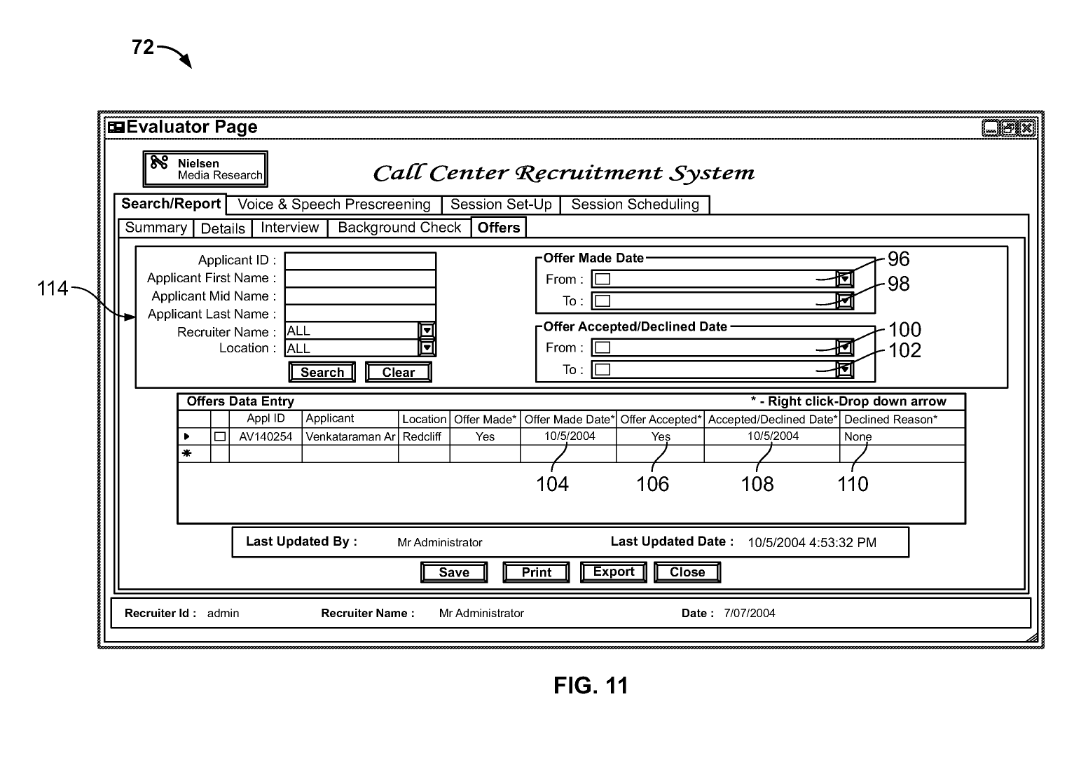

In the example of FIG. 7, the summary report interface 63 provides access to a number of additional interface screens. For example, the summary report interface 63 provides access to a details interface such as the example details interface 64 of FIG. 8, a background check interface such as the example background check interface 66 of FIG. 9, an interview interface such as the example interview interface 70 of FIG. 10, and an offers interface such as the example offers interface 72 of FIG. 11.

### Summary Interface

In the illustrated example, the summary interface 63 provides a snapshot of the recruitment progress. It display details such as the total number of applicants 14 who appeared for a given position, the number of applicants 14 who passed the tests for the position, the number of applicants 14 who have been recommended for the position, the number of applicants 14 who were offered a position, the number of applicants 14 that have accepted offers, the number of applicants 14 who were not interested in taking further tests, etc. In the example of FIG. 7, the summary interface 63 includes search fields 80 to enable narrowing of the displayed information to particular recruiters, groups, areas, and/or timeframes of interest.

### Details Interface

In the illustrated example, the details interface 64 provides specific details about each applicant 14. Thus, the details interface 64 displays a summary of the test results for each applicant 14. The details interface 64 also provides the vehicle for selecting particular tests to be scored. In other words, if a particular test for a particular applicant 14 is selected, the corresponding test interface is opened to provide access to the applicant's test results for review and/or scoring. For instance, the recruiter 12 can assess the applicant's answers to the typing test, the English oral reading test, the English oral persuading test, the Spanish oral reading test (if applicable) and the Spanish oral persuading test (if applicable) by right clicking on the corresponding column of the details interface of FIG. 8.

In the example of FIG. 8, the details interface 64 includes search fields 82 to enable narrowing of the displayed information to particular applicant(s), recruiters, tests, groups, areas, and/or time frames of interest. The details interface 64 also enables use of advanced search criteria fields 84 to limit results to bi-lingual or non-bilingual applicants, to evaluated or not-evaluated applicants, to recommended or not recommended applicants, to applicants who have or have not received an offer and/or to applicants that have or have not accepted an offer.

### Interview Interface

In the illustrated example, the interview interface 70 of FIG. 10 assists the personal interview phase of the recruitment process. For instance, the interview interface 70 provides a tool for scheduling and rescheduling interviews with applicants 14. The interview screen 70 of the illustrated example includes an interview status box 86 indicating whether a given applicant is Recommended, Not recommended, or in progress. The illustrated example interview interface 70 also indicates whether or not a background check is required for a particular applicant. In the example of FIG. 10, the interview interface 70 includes search fields 88 to enable narrowing of the displayed information to particular applicant(s), recruiters, groups, locations, and/or time frames of interest.

### Background Check Interface

In the illustrated example, the background check interface 66 of FIG. 9 assists in tracking the progress of the background checking process of candidates who passed the personal interview and who required a background check. The background check interface 66 includes a field 90 in which to identify the reason(s) for failing an applicant based on the background check (if applicable). In the example of FIG. 9, the background check interface 66 includes search fields 92 to enable narrowing of the displayed information to particular applicant(s), recruiters, groups, locations, and/or time frames of interest.

### Offers Interface

In the illustrated example, the offers interface 72 facilitates tracking of the delivery, acceptance and/or refusal of employment offer(s) made to applicant(s) 14 in the final stage of the recruitment process. The example offers interface 72 of FIG. 11 includes offer made date fields 96, 98 to enable searching for offers within a range of dates between the first offer made date field 96 and the second offer made date field 98. The example offers interface 72 also includes offer accepted/declined fields 100, 102 to enable searching for offers accepted and/or rejected within a range of dates between the first offer accepted/rejected date field 100 and the second offer accepted/rejected date field 102. The example offers interface 72 of FIG. 11 also includes a field 104 indicating the date on which a specific offer was made, a field 106 indicating whether the offer was accepted, a field 108 indicating the date on which the offer was accepted or declined, and a field 110 indicating any given reason for the offer being declined. In the example of FIG. 11, the offers interface 72 includes search fields 114 to enable narrowing of the displayed information to particular applicant(s), recruiters, groups, locations, and/or time frames of interest.

### Manual Test Assessments

Assuming, for purposes of discussion, that a recruiter 12 has logged into the recruiting system 10 and desires to score an applicant 14 that has completed testing, using the drop down tabs from the voice and speech prescreening interface 48, the recruiter 12 will navigate to the details interface 64 of FIG. 8. By entering an applicant Id and/or name into the appropriate search field(s) 82 of the details interface 64, the recruiter will cause the recruitment administrator 36 to search the database 22 for the records corresponding to the requested applicant(s) 14. Once the record(s) for the desired applicant(s) 14 are displayed in the details interface 64, the recruiter 12 can select the desired test to score. As noted above, some of the tests are automatically scored. Accordingly, before any recruiter time is spent scoring any tests, the recruiter should verify that the applicant 14 in question is recommended based on the results of the automatic test grading. In other words, if the applicant 14 has not passed the automatically scored tests, then there is no point in spending resources manually grading the remainder of the tests. Instead, the applicant 14 should be rejected without further delay.

### Typing Test Assessment

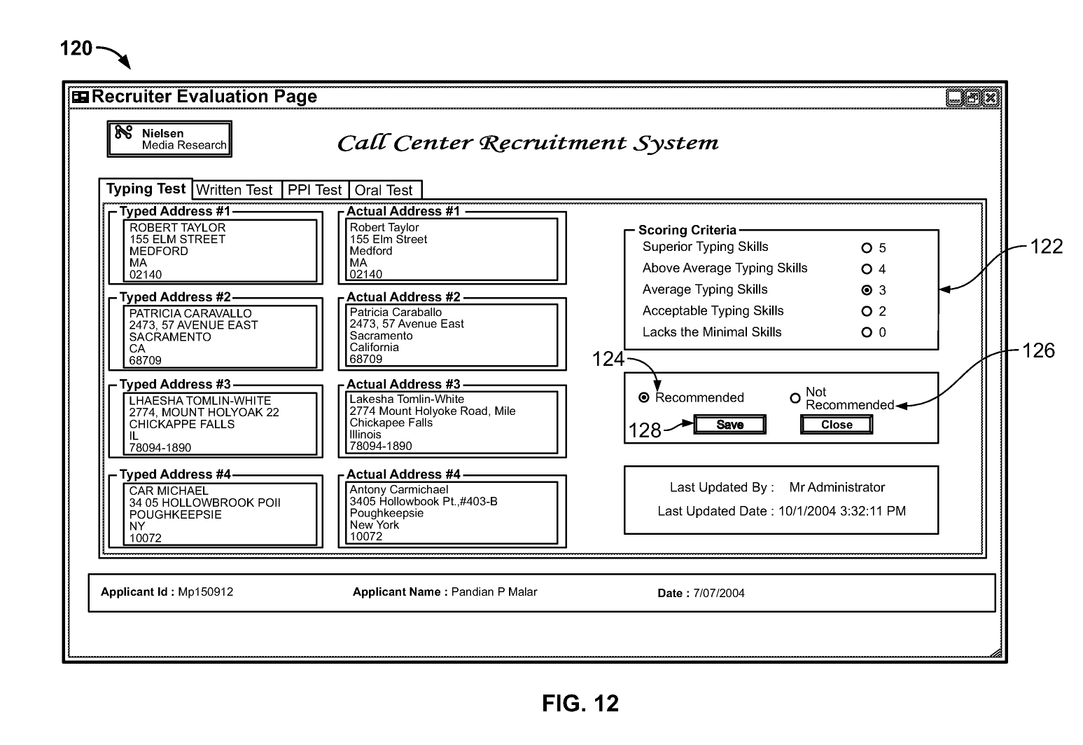

Assuming, for purposes of discussion, that the applicant 14 has passed the automatically graded tests and the recruiter 12 selects the typing test for scoring, the assessor 30 of the example recruiting system 10 of FIG. 2 will display a typing evaluation interface such as the example typing evaluation interface 120 of FIG. 12. In the illustrated example, the typing evaluation interface 120 displays the answers typed by the applicant in question during the typing test adjacent the correct answers. The recruiter 12 can then compare the applicant's answers to the correct answers and score the results on a scale of 0-5, (excluding 1), by entering the score in a scoring criteria field 122. In the illustrated example, a score of 0 is assigned to test results that demonstrate a lack of the minimal typing skills required for the call center position. A score of 2 is assigned to test results that demonstrate acceptable typing skills sufficient for the call center position. A score of 3 is assigned to test results that demonstrate average typing skills. A score of 4 is assigned to test results that demonstrate above average typing skills. A score of 5 is assigned to test results that demonstrate superior typing skills.

In scoring the test results, the recruiter 12 can consider a wide range of factors. In the illustrated example, the recruiter 12 is provided with the following guidelines. Even if misspelled, the addressee's first and last name should at least be recognizable, close to the actual name with a few errors, to be considered minimally acceptable. Even if misspelled, the street name should at least be recognizable, close to the actual street name with few errors. House and apartment numbers, as well as designations (like “Street,” “Avenue,” “Road,” “Point,” “East”) should be exact, but abbreviations are acceptable. Even if misspelled, the city name should at least be recognizable, close to the actual city name with few errors. If spelled out, the state name should at least be recognizable, close to the actual state name with few errors. (Abbreviations are acceptable, but must be accurate.) The 5-digit zip code should be complete and correct.

If the applicant 14 is ranked anywhere from 2-5, the assessor 30 will set the recommended field 124. Otherwise, the assessor 30 will set the not recommended field 126. After completion of the typing test scoring, the recruiter 12 should select the SAVE button 128. In response, the assessor 26 will store the scoring results in the database 22.

As discussed above, the purpose of the typing skills assessment is to check for basic familiarity with the computer keyboard. Call center personnel must be able to type respondents' names and addresses correctly. However, the minimal typing skills required for the position are readily learnable. Accordingly, some applicants 14 who are “Not Recommended” in the typing skills assessment may be good applicants 14 in other respects. Therefore, it may be desirable to score all components of the tests, even if a given applicant 14 fails the typing skills assessment in order to determine if an applicant 14 should be encouraged to reapply after taking a typing course or acquiring further practice in that skill.

### Multiple Choice Tests

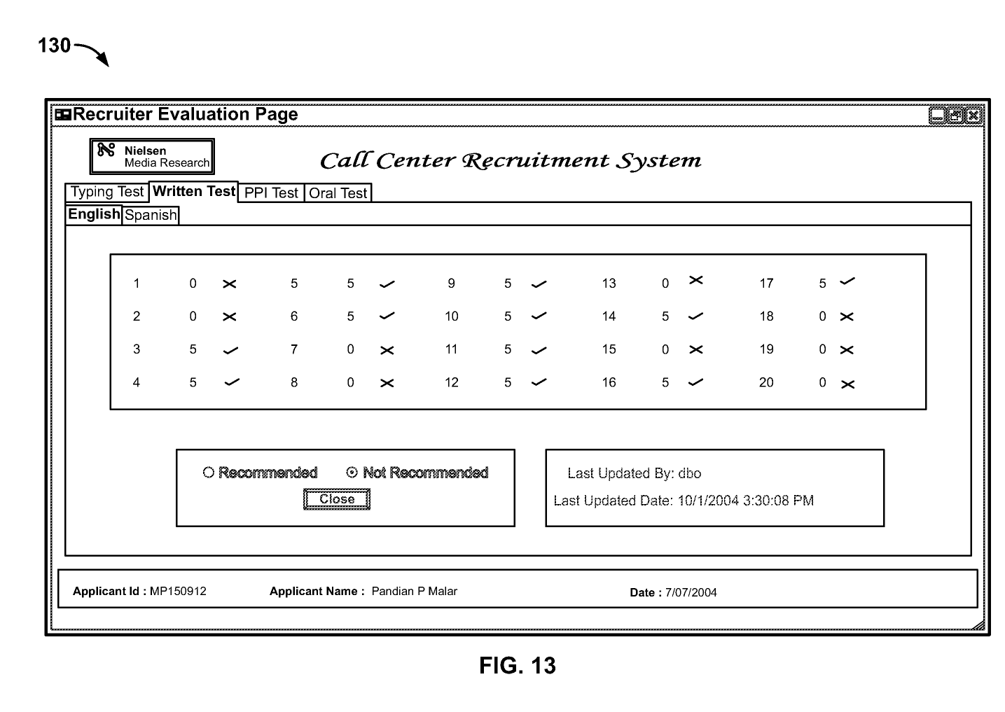

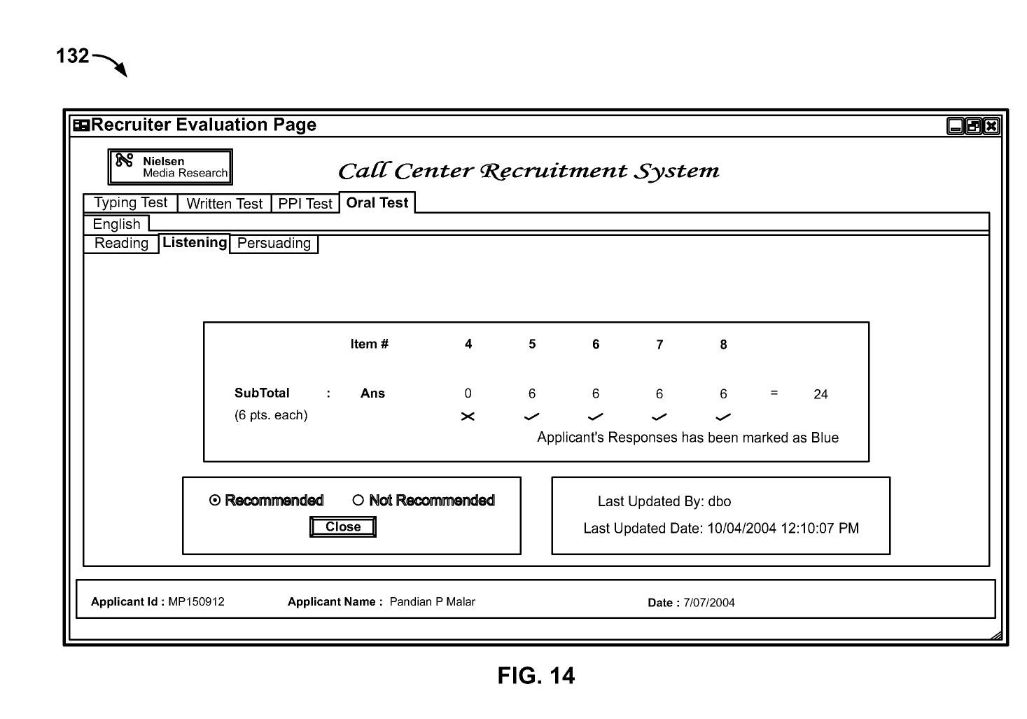

As discussed above, the written test (both English and second language, if applicable) and the oral listening test are automatically scored by the assessor 30. Accordingly, the recruiter 12 does not need to score these results. Nevertheless, it may be desirable for the recruiter 12 to review the answers provided by the applicant 14. Therefore, in the illustrated example, the assessor 30 provides a written test evaluation interface such as the written test interface 130 shown in FIG. 13 and an oral listening test evaluation interface such as the oral listening test evaluation interface 132 shown in FIG. 14. These example interfaces 130, 132 display the question numbers, the applicant's responses and an incorrect/correct status adjacent the answers to enable a recruiter 12 to quickly see the outcome of the corresponding test. Although not shown, in the illustrated example interfaces analogous to those shown in FIGS. 13 and 14 are also provided for the second language (e.g., Spanish) written test and the second language (e.g., Spanish) oral listening test.

### Oral Reading Test Assessment

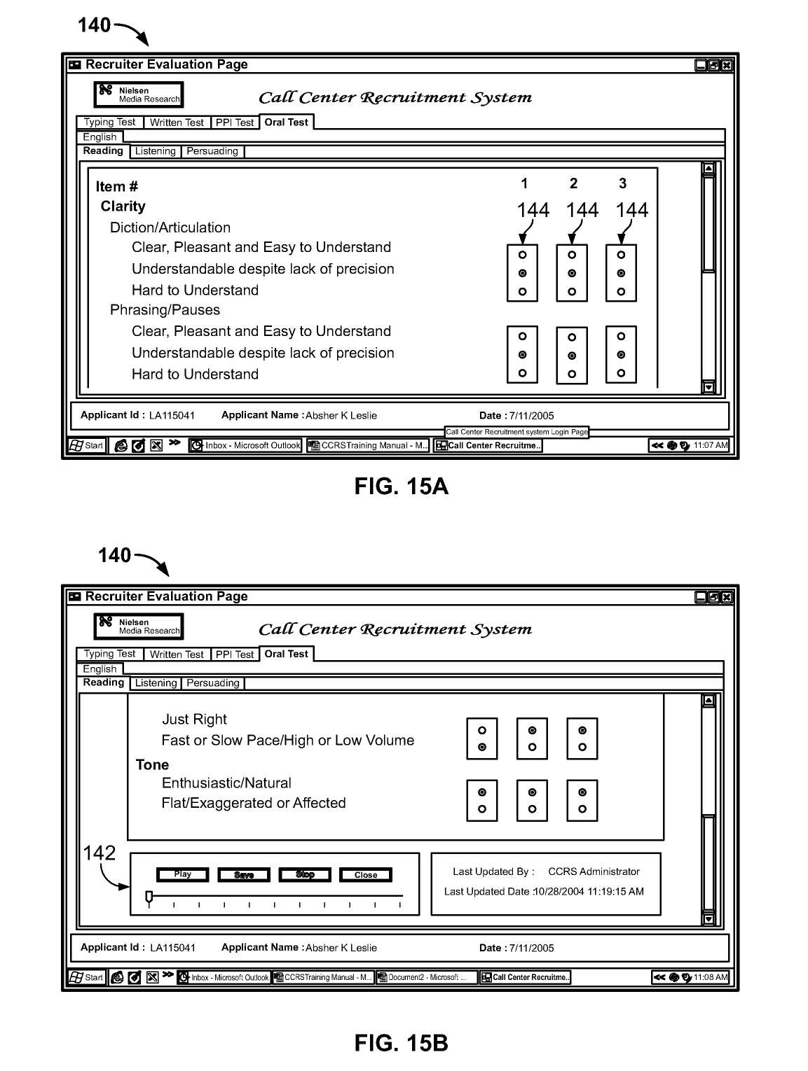

Assuming, for purposes of discussion, that the recruiter 12 selects the oral reading test for scoring, the oral screener 34 of the example recruiting system 10 of FIG. 2 displays an oral reading evaluation interface such as the example oral reading evaluation interface 140 of FIGS. 15A-15B. In the illustrated example, the oral reading evaluation interface 140 includes a plurality of controls 142 that enable the recruiter to play and/or stop the audible recordings of the applicant's test answers. The oral reading evaluation interface 140 of the illustrated example includes input fields 144 for scoring each of the applicant's readings in the areas of diction/articulation, phrasing, pauses (i.e., pace), and tone. After the recruiter 12 scores each of these qualities in each of the applicant's test responses, the recruiter 12 can select the SAVE control 142 to cause the oral screener 34 to automatically score the evaluation and to save the results in the database 22. The oral screener 34 of the illustrated example scores the results by assigning numeric values to the recruiter's selections, computing a combined (weighted or unweighted) score of the same, and comparing the combined score to a threshold. If the combined score exceeds the threshold, the applicant 14 remains in the recommended category. If not, the applicant's status is changed to not recommended.

### Oral Persuading Test Assessment

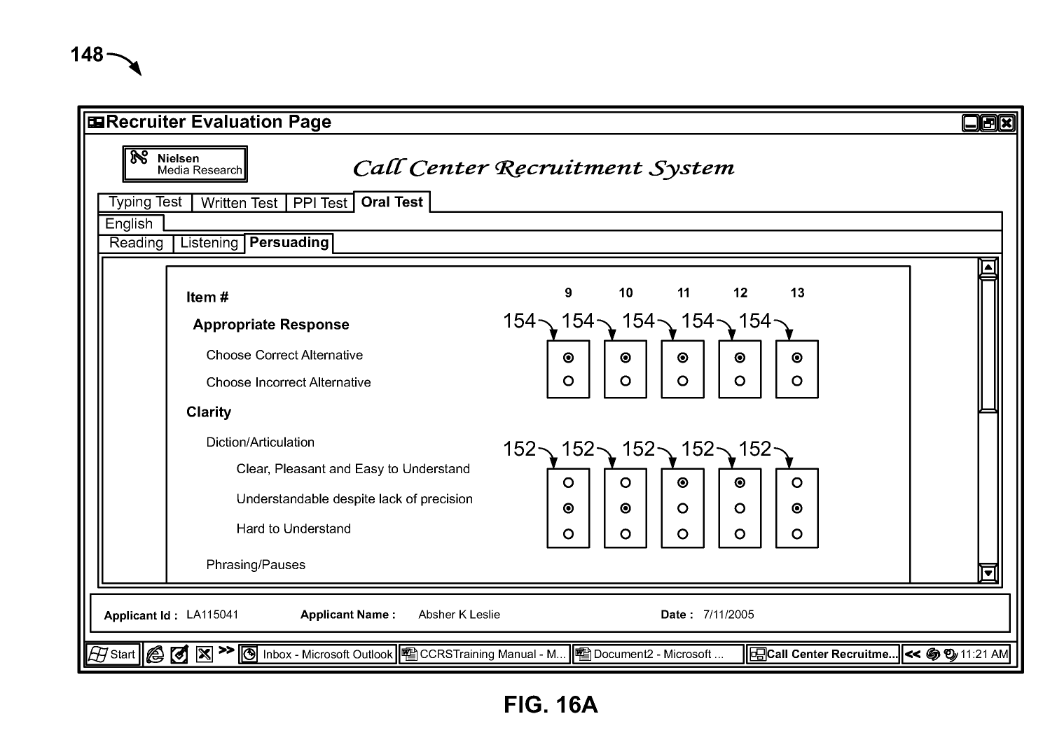

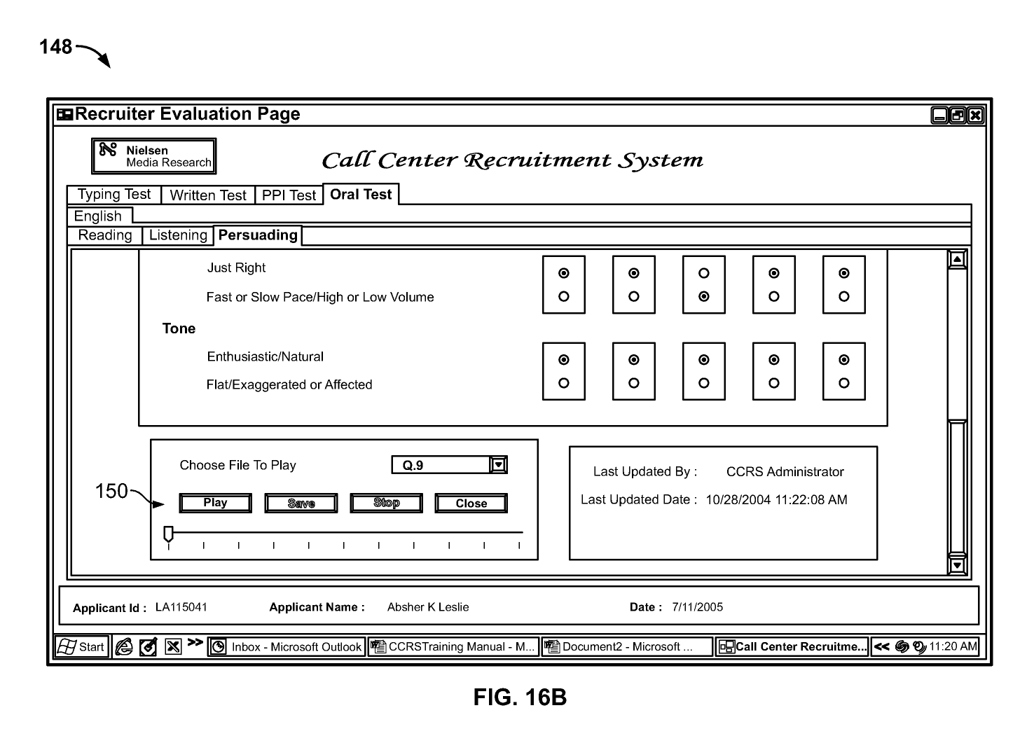

Assuming, for purposes of discussion, that the recruiter 12 selects the oral persuasion test for scoring, the oral screener 34 of the example recruiting system 10 of FIG. 2 displays an oral persuasion evaluation interface such as the example oral reading evaluation interface 148 of FIGS. 16A-16B. In the illustrated example, the oral persuasion evaluation interface 148 includes a plurality of controls 150 that enable the recruiter to play and/or stop the audible recordings of the applicant's test answers. The oral persuasion evaluation interface 148 of the illustrated example includes input fields 152 for scoring each of the applicant's answers in the areas of diction/articulation, phrasing, pauses (i.e., pace), and tone. As shown in FIG. 16A, there are also fields 154 for scoring the applicant's multiple choice answers as to their correctness. However, as discussed above, in the illustrated example these are automatically scored and, thus, in the illustrated example, the appropriate response fields 154 are automatically populated.

After the recruiter 12 grades each of the speaking qualities in each of the applicant's audible test responses, the recruiter 12 can select the SAVE control 150 to cause the oral screener 34 to automatically score the evaluation and to save the results in the database 22. The oral screener 34 of the illustrated example scores the results by assigning numeric values to the recruiter's selections, computing a combined (weighted or unweighted) score of all answers to the test (including the multiple choice answers), and comparing the combined score to a threshold. If the combined score exceeds the threshold, the applicant 14 remains in the recommended category. If not, the applicant's status is changed to not recommended.

The manual oral assessments of the illustrated example are preferably only scored by the recruiter 12 after an applicant 14 has completed all of the other assessments and is still “Recommended”. For example, if the applicant 14 is “Not Recommended” on the personality inventory assessment, the recruiter 12 should not score the oral assessments. The recruiter 12 is to use the oral assessment definitions discussed above when performing the oral assessment.

### Machine Readable Instruction Implementation

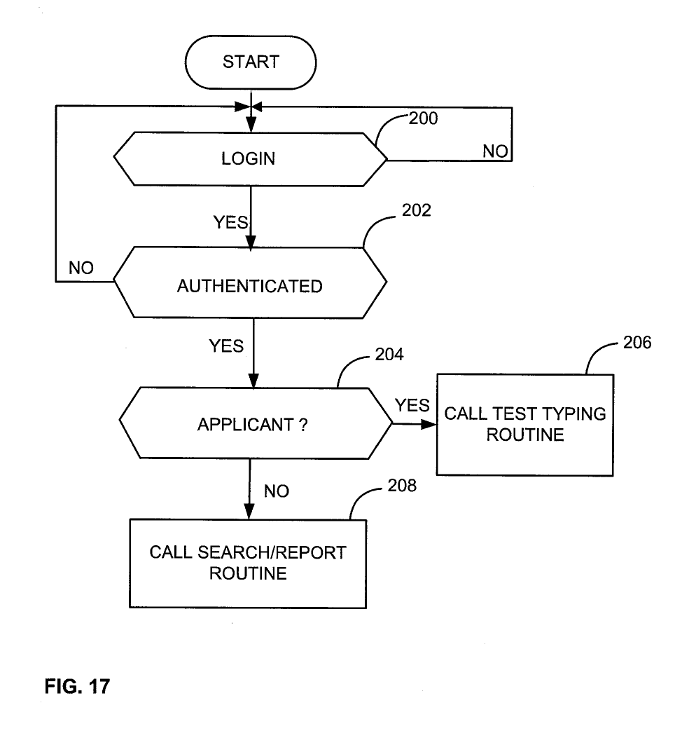

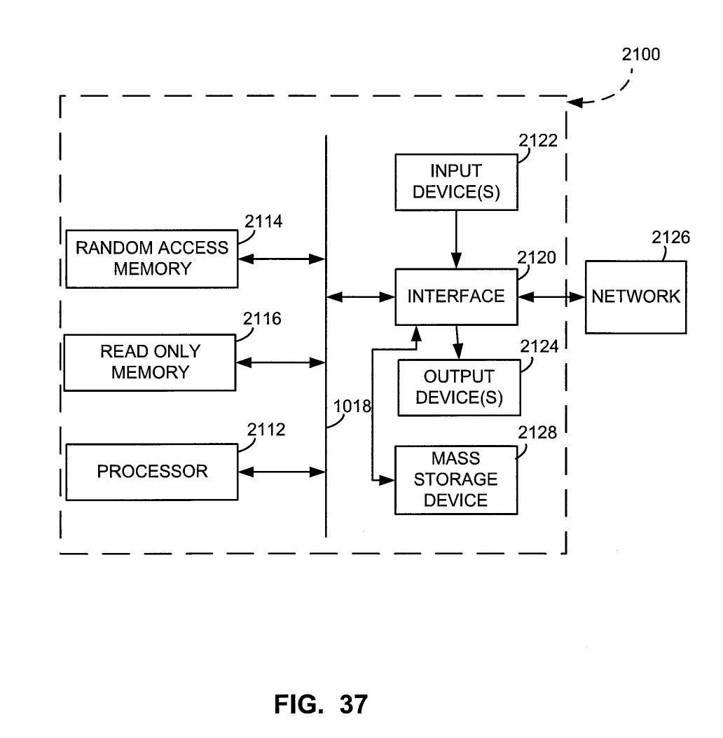

Flowcharts representative of example machine readable instructions for implementing the recruiting system 10 of FIGS. 1 and/or 2 are shown in FIGS. 17-36. In this example, the machine readable instructions comprise a program for execution by a processor such as the processor 2112 shown in the example computer platform 2100 discussed below in connection with FIG. 37. The program may be embodied in software stored on a tangible medium such as a CD-ROM, a floppy disk, a hard drive, a digital versatile disk (DVD), or a memory associated with the processor 2112, but persons of ordinary skill in the art will readily appreciate that the entire program and/or parts thereof could alternatively be executed by a device other than the processor 2112 and/or embodied in firmware and/or dedicated hardware in a well known manner. For example, any or all of the gatekeeper 24, the test administrator 26, the recruiting interface 28, the assessor 30, the scheduler 32, the oral screener 34, and/or recruitment administrator 36 could be implemented by software, hardware, and/or firmware. Further, although the example program is described with reference to the flowcharts illustrated in FIGS. 17-36, persons of ordinary skill in the art will readily appreciate that many other methods of implementing the example recruitment system 10 may alternatively be used. For example, the order of execution of the blocks may be changed, and/or some of the blocks described may be changed, eliminated, or combined.

The program of FIG. 17 begins at block 200 where, after performing conventional housekeeping tasks such as setting registers, defining variables, etc, the gatekeeper 24 of the example recruiting system 10 displays the example login interface screen 44 shown in FIG. 3 and awaits input of login information from a user. Upon receiving login information, the gatekeeper 24 compares the login information to a database of login information to determine if the login information is correct (block 202). If the login information is not recognized as present in the database 22, the user is not authenticated and control returns to block 200 to await further login information via the example login interface screen 44.

If the user is authenticated (block 202), control advances to block 204, where the gatekeeper determines if the user is an applicant 14 or a recruiter 12. If the user logged in as an applicant 14 (block 204), control advances to block 206. If the user logged in as a recruiter 12 (block 204), control advances to block 208.

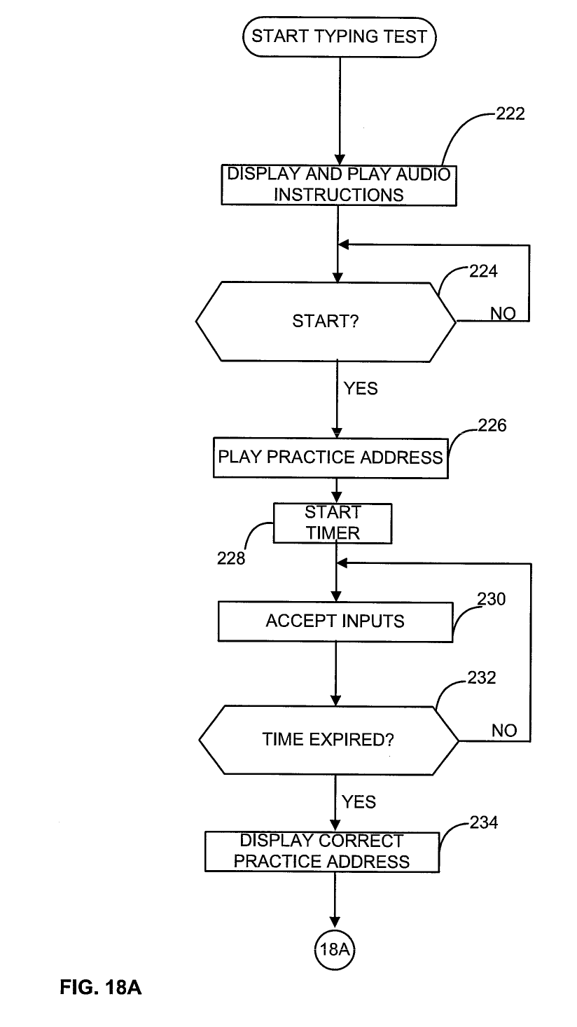

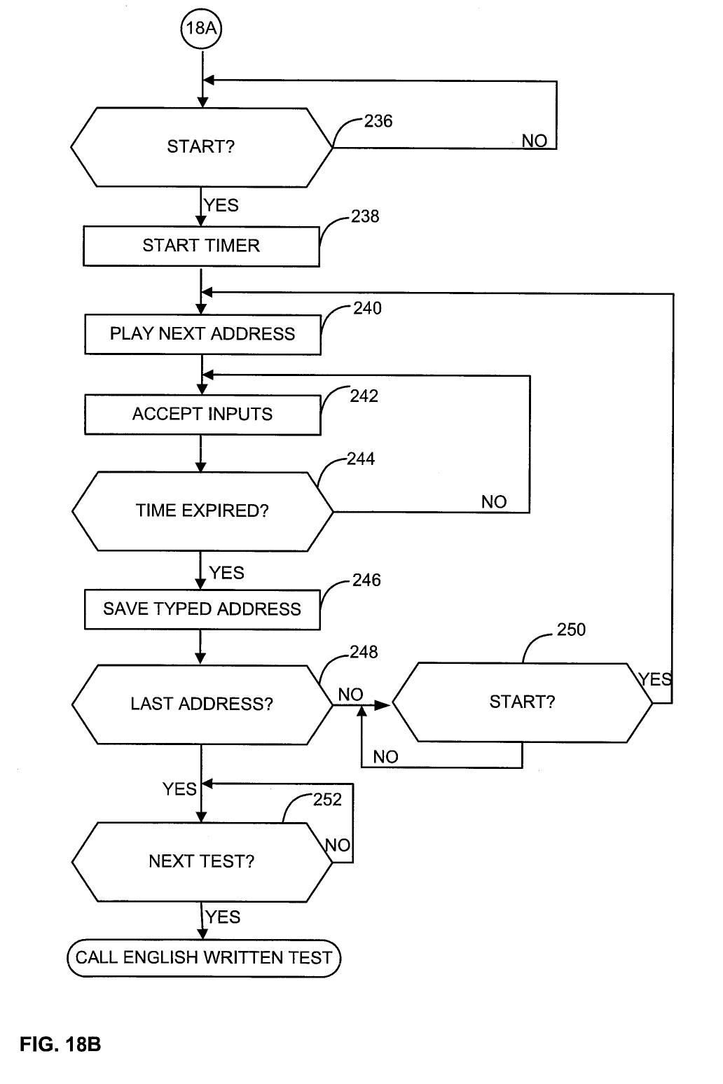

Assuming for purposes of discussion that the user is an applicant 14 (block 204), the gatekeeper 24 calls the test administration routine (block 206) and control advances to block 222 of the example typing test routine shown in FIGS. 18A-18B.

At block 222 of FIG. 18A, the test administrator 26 initiates the typing test by displaying the typing test instructions on the applicant's computer and playing an audio file corresponding to those instructions via the applicant's headphones. After the audio instructions have completely played (block 222), the test administrator 26 displays a START button and waits for the applicant 14 to select the same (block 224). Upon selection of the START button (block 224), control advances to block 226.

At block 226, the test administrator 26 plays the audio file corresponding to the practice name and address to be typed by the applicant 14. The test administrator 26 starts a timer (block 228) and accepts inputs typed into the answer field of a typing test display by the applicant 14 (block 230). The test administrator 26 permits revisions and entries in the input field until the timer reaches a predetermined value, thereby indicating the expiration of the timed answer period (block 232). In other words, control continues to loop through blocks 230 and 232 until a predetermined answer period expires. Upon expiration of the time period (block 232), control advances to block 234 and no further revisions to, and/or entries in, the input field are accepted. Instead, the test administrator 26 displays the correct answer in the typing test interface adjacent the applicant's practice answer for the applicant's review (block 234).

The test administrator 26 then displays a START button and awaits selection of the same by the applicant 14 (FIG. 18B, block 236). When the applicant 14 clicks the START button using, for example, a point and click device such as a mouse (block 236), the test administrator 26 starts a timer (block 238) and plays the audio file corresponding to the first test name and address the applicant is to type (block 240). The test administrator 26 also displays the typing test interface on the applicant's display and accepts inputs typed into the answer field of the typing test interface display by the applicant 14 (block 242). The test administrator 26 permits revisions and entries in the input field until the timer reaches a predetermined value, thereby indicating the expiration of the timed answer period (block 244). In other words, control continues to loop through blocks 242 and 244 until a predetermined answer period expires. Upon expiration of the time period (block 244), control advances to block 246 and no further revisions to, and/or entries in, the input field are accepted. Instead, the test administrator 26 saves the data in the input field to, for example, the database 22 (block 246). Control then advances to block 248.

At block 248, the test administrator 26 determines whether there are any more questions to be answered in the typing test. If so, control advances to block 250, where the test administrator 26 displays a START button and awaits selection of the same by the applicant 14 (block 250). When the applicant 14 clicks the START button using, for example, a point and click device such as a mouse (block 250), control returns to block 240 where the audio file corresponding to the next name and address to be typed by the applicant 14 is played. Control continues to loop through blocks 240-250 until all of the typing test questions have been answered. Although in the example of FIGS. 18A-18B, each individual question is timed, in other implementations, the test as a whole is timed and there is no per question time limit. Thus, the applicant simply proceeds form question to question until all questions have been answered or the time limit for the test as a whole is reached. In other implementations, the test is not timed at all and the applicant is permitted to take as long as they wish to complete the entire examination. Further, although the example implementation illustrated in FIGS. 18A-18B pauses between the practice address and the test addresses until a START button is selected (block 236), some implementations eliminate this pause and move directly to the test questions after displaying the correct practice address (block 234) without presenting or awaiting selection of a START button. Other variations and/or modifications to the example implementation described in FIGS. 18A-18B abound and will be readily apparent to persons of ordinary skill in the art.

Returning to the example of FIG. 18B, when the last typing test question has been answered (block 248), control advances to block 252. At block 252, the test administrator 26 displays a NEXT TEST button and awaits selection of the same by the applicant 14 (block 252). When the applicant 14 clicks the NEXT TEST button using, for example, a point and click device such as a mouse (block 252), the test administrator 26 calls the English written test routine. Persons of ordinary skill in the art will appreciate that the NEXT TEST button can be omitted and the next test y be started automatically upon completion of the typing test.

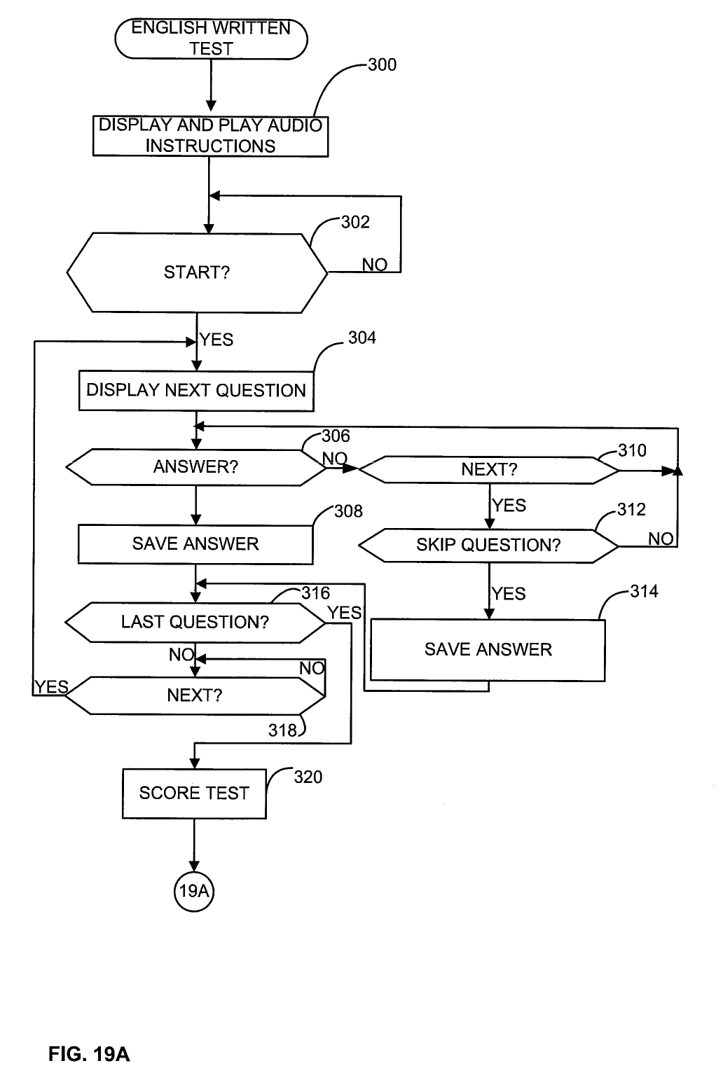

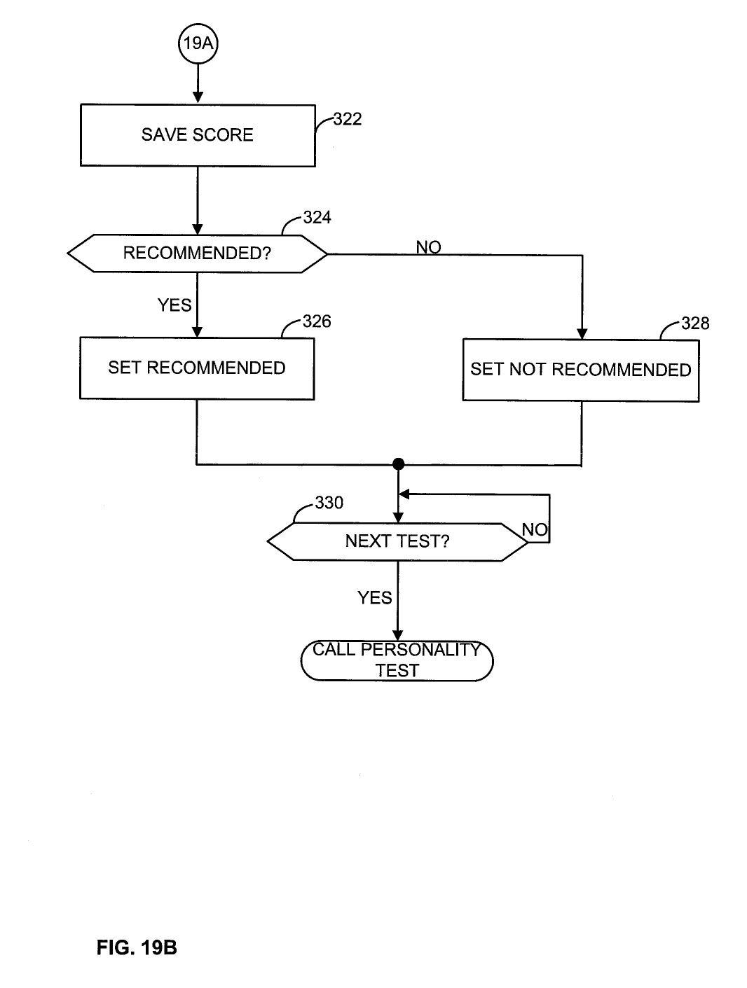

An example English written test routine is shown in FIGS. 19A-19B. The English written test routine of FIGS. 19A-19B begins at block 300 where the test administrator displays the English written test instructions on the applicant's computer and plays an audio file corresponding to those instructions via the applicant's headphones. After the audio instructions have completely played (block 300), the test administrator 26 displays a START button and waits for the applicant 14 to select the same (block 302). Upon selection of the START button (block 302), control advances to block 304.

At block 304, the test administrator 26 displays the first question and the multiple choice answers for the same on the applicant's display. The test administrator also displays a NEXT QUESTION button (block 304). If the applicant 14 selects an answer (block 306), control advances to block 308 where the answer is saved in the database 22. If the applicant 14 selects the NEXT QUESTION button (block 310), the test administrator displays “SKIP QUESTION?” and a YES button and a NO button for selection by the applicant 14 (block 312). If the applicant selects the NO button (block 312), control returns to block 306 where the test administrator continues to await input of an answer or selection of the NEXT QUESTION button. If the applicant 14 selects the YES button in response to the SKIP QUESTION inquiry (block 312), the applicant's answer is saved in the database 22 (block 314) and control advances to block 316.

Control continues to loop through blocks 306 and 310-314 until the applicant answers or skips the current question. Assuming, for purposes of discussion, that the applicant 14 answers the question (block 306), the test administrator 26 saves the answer in the database 22 (block 308) and determines if the last question has been answered (block 316). If the last question has been answered (block 316), control advances to block 318. Otherwise, the test administrator displays a NEXT QUESTION button and waits for the applicant 14 to select the same (block 318). When the applicant 14 clicks the NEXT QUESTION button using, for example, a point and click device such as a mouse (block 318), control returns to block 304 where the next question is displayed.

Control continues to loop through blocks 304-318 until all of the questions are answered or skipped. Although in the example of FIGS. 19A-19B, the applicant is presented a NEXT QUESTION button, and requested to confirm that it is the applicant's intent to skip a question (blocks 310, 312), some implementations eliminate this functionality. In some implementations, the applicant is provided a fixed time to answer all questions and the test ends upon completion of that time and/or when all questions have been answered (i.e., control skips to block 320 when the test time terminates or when answers have nee saved (block 308) for each question). Other variations and/or modifications to the example implementation described in FIGS. 18A-18B abound and will be readily apparent to persons of ordinary skill in the art.

Returning to the discussion of the example implementation of FIG. 19A, after the last question is answered or skipped (block 316), the test administrator 26 scores the English written test by comparing the applicant's answers against a stored answer key (block 320). The test administrator 26 then stores the English written test score in the database 22 (FIG. 19B, block 322). Control then advances to block 324.

At block 324, the assessor 30 compares the English written test score to a predetermined passing threshold. If the applicant's score exceeds the threshold, control advances to block 326 where the assessor 30 sets a recommended flag associated with the applicant 14 to indicate that the applicant 14 is still in the pool of recommended applicants 14. If the applicant's score falls below the threshold, control advances to block 328 where the assessor 30 sets a not recommended flag associated with the applicant 14 to indicate that the applicant 14 is no longer in the pool of recommended applicants 14. Irrespective of whether control branches through block 326 or block 328, control proceeds to block 330.

At block 330, the test administrator 26 displays a NEXT TEST button and awaits selection of the same by the applicant 14 (block 330). When the applicant 14 clicks the NEXT TEST button using, for example, a point and click device such as a mouse (block 330), the test administrator 26 calls the personality inventory test routine. Persons of ordinary skill in the art will appreciate that the NEXT TEST button can be omitted and the next test may be started automatically upon completion of the English written test.

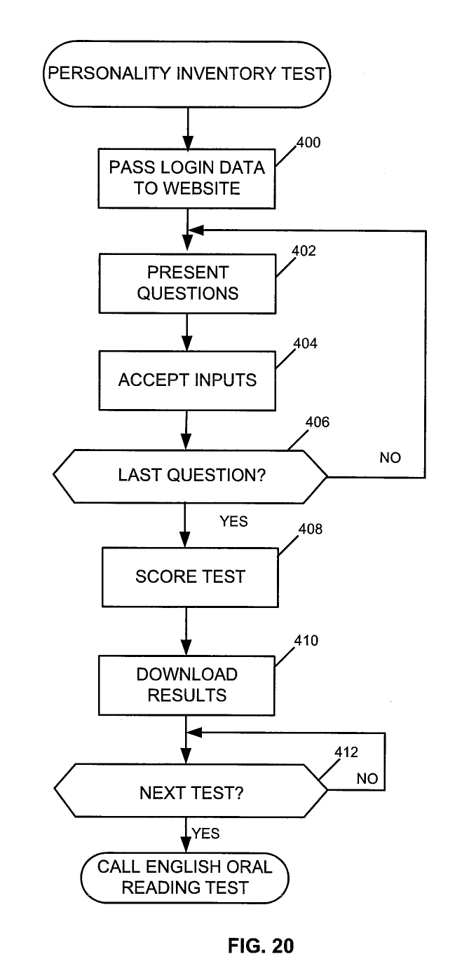

An example personality inventory test routine is shown in FIG. 20. In the illustrated example, the personality test is administered and scored by a third party service. As such, the flowchart of FIG. 20 represents instructions executed by the example recruiting system 10 of FIGS. 1 and 2, and instructions executed by an example third party test service.

The example personality inventory test routine of FIG. 20 begins at block 400 where the example recruiting system 10 passes the login data for the applicant 14 to a website associated with the third party testing party using a browser interface such as Microsoft's Internet Explorer program. The browser will then interact with the third party website to display questions to the applicant 14 (block 402) and return the applicant's answers to the website's server (block 404). Control will continue to loop through blocks 402-406 until all of the questions have been answered (block 406). Once the last question has been answered (block 406), the third party server will score the test (block 408) and download the results to the recruiting system 10 (block 410). Preferably, the exchanges between the applicant's computer and the third party server and the exchanges between the recruiting system 10 and the third party server are encrypted to preserve the applicant's anonymity. The test results received from the third party server are saved on the database 22.

After completion of the personality test (block 410), the test administrator 26 of the example recruiting system 10 displays a NEXT TEST button and awaits selection of the same by the applicant 14 (block 412). When the applicant 14 clicks the NEXT TEST button using, for example, a point and click device such as a mouse (block 412), the test administrator 26 calls the English oral reading test routine. Persons of ordinary skill in the art will appreciate that the NEXT TEST button can be omitted and the next test may be started automatically upon completion of the personality test.

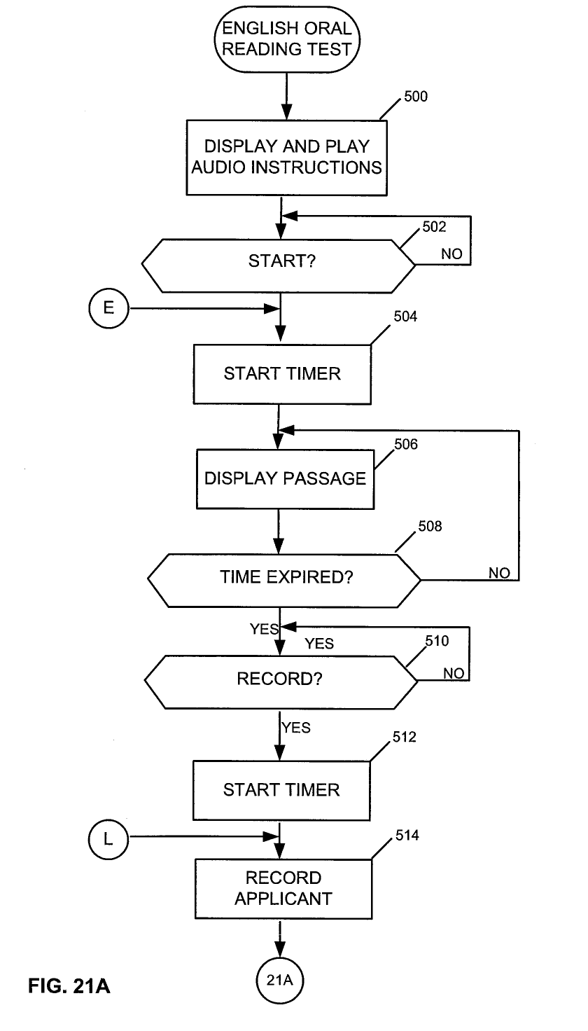

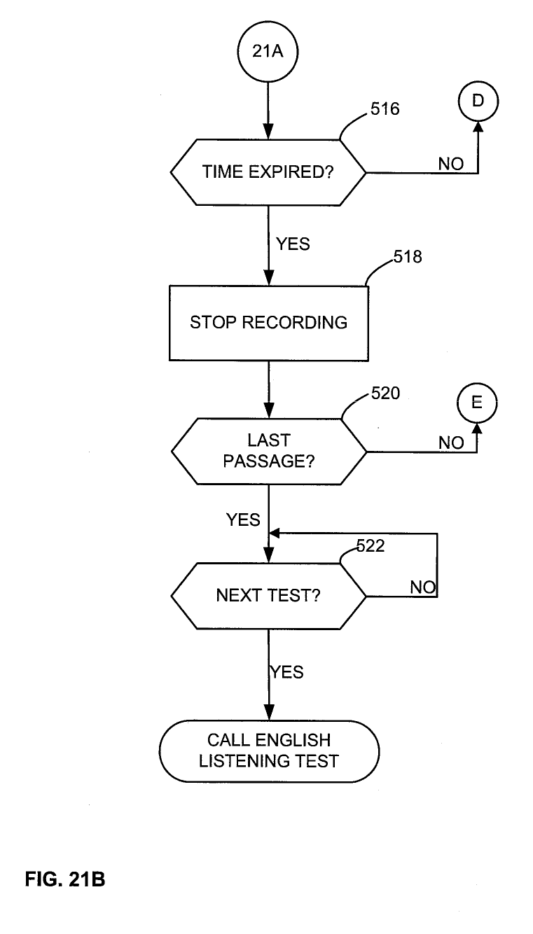

An example English oral reading test routine is shown in FIGS. 21A-21B. The English oral reading test routine of FIGS. 21A-21B begins at block 500 where the test administrator 26 displays the English oral reading test instructions on the applicant's computer and plays an audio file corresponding to those instructions via the applicant's headphones. After the audio instructions have completely played (block 500), the test administrator 26 displays a START button and waits for the applicant 14 to select the same (block 502). Upon selection of the START button (block 502), control advances to block 504.

At block 504, the test administrator 26 starts a timer. The test administrator 26 also displays a passage to be read aloud by the applicant 14 (block 506). This passage is displayed to give the applicant 14 an opportunity to become familiar with the passage before reading it aloud. The test administrator also displays a RECORD button (block 510). When the applicant 14 selects the RECORD button (block 510), the test administrator 26 begins recording the sounds captured by the microphone of the applicant's headset (block 514). The applicant 14 is expected to read the displayed passage aloud so that their voice can be recorded. The test administrator 26 will continue recording until the expiration of a predetermined time period set by the timer (FIG. 21B, block 516). Once the timer expires (block 516), the test administrator stops recording (block 518) and saves the recorded file in the database 22.

The test administrator 26 then determines if there are more test passages to be read aloud (block 520). If so, control returns to block 504 where the timer is restarted and the next test passage is displayed to the applicant (block 506). Control continues to lop through blocks 504-520 until all of the test passages have been read. When all of the test passages have been completed (block 520), control advances to block 522.

At block 522, the test administrator 26 of the example recruiting system 10 displays a NEXT TEST button and awaits selection of the same by the applicant 14 (block 522). When the applicant 14 clicks the NEXT TEST button using, for example, a point and click device such as a mouse (block 522), the test administrator 26 calls the English listening test routine. Persons of ordinary skill in the art will appreciate that the NEXT TEST button can be omitted and the next test may be started automatically upon completion of the English oral reading test.

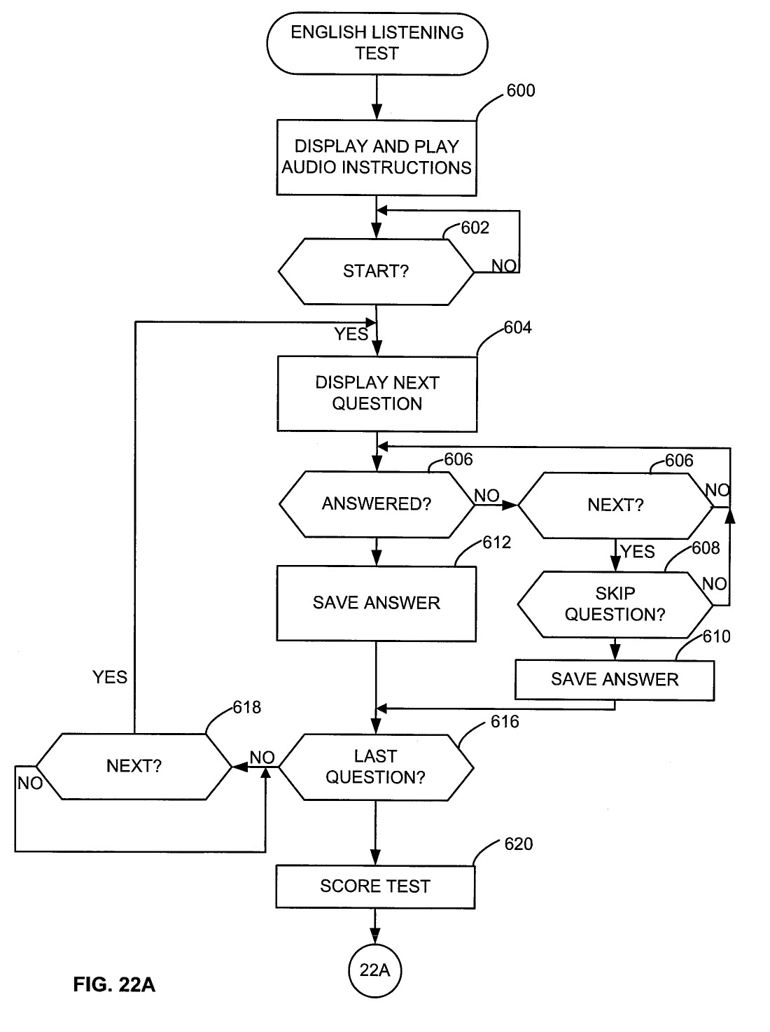

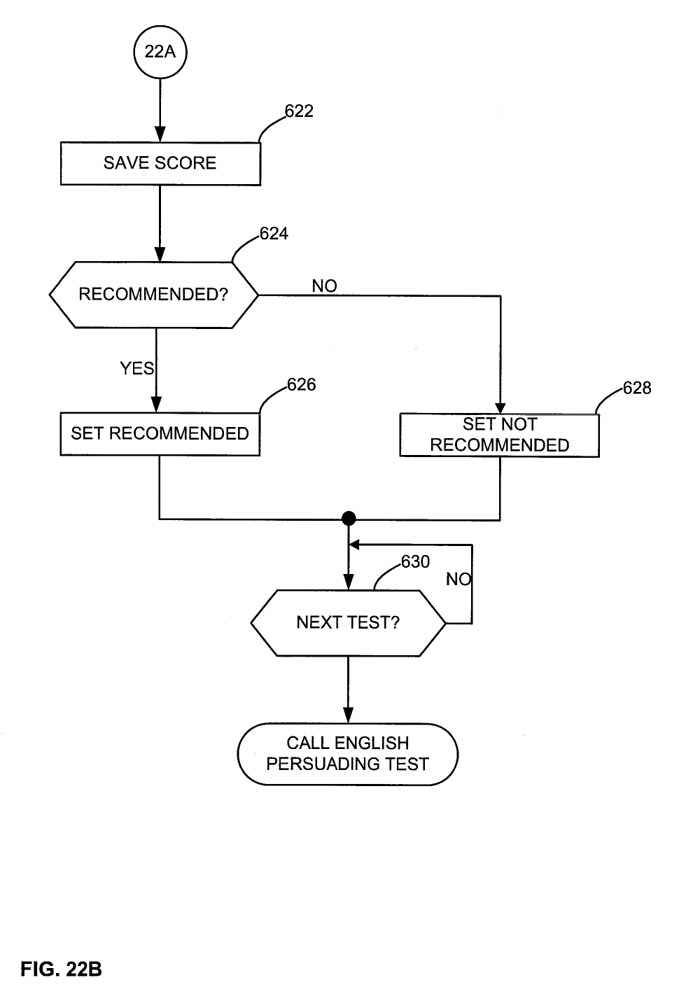

An example English listening test routine is shown in FIGS. 22A-22B. The English oral listening test routine of FIGS. 22A-22B begins at block 600 where the test administrator 26 displays the English oral listening test instructions on the applicant's computer and plays an audio file corresponding to those instructions via the applicant's headphones. After the audio instructions have completely played (block 600), the test administrator 26 displays a START button and waits for the applicant 14 to select the same (block 602). Upon selection of the START button (block 602), control advances to block 604.

At block 604, the test administrator 26 displays the first question and the multiple choice answers for the same on the applicant's display. The test administrator also displays a NEXT QUESTION button (block 606). If the applicant 14 selects an answer (block 606), control advances to block 612 where the answer is saved in the database 22. If the applicant 14 selects the NEXT QUESTION button (block 606), the test administrator displays “SKIP QUESTION?” and a YES button and a NO button for selection by the applicant 14 (block 608). If the applicant selects the NO button (block 608), control returns to block 606 where the test administrator continues to await input of an answer or selection of the NEXT QUESTION button. If the applicant 14 selects the YES button in response to the SKIP QUESTION inquiry (block 608), the applicant's answer is saved in the database 22 (block 610) and control advances to block 616.

Control continues to loop through blocks 606-610 until the applicant answers or skips the current question. Assuming, for purposes of discussion, that the applicant 14 answers the question (block 606), the test administrator 26 saves the answer in the database 22 (block 612) and determines if the last question has been answered (block 616). If the last question has been answered (block 616), control advances to block 620. Otherwise, the test administrator displays a NEXT QUESTION button and waits for the applicant 14 to select the same (block 618). When the applicant 14 clicks the NEXT QUESTION button using, for example, a point and click device such as a mouse (block 618), control returns to block 604 where the next question is displayed.

Control continues to loop through blocks 604-618 until all of the questions are answered or skipped. Although in the example of FIGS. 22A-22B, the applicant is presented a NEXT QUESTION button, and requested to confirm that it is the applicant's intent to skip a question (blocks 606, 608), some implementations eliminate this functionality. In some implementations, the applicant is provided a fixed time to answer all questions and the test ends upon completion of that time and/or when all questions have been answered (i.e., control skips to block 620 when the test time terminates or when answers have been saved (block 612) for each question). Other variations and/or modifications to the example implementation described in FIGS. 22A-22B abound and will be readily apparent to persons of ordinary skill in the art.

Returning to the example implementation shown in FIGS. 22A-22B, after the last question is answered or skipped (block 616), the test administrator 26 scores the English listening test by comparing the applicant's answers against a stored answer key (block 620). The assessor 30 then stores the English listening test score in the database 22 (FIG. 22B, block 622). Control then advances to block 624.

At block 624, the assessor 30 compares the English listening test score to a predetermined passing threshold. If the applicant's score exceeds the threshold, control advances to block 626 where the assessor 30 sets a recommended flag associated with the applicant 14 to indicate that the applicant 14 is still in the pool of recommended applicants 14. If the applicant's score falls below the threshold, control advances to block 628 where the assessor 30 sets a not recommended flag associated with the applicant 14 to indicate that the applicant 14 is no longer in the pool of recommended applicants 14. Irrespective of whether control branches through block 626 or block 628, control proceeds to block 630.

At block 630, the test administrator 26 displays a NEXT TEST button and awaits selection of the same by the applicant 14 (block 630). When the applicant 14 clicks the NEXT TEST button using, for example, a point and click device such as a mouse (block 630), the test administrator 26 calls the oral persuading test routine. Persons of ordinary skill in the art will appreciate that the NEXT TEST button can be omitted and the next test may be started automatically upon completion of the English listening test.

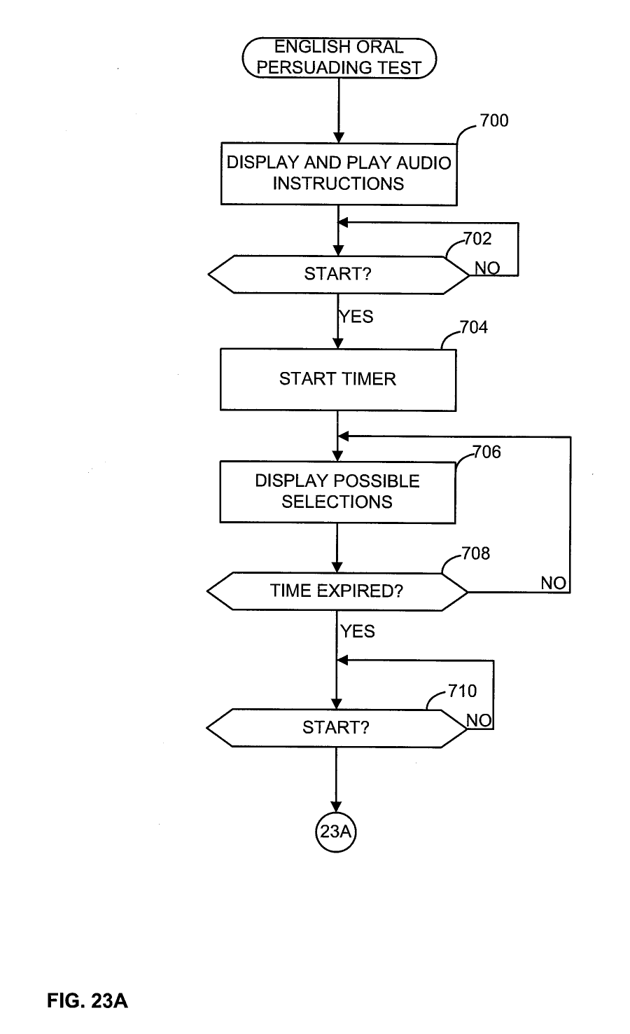

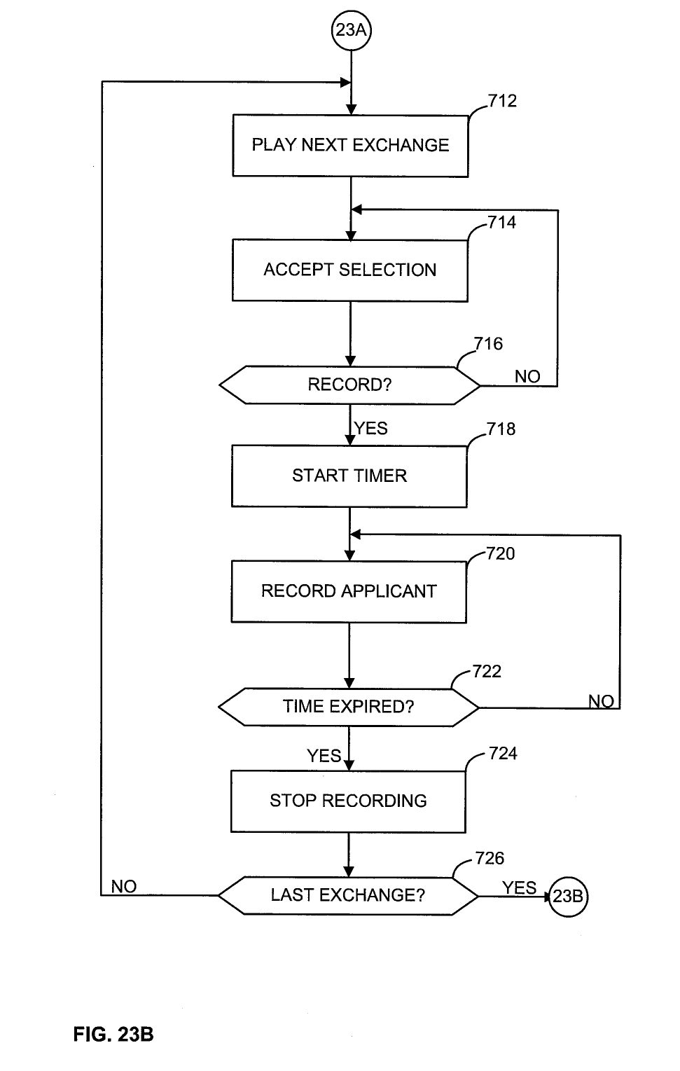

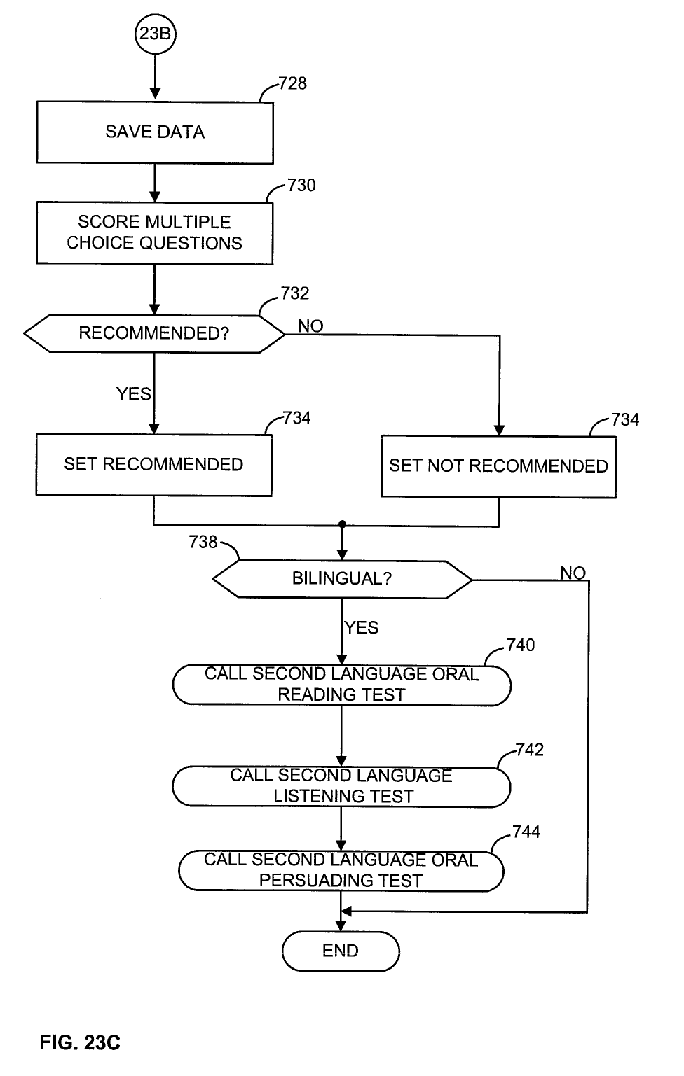

An example English oral persuading test routine is shown in FIGS. 23A-23C. The English oral persuading test routine of FIGS. 23A-23C begins at block 700 where the test administrator 26 displays the English oral persuading test instructions on the applicant's computer and plays an audio file corresponding to those instructions via the applicant's headphones. After the audio instructions have completely played (block 700), the test administrator 26 displays a START button and waits for the applicant 14 to select the same (block 702). Upon selection of the START button (block 702), control advances to block 704.

At block 704, the test administrator 26 starts a timer. The test administrator 26 also displays possible responses to comments from a hypothetical respondent during a hypothetical conversation with a call center employee (block 706). These responses are the pool of responses from which the applicant is to select in the following test. These responses are displayed to give the applicant 14 an opportunity to become familiar with the same before the actual testing begins.

Upon expiration of the timer (block 708), the test administrator 26 plays a recording of the first hypothetical exchange between a respondent and a call center employee. The applicant 14 is then required to select one of the possible responses displayed on the screen (e.g., by clicking on the response with a point and click device) as the most persuasive passage to be used in response to the hypothetical respondent's comment (block 714). After a passage is selected (block 714), the unselected passages disappear from the screen and the selected passage is displayed with a RECORD button.

When the applicant 14 selects the RECORD button (block 716), the test administrator 26 starts a timer (block 718) and begins recording the sounds captured by the microphone of the applicant's headset (block 720). The applicant 14 is expected to read the displayed passage aloud so that his/her voice can be recorded. The test administrator 26 will continue recording until the expiration of a predetermined time period set by the timer (block 722). Once the timer expires (block 722), the test administrator stops recording (block 724) and saves the recorded file in the database 22.

The test administrator 26 then determines if there are more test exchanges to be presented to the applicant 14 (block 726). If so, control returns to block 712 where the next exchange passage is played for the applicant to determine the appropriate response passage (block 712). Control continues to loop through blocks 712-726 until all of the test passages have been presented and answers to the same read aloud. When all of the test exchanges have been completed (block 726), control advances to block 728 of FIG. 23C.

At block 728, the test administrator 26 of the example recruiting system 10 stores the applicant's response selections and voice recordings in the database 22. The assessor 30 then scores the multiple choice response selections made during the English oral persuading test by comparing the applicant's answers against a stored answer key and stores the English oral persuading test score in the database 22 (block 730). Control then advances to block 732.

At block 732, the assessor 30 compares the English oral persuading test score to a predetermined passing threshold. If the applicant's score exceeds the threshold, control advances to block 734 where the assessor 30 sets a recommended flag associated with the applicant 14 to indicate that the applicant 14 is still in the pool of recommended applicants 14. If the applicant's score falls below the threshold, control advances to block 736 where the assessor 30 sets a not recommended flag associated with the applicant 14 to indicate that the applicant 14 is no longer in the pool of recommended applicants 14. Irrespective of whether control branches through block 734 or block 736, control proceeds to block 738.

At block 738, the test administrator 26 displays an “ARE YOU BILINGUAL?” question and awaits selection of a YES button or a NO button by the applicant 14 (block 738). If the applicant 14 selects the YES button (block 738), the tests have been completed and the program ends by automatically logging the applicant out of the system 10 and again displaying the example login screen of FIG. 3. If the applicant 14 selects the YES button (block 738), the test administrator 26 calls the second language (e.g., Spanish) written test routine (block 739). Persons of ordinary skill in the art will appreciate that, in some implementations, the applicant is not asked to indicate whether they are bilingual at block 738, but instead, the test administrator 26 checks the applicant's record to determine whether they have been scheduled for bilingual testing. If the applicant has been designated for bilingual testing, control advances to block 739. Otherwise, the tests have been completed and the program ends by automatically logging the applicant out of the system 10 and again displaying the example login screen of FIG. 3.

Assuming that bilingual testing is to occur, control advance from block 738 to block 739 where the second language written test routine is called. In the illustrated example, the second language written test is substantially identical to the English written test, but everything is done in the second language, instead of English. Since the flowchart for the second language written test is, thus, substantially identical to the flowchart for the English written test of FIGS. 19A-19B, the interested reader is referred to the flowchart of FIGS. 19A-19B for a complete explanation of the second language oral reading test.

Once the second language written test is completed (block 739), control advance to block 740 where the second language oral reading test routine is called. In the illustrated example, the second language oral reading test is substantially identical to the English oral reading test, but everything is done in the second language, instead of English. Since the flowchart for the second language oral reading test is, thus, substantially identical to the flowchart for the English oral reading test of FIGS. 21A-21B, the interested reader is referred to the flowchart of FIGS. 21A-21B for a complete explanation of the second language oral reading test.

At the conclusion of the second language oral reading test, the test administrator 26 calls the second language listening test (block 742).

In the illustrated example, the second language listening test is substantially identical to the English listening test, but everything is done in the second language, instead of English. Since the flowchart for the second language listening test is, thus, substantially identical to the flowchart for the English listening test of FIGS. 22A-22B, the interested reader is referred to the flowchart of FIGS. 22A-22B for a complete explanation of the second language listening test.

At the conclusion of the second language listening test, the test administrator 26 calls the second language oral persuading test (block 744).

In the illustrated example, the second language oral persuading test is substantially identical to the English oral persuading test, but everything is done in the second language, instead of English. Since the flowchart for the second language oral persuading test is, thus, substantially identical to the flowchart for the English oral persuading test of FIGS. 23A-23C (excluding blocks 738-744), the interested reader is referred to the flowchart of FIGS. 23A-23C for a complete explanation of the second language oral persuading test.

At the conclusion of the second language oral persuading test (block 744), the tests have been completed and the program ends by automatically logging the applicant out of the system.

Returning to FIG. 17, and assuming that the gatekeeper 24 identifies the user as a recruiter 12 (block 204), control advances to block 208. At block 208, the recruitment administrator 36 calls the voice and speech prescreening routine.

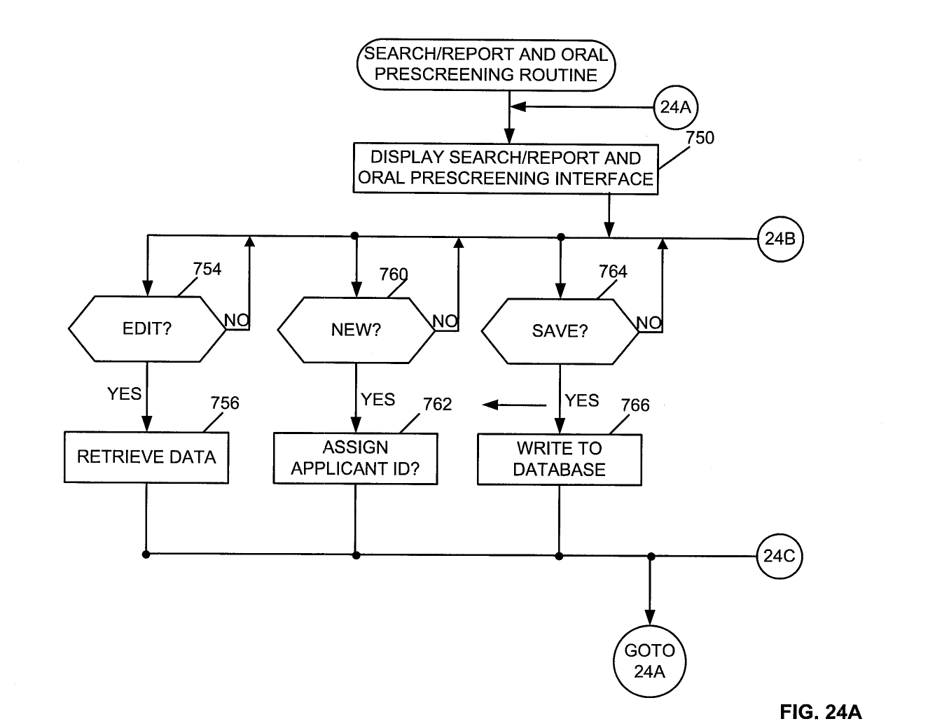

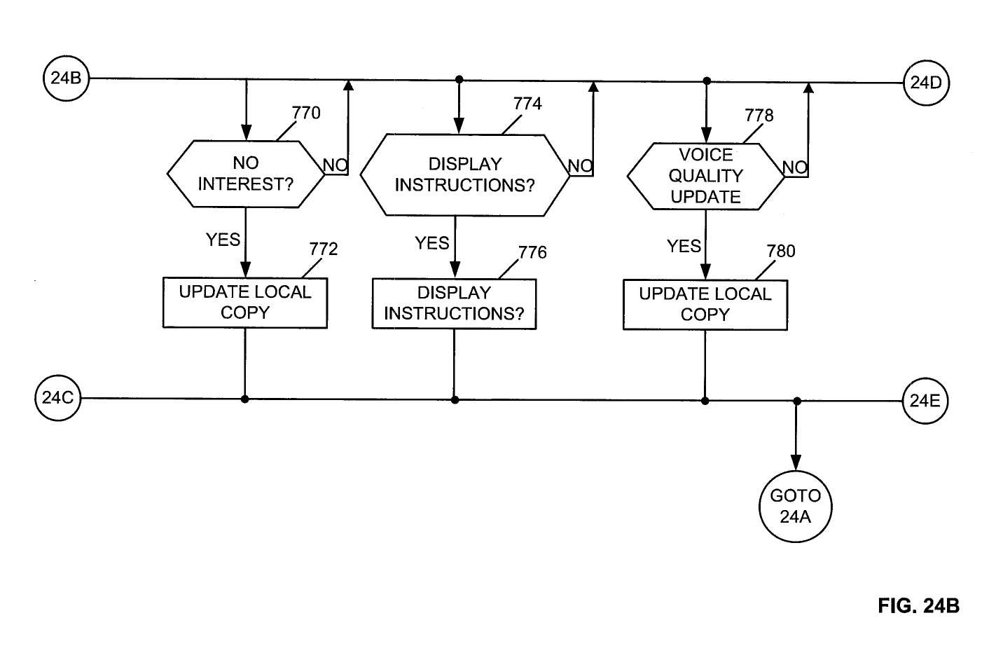

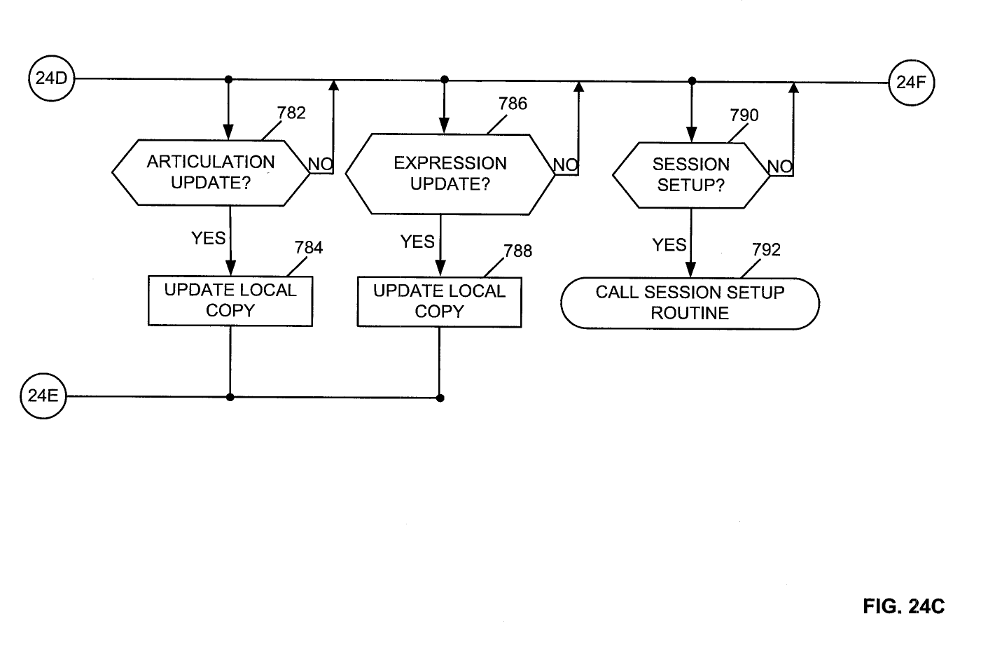

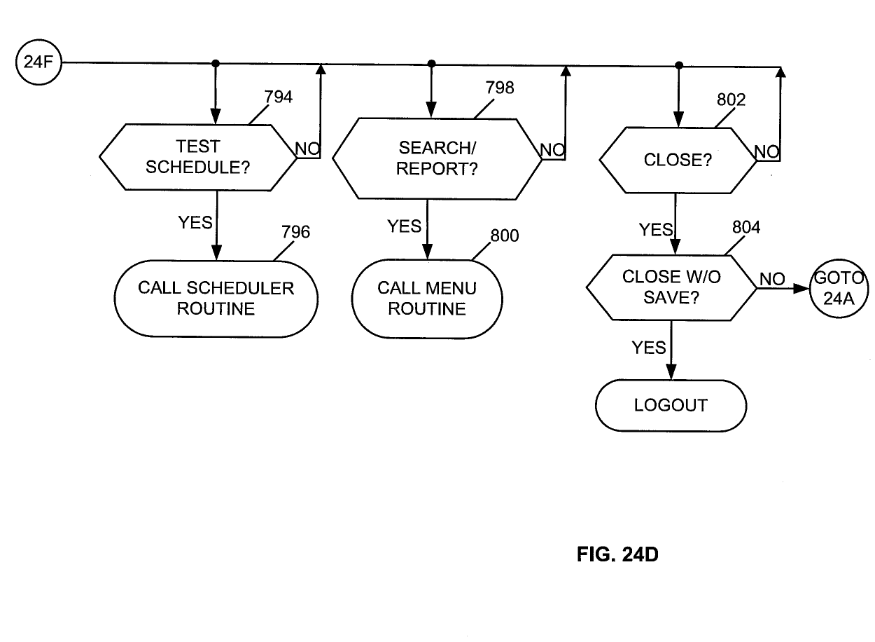

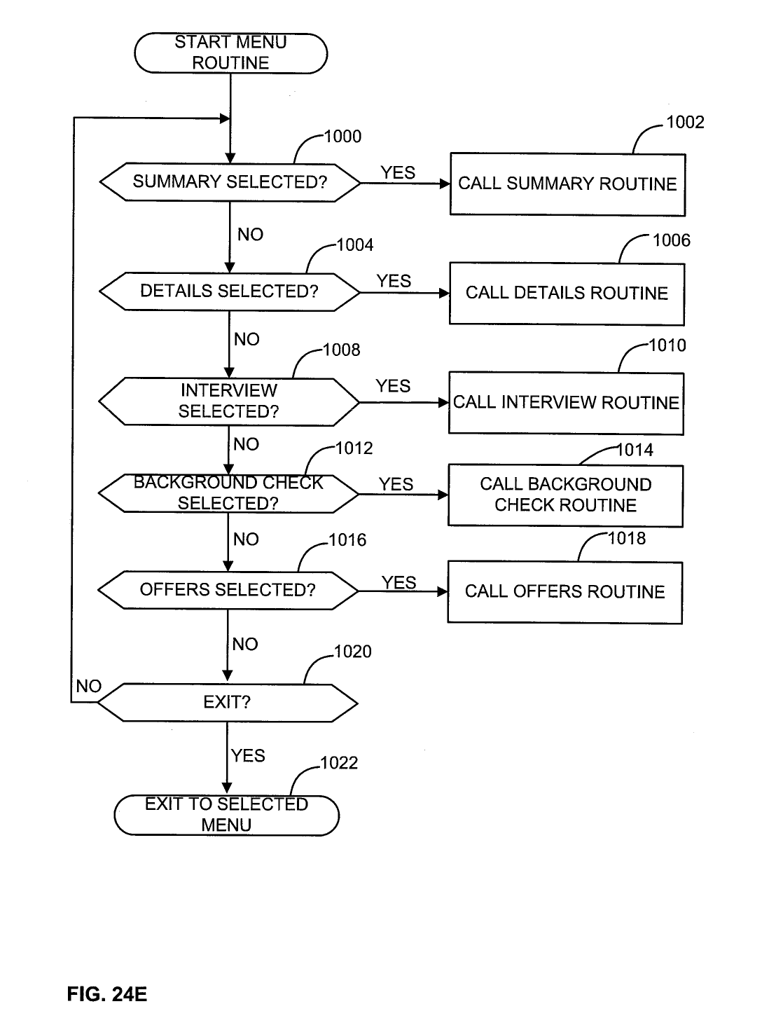

An example voice and speech routine is shown in FIGS. 24A-24D. The example search/report and oral prescreening routine of FIGS. 24A-24D begins at block 750 where the recruitment administrator 36 displays the voice and speech prescreening interface 48 of FIG. 4 (which, in the illustrated example, is the same as the voice and speech prescreening interface 48). The voice and speech prescreening interface 48 of the illustrated example, enables the recruiter 12 to perform many functions. For example, the recruiter 12 may fill in one or more of the name fields 50 and/or the applicant Id field 52 of the voice and speech prescreening interface 48 and select the EDIT button to search for applicant(s) 14 who are already existing in the database 22 (block 754). When the EDIT button is selected (block 754), the recruitment administrator 36 retrieves the corresponding records from the database 22 and populates the fields of the voice and speech prescreening interface 48 with the corresponding data (block 756). Control then returns to block 750 to await another user input.

If the recruiter 12 fills in one or more of the name fields 50 of the voice and speech prescreening interface 48 and selects the NEW button (block 760), the recruitment administrator 36 will create a new applicant record and assign that record a unique applicant Id (block 762). Control then returns to block 750 to await another user input.

If the recruiter 12 selects the SAVE button (block 764), the recruitment administrator 36 will save the local copy of any applicant record (new or edited) to the database 22 (block 766). Control then returns to block 750 to await another user input.

Additionally, if the recruiter 12 selects the DISPLAY INSTRUCTIONS button (FIG. 24B, block 774), the recruitment administrator 36 will retrieve and display instructions for interacting with the recruitment system 10 (block 776). Control then returns to block 750 of FIG. 24A to await another user input.

The voice and speech prescreening interface 48 of the illustrated example is also the voice and speech prescreening interface 48. Therefore, as shown in FIG. 24B, if a recruiter 12 contacts an applicant 14 and learns that the applicant 14 is not interested in the position, the recruiter 12 can select the CANDIDATE NOT INTERESTED field 54 (block 770). The recruitment administrator 36 responds to such a selection by updating the local copy of the corresponding applicant's record (block 772). Control then returns to block 750 of FIG. 24A to await another user input. For example, the recruiter 12 may desire to save the record (FIG. 24A, block 764) to ensure the permanent record in the database 22 indicates that the applicant 14 is no longer a recommended candidate due to lack of interest.

Additionally, the recruiter 12 can select one of the voice quality inputs of the voice and speech prescreening interface 48 to input the perceived voice quality of the applicant 14 into the database 22 (FIG. 24B, block 778). When a voice quality selection is made (block 778), the recruitment administrator 36 updates the local copy of the corresponding applicant's record (block 780). Control then returns to block 750 of FIG. 24A to await another user input.

Further, the recruiter 12 can select one of the articulation inputs of the voice and speech prescreening interface 48 to input the perceived articulation rating of the applicant 14 into the database 22 (FIG. 24C, block 782). When an articulation ranking selection is made (block 782), the recruitment administrator 36 updates the local copy of the corresponding applicant's record (block 784). Control then returns to block 750 of FIG. 24A to await another user input.

Similarly, the recruiter 12 can select one of the expression inputs of the voice and speech prescreening interface 48 to input the perceived expression rating of the applicant 14 into the database 22 (FIG. 24C, block 786). When an expression ranking selection is made (block 786), the recruitment administrator 36 updates the local copy of the corresponding applicant's record (block 788). Control then returns to block 750 of FIG. 24A to await another user input.

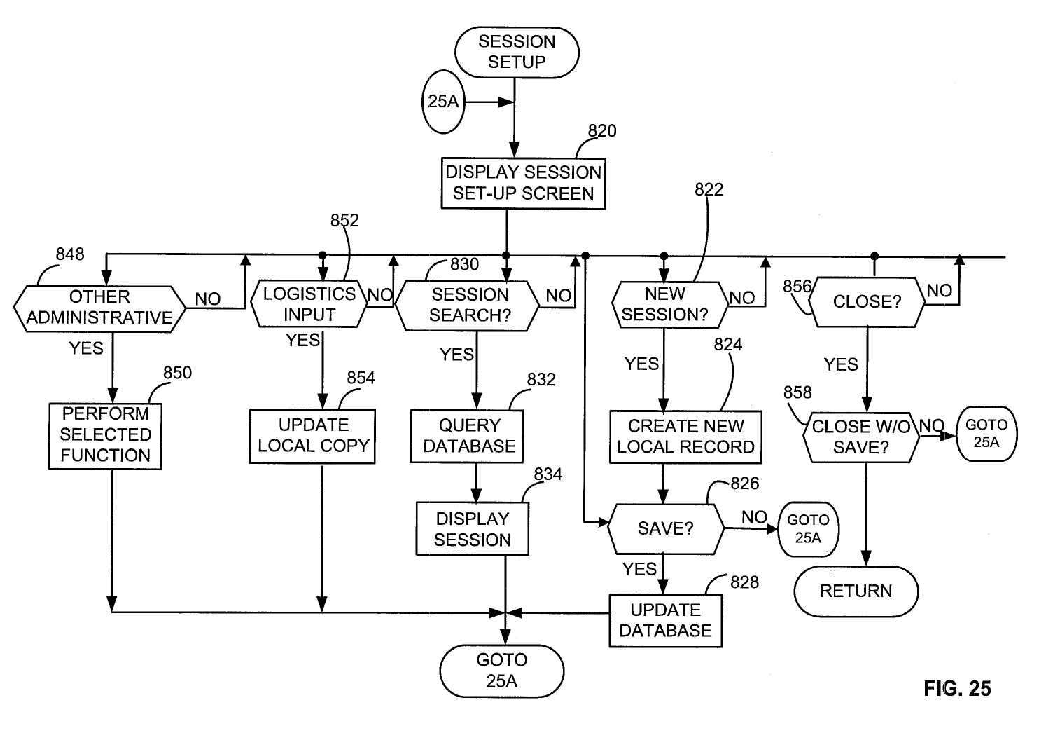

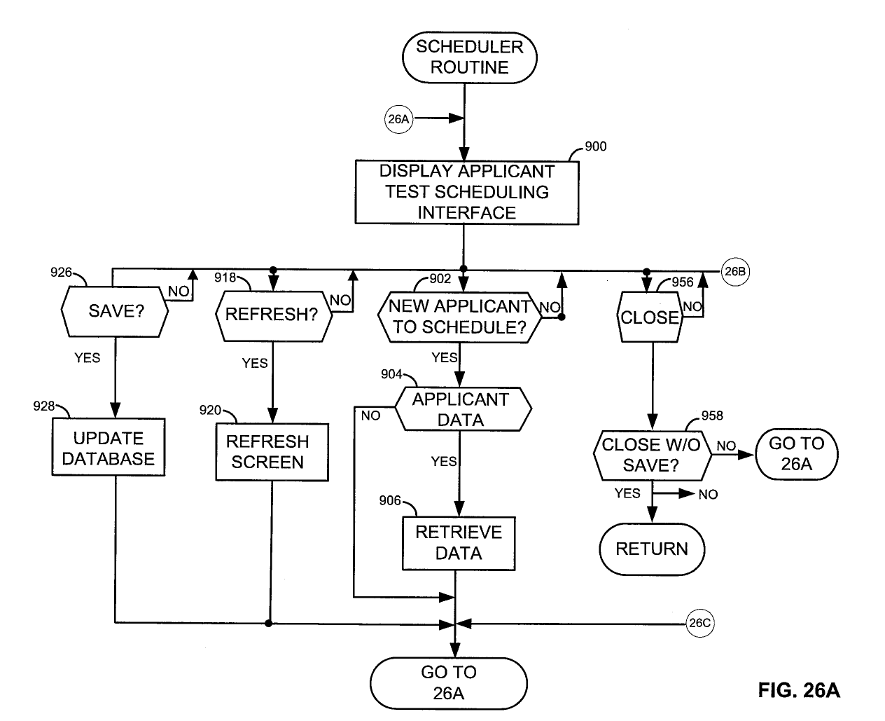

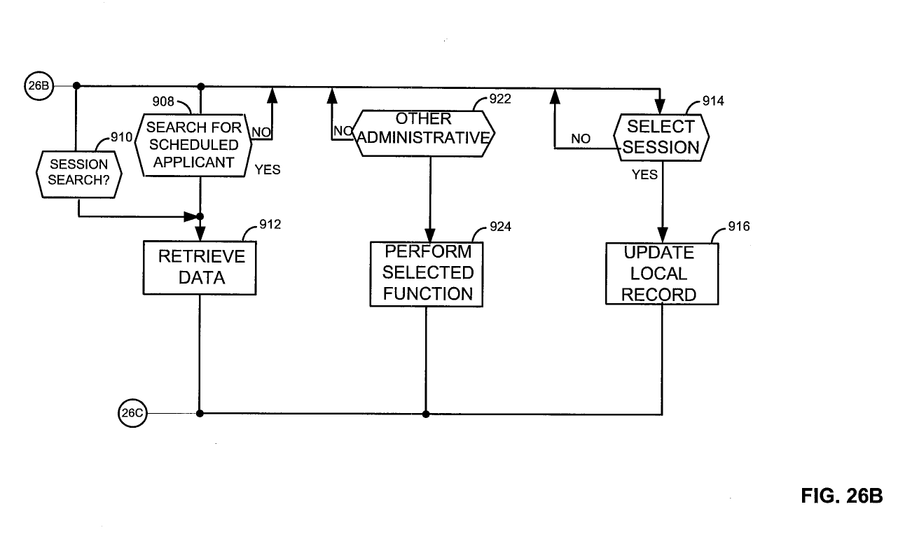

The voice and speech prescreening interface 48 of the illustrated example also provides a menu bar for reaching other interfaces of the example recruiting system 10. For instance, as shown in FIG. 24C, the recruiter 12 can select the session set-up tab (block 790) to call the example session set-up routine of FIG. 25 (block 792). As another example, as shown in FIG. 24D, the recruiter 12 can select the session scheduling tab to call the example scheduler routine of FIGS. 26A-26B (block 796). As still another example, the recruiter 12 can select the search/report tab (block 798) to call the example menu routine of FIG. 24E (block 800).

If the recruiter wishes to exit the voice and speech prescreening interface 48 of the illustrated example, the recruiter 12 can select the CLOSE button (block 802). Upon detecting selection of the CLOSE button (block 802), the recruitment administrator 36 will display a message asking if the recruiter 12 wants to exit the assessment process for the current record without saving any changes made to the same (block 804). If the recruiter 12 selects a YES button, the recruiter 12 is logged out and control returns to block 200 of FIG. 17. If, on the other hand, the recruiter 12 selects the NO button (block 804), control returns to block 750 (FIG. 24A) to await a further input from the recruiter 12.

Assuming, for purposes of discussion, that the recruiter 12 selects the session set-up tab (FIG. 24C, block 790), the recruitment administrator 36 calls the example session set-up routine of FIG. 25 (block 792). As shown in FIG. 25, the example session set-up routine begins at block 820 where the scheduler 32 displays the example session set-up interface 56 of FIG. 5 (block 820). The example session set-up interface enables the recruiter 12 to perform a number of functions.

For example, if the recruiter 12 selects the NEW button (block 822), the scheduler 32 creates a new local record corresponding to a new session (block 824). The scheduler 32 then asks the recruiter 12 if he/she desires to save the new session to the database 22 (block 826). If the recruiter 12 indicates that he/she does not wish to save the local record (block 826), control returns to block 820. If the recruiter 12 indicates that he/she does wish to save the local record (block 826), the scheduler writes the local record to the database 22, thereby making the session available for scheduling by other recruiters 12 (block 828). Control then returns to block 820.

As another example, a recruiter 12 can enter one or more search criteria into the search fields of the session set-up interface and select the SEARCH button (block 830). Upon detecting selection of the SEARCH button (block 830), the scheduler 32 will search for and retrieve the session record(s) corresponding to the search criteria from the database 22 (block 832). The scheduler 32 displays the search results in the session set-up interface (block 834). Control then returns to block 820 to await further input from the recruiter 12.

The session set-up interface 56 of the illustrated example provides various administrative functions. For example, the interface 56 provides a DELETE button, a PRINT button, and an EXPORT button to enable the recruiter to delete sessions from the database 22, print displayed sessions, and export sessions to, for example, a Microsoft Excel spreadsheet, respectively. Thus, if the scheduler 32 detects selection of one of the DELETE, PRINT, and/or EXPORT buttons (block 848), the scheduler 32 will perform the corresponding function (block 850). Control then returns to block 820 to await further input from the recruiter 12.

The session set-up interface 56 of the illustrated example also permits the recruiter 12 to select a session from a list of displayed sessions and to change and/or set the date, time, place, location, room, capacity and/or proctor (referred to collectively and individually as logistic inputs) for the selected session. Thus, if the scheduler 32 detects entry of a new logistics input (block 852), the scheduler 32 updates the local copy of the record for the corresponding session (block 854). Control then returns to block 820 to await further input from the recruiter 12.

If the recruiter 12 selects the SAVE button (block 826), the scheduler 32 saves the local copy of any session record (new or edited) to the database 22 (block 828). Control then returns to block 820 to await another user input.

If the recruiter 12 wishes to exit the session set-up interface 56 of the illustrated example, the recruiter 12 can select the CLOSE button (block 856). Upon detecting selection of the CLOSE button (block 856), the scheduler 32 displays a message asking if the recruiter 12 wants to close the current record without saving any changes made to the same (block 858). If the recruiter 12 selects a YES button, control returns to block 750 of FIG. 24A. (Alternatively, control can return to block 200 of FIG. 17 which will require the recruiter to login again to take further action in the system 10). If, on the other hand, the recruiter 12 selects the NO button (block 858), control returns to block 820 (FIG. 25) to await a further input from the recruiter 12.

Returning to FIG. 24D and assuming, for purposes of discussion, that the recruiter 12 selects the session scheduling tab of the voice and speech prescreening interface 48 (block 794), the recruitment administrator 36 calls the example scheduler routine of FIGS. 26A-26B (block 796). As shown in FIG. 26A, the example scheduler routine begins at block 900 where the scheduler 32 displays the example applicant test scheduling interface 58 of FIG. 6 (block 900). The example applicant test scheduling interface enables the recruiter 12 to perform a number of functions.

For example, if the recruiter 12 selects the NEW button (block 902), the scheduler 32 determines if the recruiter 12 has entered applicant identifying data into the search fields (block 904). If not, control returns to block 900 to await further recruiter input. If, on the other hand, the recruiter 12 has entered sufficient data to uniquely identify the applicant 14 to be scheduled (e.g., by entering the applicant id), the scheduler 32 retrieves a copy of the corresponding applicant's record from the database 22 (block 906). Control then returns to block 900 to await further input from the recruiter 12.

As another example, a recruiter 12 can enter one or more search criteria into the applicant search fields of the applicant test scheduling interface 58 and select the SEARCH button to search for a scheduled applicant (FIG. 26B, block 908). Alternatively, the recruiter 12 can enter one or more search criteria into the session search fields and select the SEARCH button to search for scheduled sessions (FIG. 26B, block 910). Upon detecting selection of the SEARCH button (block 908 or 910), the scheduler 32 searches for and retrieves the record(s) corresponding to the search criteria from the database 22 (block 912). The scheduler 32 displays the search results in the interface 58 and control returns to block 900 of FIG. 26B to await further input from the recruiter 12.

The applicant test scheduling interface 58 also enables the recruiter 12 to schedule an applicant to attend a test session by selecting a session from a retrieved list of sessions. Upon detecting selection of a session (block 914), the scheduler 32 identifies the selected test session in the local copy of the applicant record for the applicant being scheduled and adds the applicant to the local copy of the record corresponding to the selected session (block 916). Control then returns to block 900 to await further input from the recruiter 12.

The applicant test scheduling interface 58 also enables the recruiter 12 to refresh the screen by selecting a REFRESH button. Upon detecting selection of the REFRESH button (FIG. 26A, block 918), the scheduler 32 updates the display of the applicant test scheduling interface 58 to reflect any data changes made in the database 22 and/or locally (block 928). Control then returns to block 900 to await further input from the recruiter 12.

The applicant test scheduling interface 58 of the illustrated example provides various administrative functions. For example, the interface 58 provides a DELETE button, a PRINT button, and an EXPORT button to enable the recruiter to delete applicants from sessions, print displayed records, and export records to, for example, a Microsoft Excel spreadsheet, respectively. Thus, if the scheduler 32 detects selection of one of the DELETE, PRINT, and/or EXPORT buttons (FIG. 26B, block 922), the scheduler 32 will perform the corresponding function (block 924). Control then returns to block 900 of FIG. 26A to await further input from the recruiter 12.

If the recruiter 12 selects the SAVE button (FIG. 26A, block 926), the scheduler 32 saves the local copy of any open record(s) (new or edited) to the database 22 (block 928). Control then returns to block 900 to await another user input.

If the recruiter 12 wishes to exit the applicant test scheduling interface 58 of the illustrated example, the recruiter 12 can select the CLOSE button (FIG. 26A, block 956). Upon detecting selection of the CLOSE button (block 956), the scheduler 32 displays a message asking if the recruiter 12 wants to exit the assessment process and close the current record without saving any changes made to the same (block 958). If the recruiter 12 selects a YES button, control returns to block 750 of FIG. 24A. (Alternatively, control can return to block 200 of FIG. 17 which will require the recruiter to login again to take further action in the system 10). If, on the other hand, the recruiter 12 selects the NO button (block 958), control returns to block 900 (FIG. 26A) to await a further input from the recruiter 12.

Returning to FIG. 24D and assuming, for purposes of discussion, that the recruiter 12 selects the search/report tab of the voice and speech prescreening interface 48 (block 798), the recruitment administrator 36 calls the example menu routine of FIG. 24E (block 800). As shown in FIG. 7, in response to selection of the search/report tab (block 800), the recruitment administrator 36 displays a menu of additional tabs to enable the recruiter 12 to access the summary interface 63, the details interface 64, the interview interface 66, the background check interface 70, and/or the offers interface 72. To this end, the example menu routine executes a loop (FIG. 24E, blocks 1000-1020) where the recruitment administrator 36 waits to receive a selection of one of the additional tabs noted above.

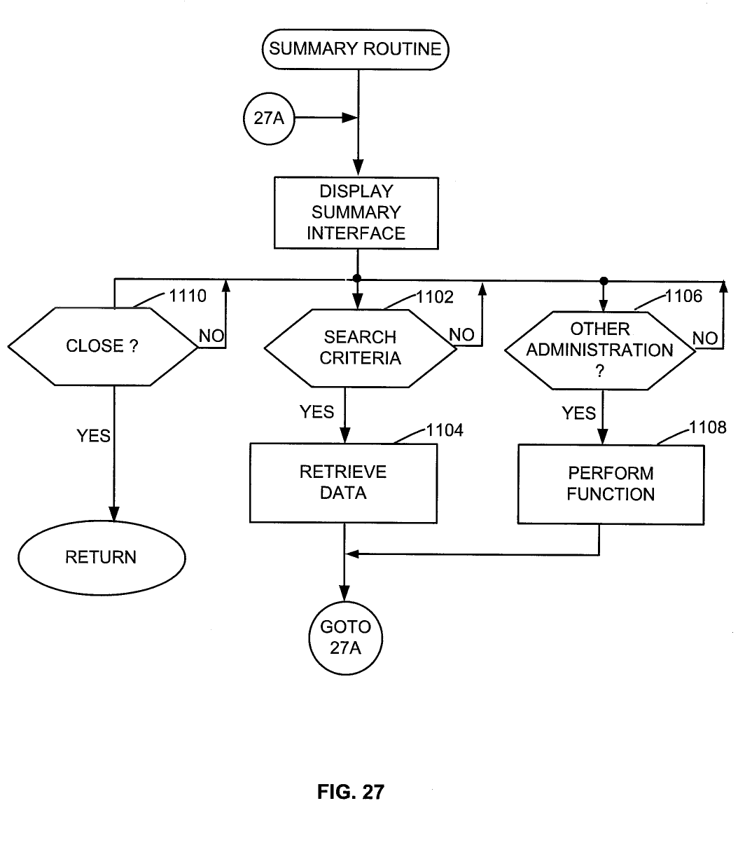

In particular, the example loop of FIG. 24E begins at block 1000 where the recruitment administrator 36 determines if the summary tab has been selected. If so, the recruitment administrator 36 calls the example summary routine of FIG. 27 (block 1002). If the summary tab is not selected (block 1000), control advances to block 1004.

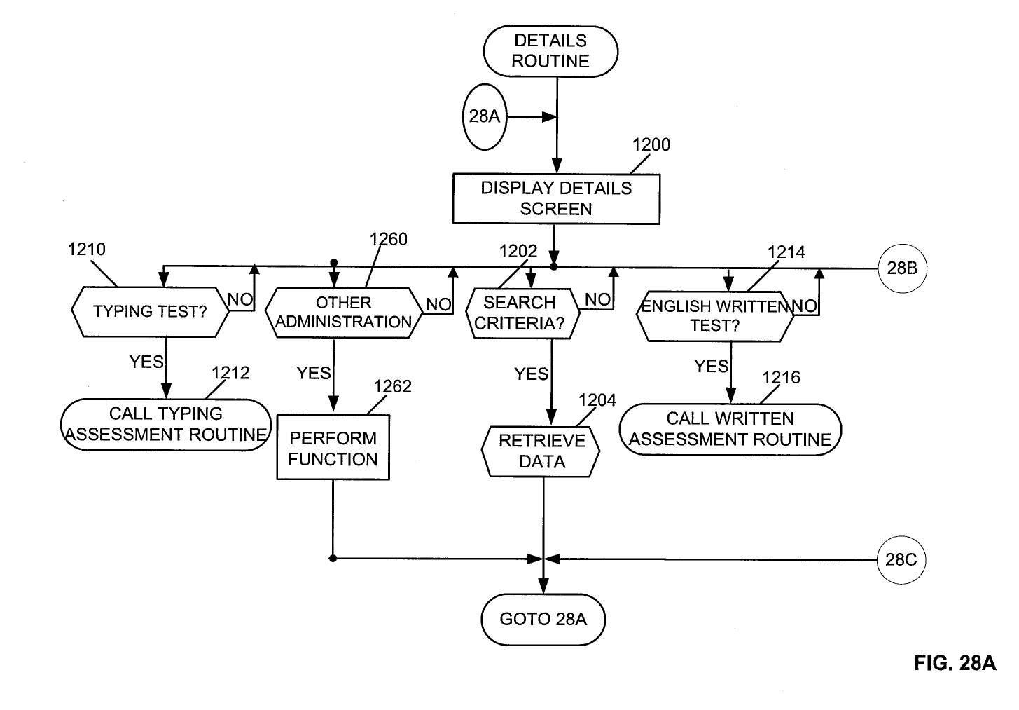

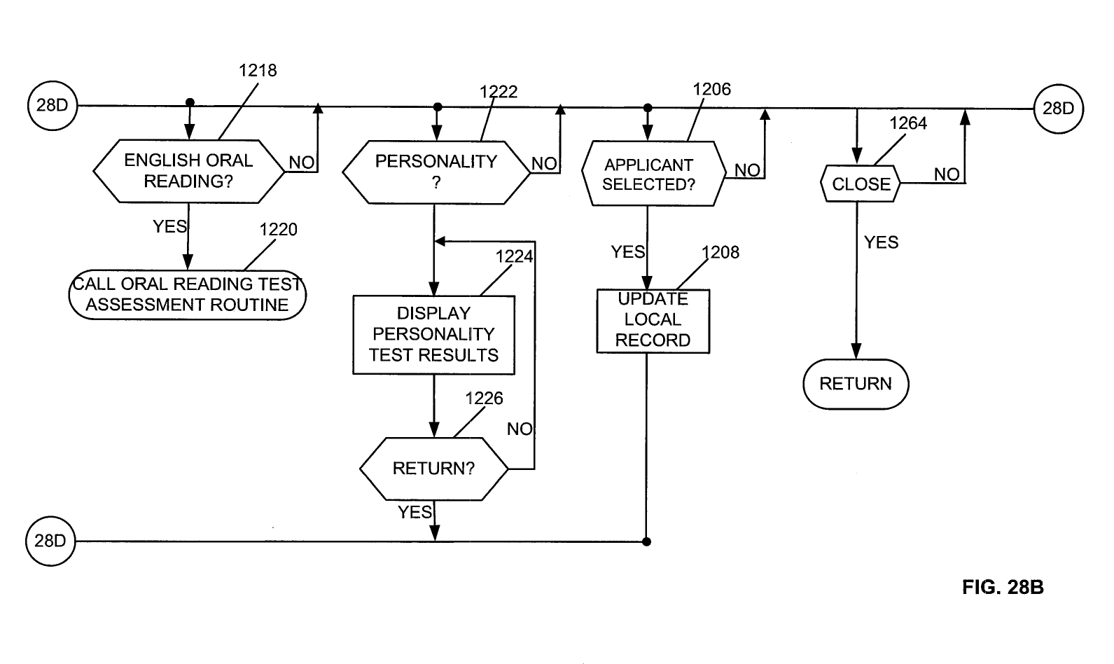

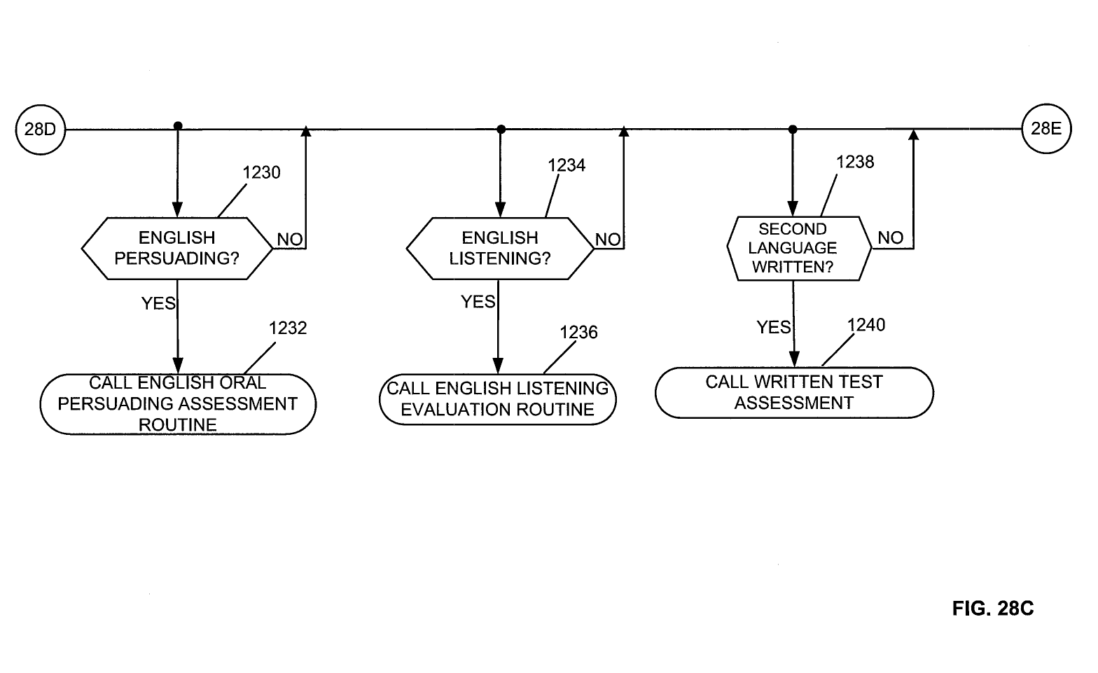

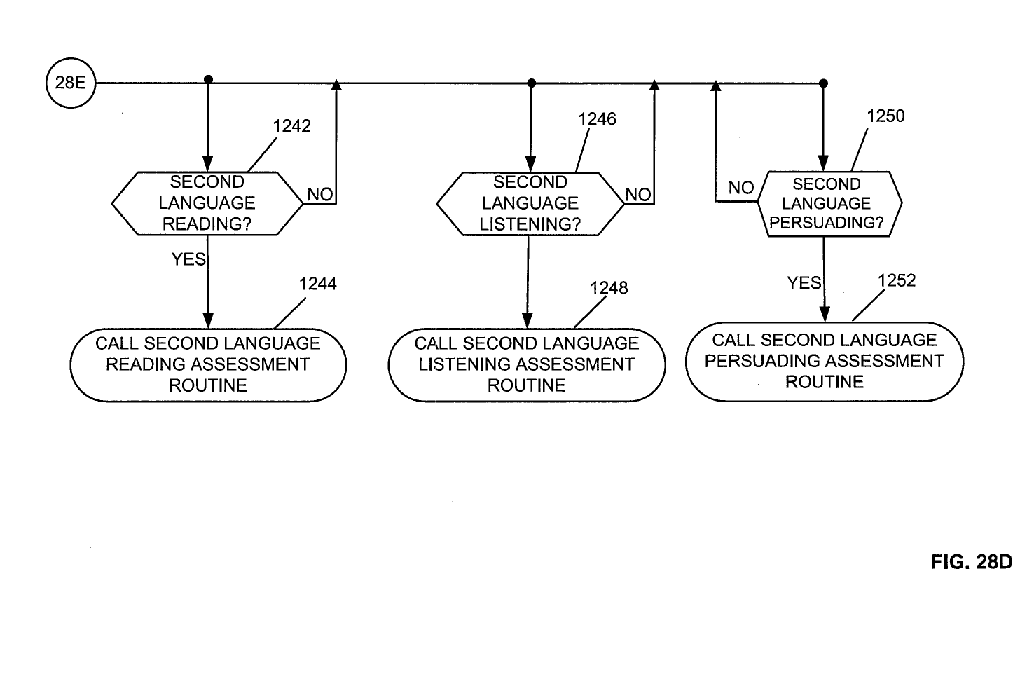

At block 1004, the recruitment administrator 36 determines if the details tab has been selected. If so, the recruitment administrator 36 calls the example details routine of FIGS. 28A-28D (block 1006). If the details tab is not selected (block 1004), control advances to block 1008.

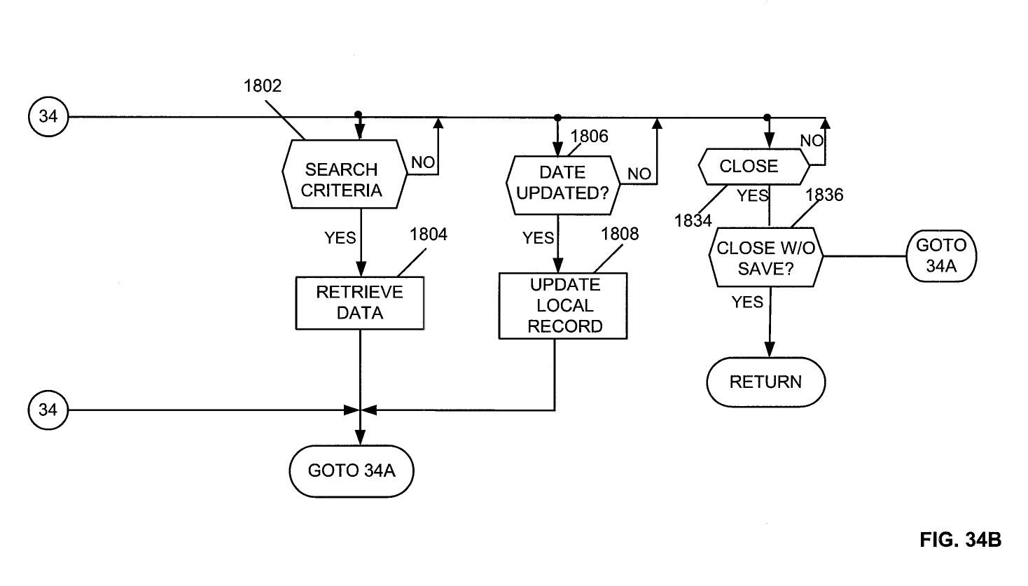

At block 1008, the recruitment administrator 36 determines if the interview tab has been selected. If so, the recruitment administrator 36 calls the example interview routine of FIGS. 34A-34B (block 1010). If the interview tab is not selected (block 1010), control advances to block 1012.

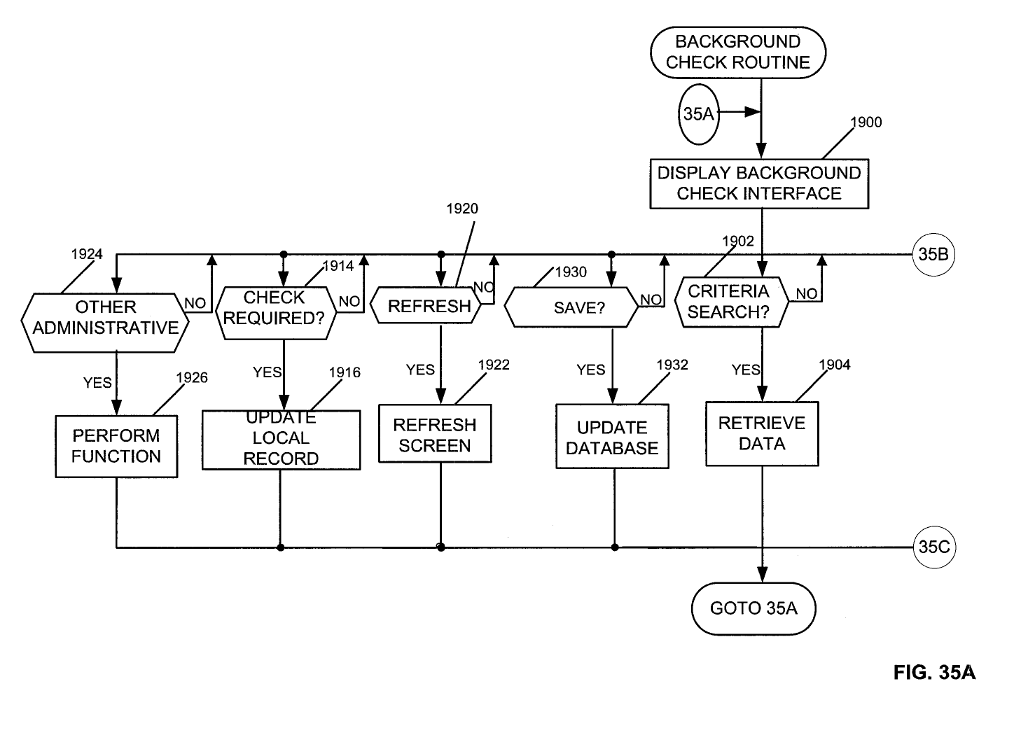

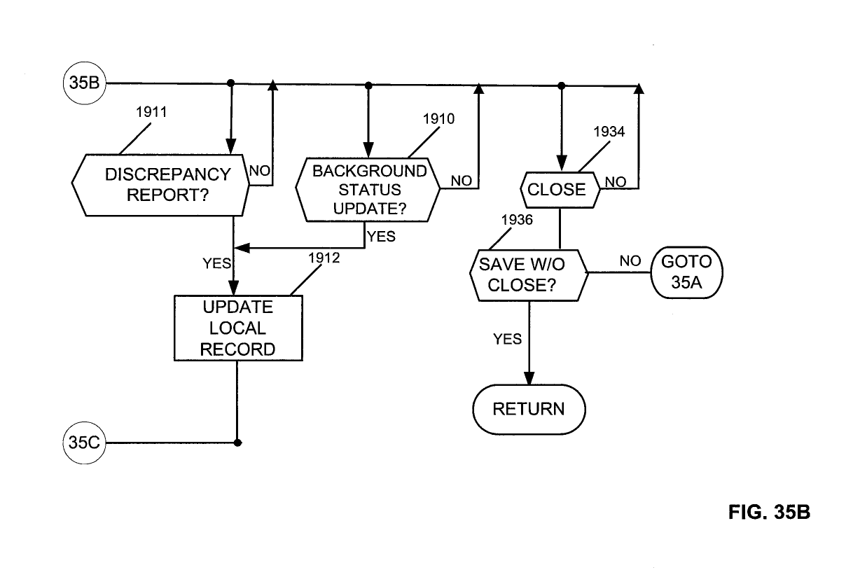

At block 1012, the recruitment administrator 36 determines if the background check tab has been selected. If so, the recruitment administrator 36 calls the example background check routine of FIGS. 35A-35B (block 1014). If the background check tab is not selected (block 1014), control advances to block 1016.

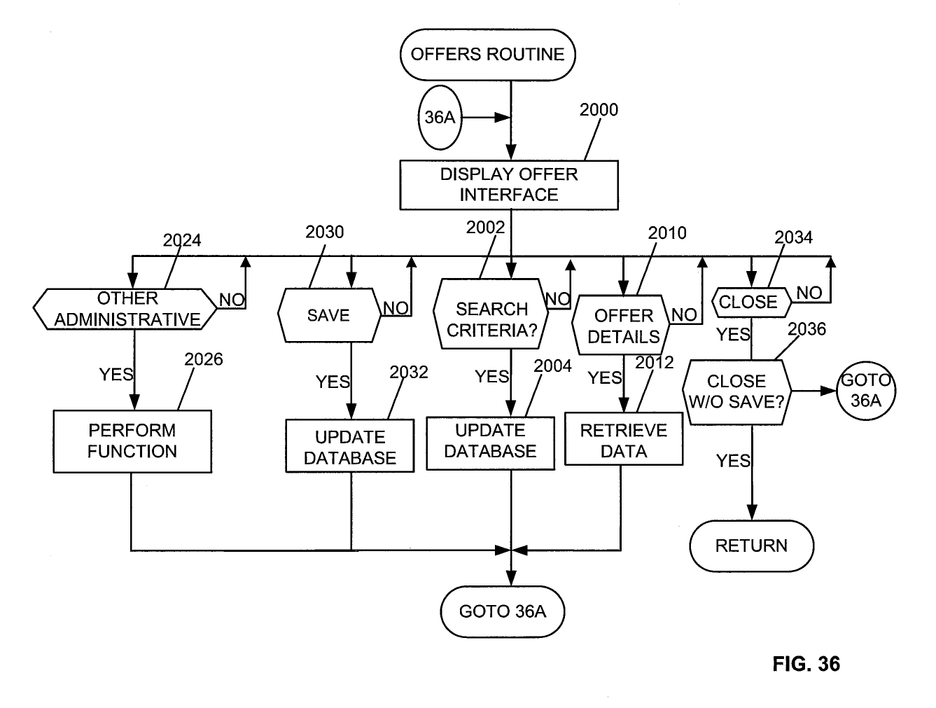

At block 1016, the recruitment administrator 36 determines if the offers tab has been selected. If so, the recruitment administrator 36 calls the example offers routine of FIG. 36 (block 1018). If the offers tab is not selected (block 1016), control advances to block 1020.

At block 1020, the recruitment administrator 36 determines if the recruiter 12 has selected the CLOSE button, the voice and speech prescreening tab, the session set-up tab or the session scheduling tab. If so, the recruitment administrator 36 ends the example menu routine of FIG. 24E (block 1022) and transfers control to the selected interface. For instance, if the CLOSE button is selected, the recruitment administrator 36 logs the recruiter out and displays the example login interface of FIG. 3. If the voice and speech prescreening tab is selected, the recruiting administrator returns control to block 750 of FIG. 24A. If the session set-up tab is selected, the recruiting administrator 36 returns control to block 792 of FIG. 24C and calls the example session set-up routine of FIG. 25 (block 792). If the session scheduling tab is selected, the recruiting administrator 36 returns control to block 796 of FIG. 24D and calls the example scheduler routine of FIGS. 26A-26B (block 796).

Control continues to loop through blocks 1000-1020 until the recruiter selects one of the exit options at block 1020.

Assuming, for purposes of discussion, that the recruiter 12 selects the summary tab (block 1000 of FIG. 24E), the recruitment administrator 36 calls the example summary routine of FIG. 27. The example summary routine of FIG. 27 begins at block 1100 where the recruitment administrator 36 displays the example summary interface 63 of FIG. 7.

The example summary interface 63 of FIG. 7 provides a vehicle for the recruiter 12 to review the status of one or more recruitment efforts. In the illustrated example, it is not a vehicle for inputting data. Thus, for example, the summary interface 63 enables the recruiter 12 to enter search criteria to search for a status summary of one or more recruitment projects by entering, for example, a recruiter name, a location of the position being offered, and/or a range of test dates. When the recruitment administrator 36 detects entry of one or more search criteria and selection of the SEARCH button (block 1102), the recruitment administrator 36 retrieves the corresponding data from the database 22 (block 1104). Control then returns to block 1000 where the recruitment administrator 36 displays the summary status for each recruitment project corresponding to the search criteria and awaits further input from the recruiter 12.

The summary interface 63 of the illustrated example provides various administrative functions. For example, the interface 63 provides a PRINT button and an EXPORT button to enable the recruiter to print displayed records and to export records to, for example, a Microsoft Excel spreadsheet, respectively. Thus, if the recruitment administrator 36 detects selection of one of the PRINT, and/or EXPORT buttons (block 1106), the recruitment administrator 36 performs the corresponding function (block 1108). Control then returns to block 1100 to await further input from the recruiter 12.

If the recruiter 12 wishes to exit the summary interface 63 of the illustrated example, the recruiter 12 can select the CLOSE button (block 1110). Upon detecting selection of the CLOSE button (block 1110), the recruitment administrator 36 returns control to block 1000 of FIG. 24E. In some implementations, control is instead returned to bock 200 of FIG. 17.

Assuming, for purposes of discussion, that the recruiter 12 selects the details tab (block 1004 of FIG. 24E), the recruitment administrator 36 calls the example details routine of FIGS. 28A-28D. The example details routine of FIGS. 28A-28D begins at block 1200 where the recruitment administrator 36 displays the example details interface 64 of FIG. 8.

The example details interface 64 of FIG. 8 provides a vehicle for the recruiter 12 to manually score the tests taken by one or more applicant(s) 14. Thus, for example, the details interface 64 enables the recruiter 12 to enter search criteria to search for one or more applicant(s) by entering, for example, applicant identification information (e.g., name and/or identification number), a recruiter name, a location of the position being offered, test types, and/or a range of test dates. When the recruitment administrator 36 detects entry of one or more search criteria and selection of the SEARCH button (block 1202), the recruitment administrator 36 retrieves the corresponding data from the database 22 (block 1204). Control then returns to block 1200 where the recruitment administrator 36 displays the testing status for each applicant 14 corresponding to the search criteria and awaits further input from the recruiter 12.

If the recruiter 12 wishes to assess one or more of the tests of an applicant 14, the recruiter 12 will select the applicant in the details report screen. When the recruitment administrator 36 detects selection of an applicant 14 (FIG. 28B, block 1206), the recruitment administrator 36 designates the local copy of the record of the selected applicant 14 as active (block 1208). Control then returns to block 1200 of FIG. 28A to await further input from the recruiter 12.

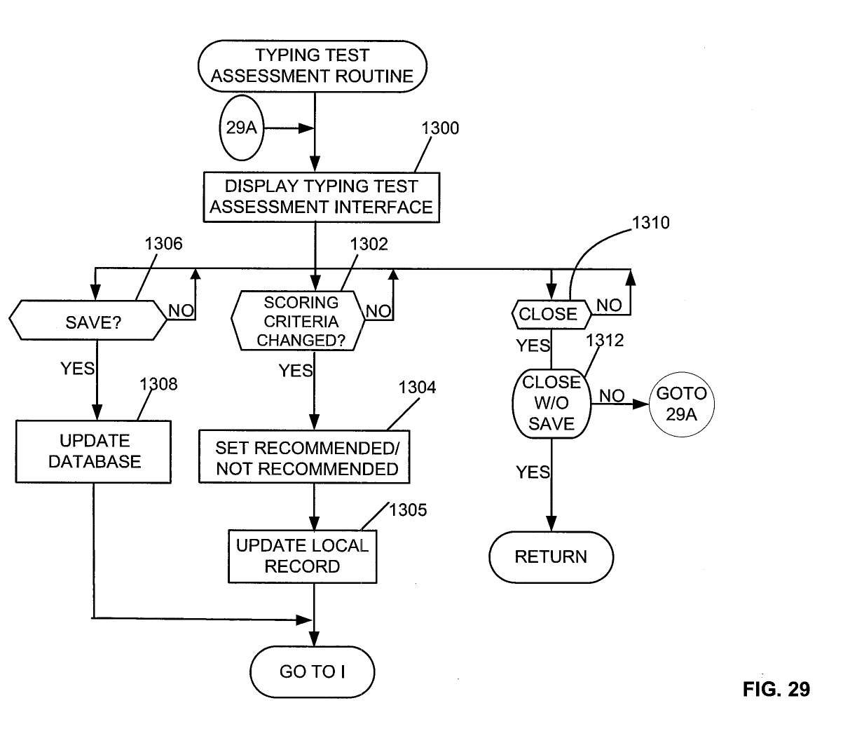

If the recruiter 12 wishes to score and/or review the test results of the selected applicant 14, the recruiter 12 selects the corresponding column of the details report. For example, if the recruiter 12 wishes to review and/or assess the results of the applicant's typing test, the recruiter 12 selects the typing test column. When the recruitment administrator 36 detects selection of the typing test column (FIG. 28A, block 1210), the recruitment administrator 36 retrieves the typing test record for the selected applicant 14 and calls the typing test assessment routine of FIG. 29 (block 1212).

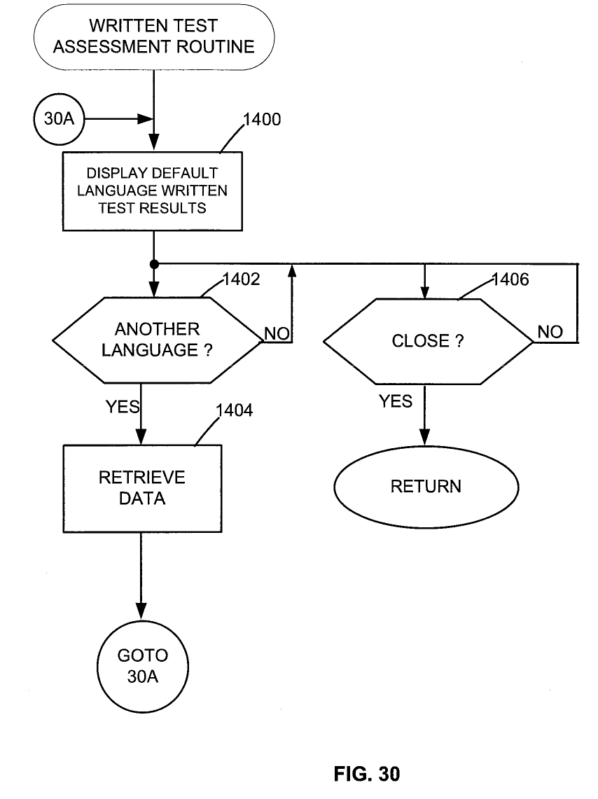

If the recruiter 12 wishes to review the results of the applicant's English written test, the recruiter 12 selects the English written test column. When the recruitment administrator 36 detects selection of the English written test column (FIG. 28A, block 1214), the recruitment administrator 36 retrieves the English written test record for the selected applicant 14 and calls the English written test assessment routine of FIG. 30 (block 1216).

If the recruiter 12 wishes to review the results of the applicant's personality inventory test, the recruiter 12 selects the personality inventory test column. When the recruitment administrator 36 detects selection of the personality inventory test column (FIG. 28B, block 1222), the recruitment administrator 36 retrieves and displays the personality inventory test record for the selected applicant 14 (block 1224). The recruitment administrator 36 then awaits an input from the recruiter 12 indicating that the personality inventory test results display should be closed (block 1226). Upon detection of such a command, the recruitment administrator 36 closes the personality inventory results display. Control then returns to block 1200 of FIG. 28A to await further input from the recruiter 12.

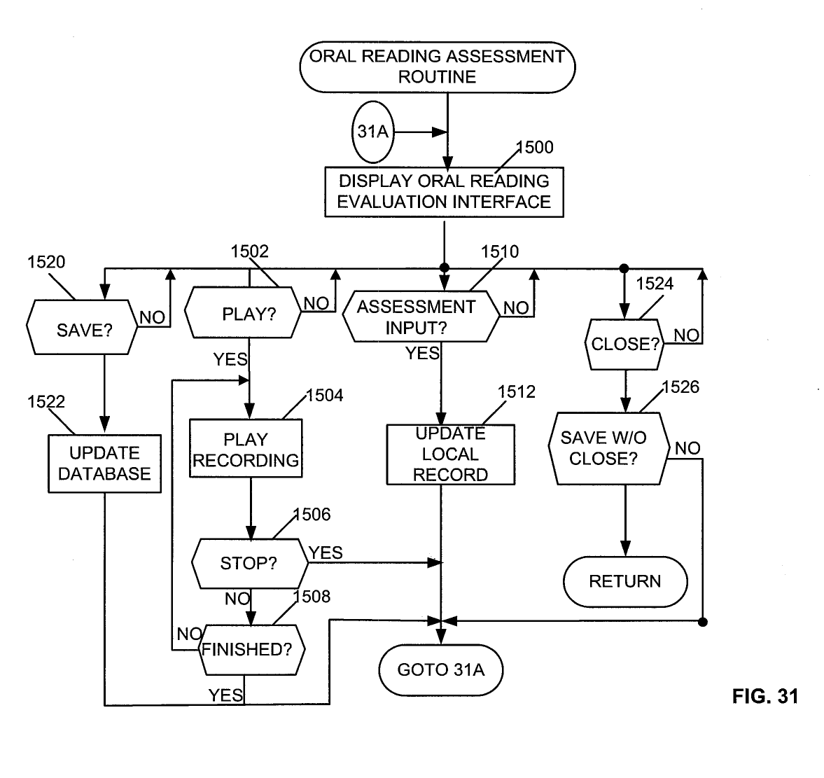

If the recruiter 12 wishes to review and/or score the results of the applicant's English oral reading test, the recruiter 12 selects the English oral reading test column. When the recruitment administrator 36 detects selection of the English oral reading test column (FIG. 28B, block 1218), the recruitment administrator 36 retrieves the English oral reading test record for the selected applicant 14 and calls the English oral reading test assessment routine of FIG. 31 (block 1220).

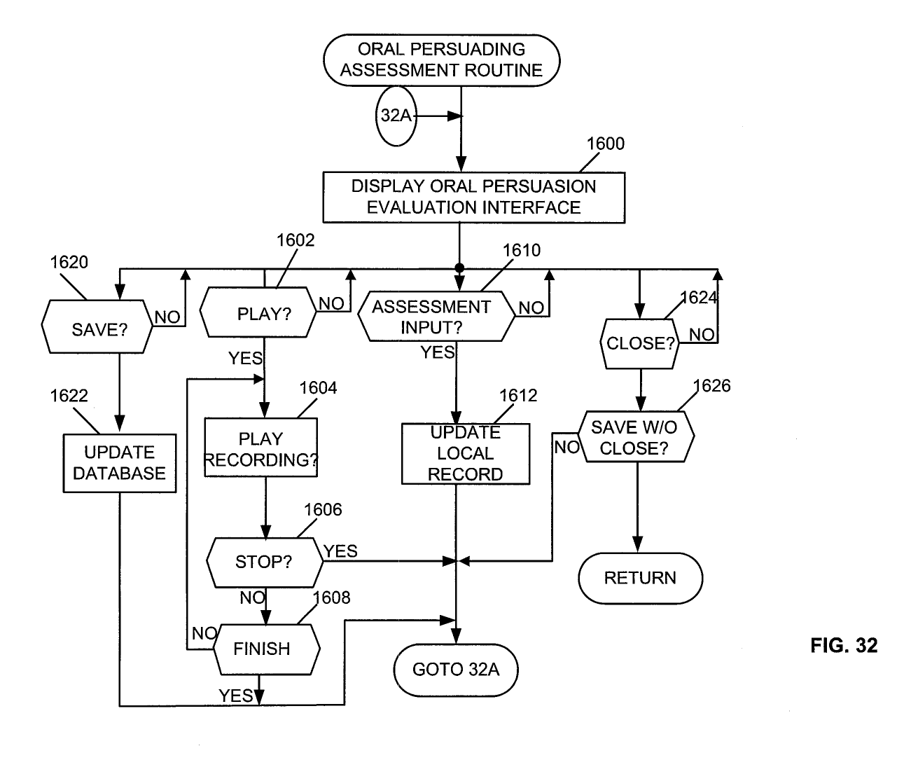

If the recruiter 12 wishes to review and/or score the results of the applicant's English oral persuading test, the recruiter 12 selects the English oral persuading test column. When the recruitment administrator 36 detects selection of the English oral persuading test column (FIG. 28C, block 1230), the recruitment administrator 36 retrieves the English oral persuading test record for the selected applicant 14 and calls the English oral persuading test assessment routine of FIG. 32 (block 1232).

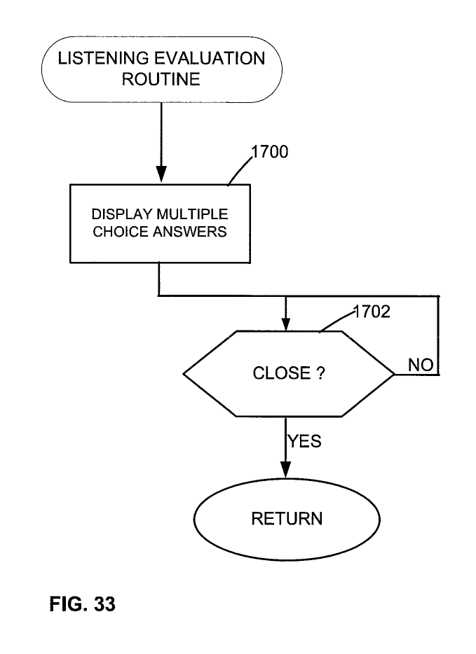

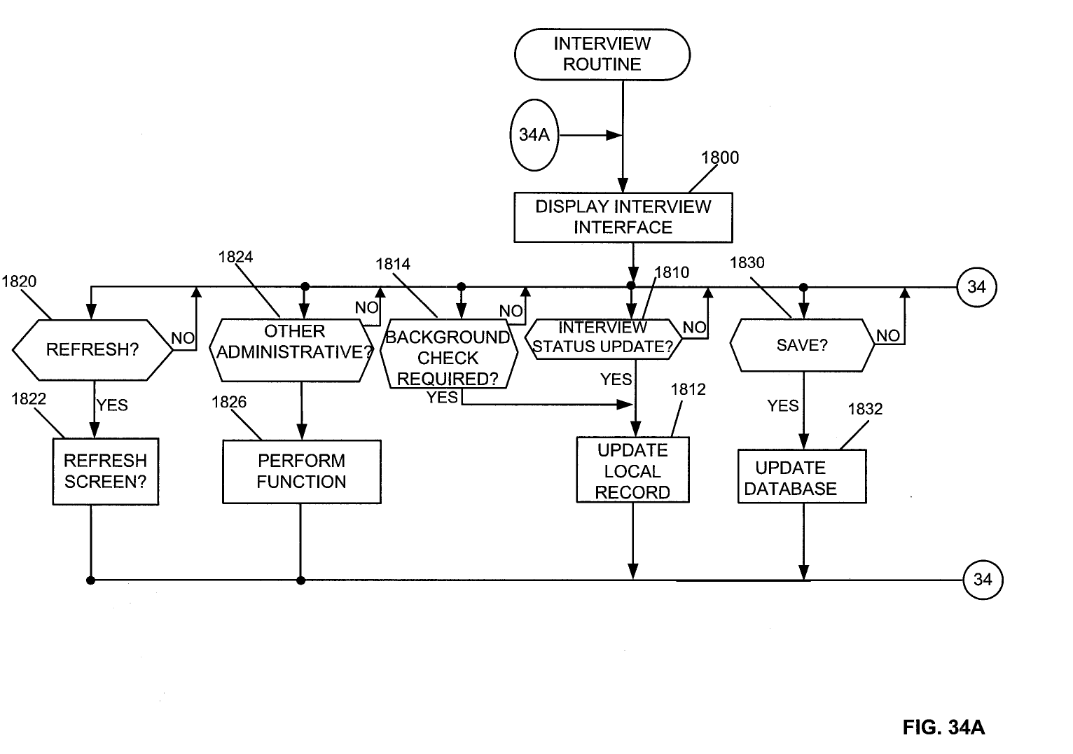

If the recruiter 12 wishes to review and/or score the results of the applicant's English listening test, the recruiter 12 selects the English listening test column. When the recruitment administrator 36 detects selection of the English listening test column (FIG. 28C, block 1234), the recruitment administrator 36 retrieves the English listening test record for the selected applicant 14 and calls the English listening assessment routine of FIG. 33 (block 1236).

If the recruiter 12 wishes to review the results of the applicant's second language written test, the recruiter 12 selects the second language written test column. When the recruitment administrator 36 detects selection of the second language written test column (FIG. 28C, block 1238), the recruitment administrator 36 retrieves the second language written test record for the selected applicant 14 and calls the written test assessment routine of FIG. 30 (block 1240).

If the recruiter 12 wishes to review and/or score the results of the applicant's second language oral reading test, the recruiter 12 selects the second language oral reading test column. When the recruitment administrator 36 detects selection of the second language oral reading test column (FIG. 28D, block 1242), the recruitment administrator 36 retrieves the second language oral reading test record for the selected applicant 14 and calls the second language oral reading test assessment routine (block 1244). Because the second language oral reading test assessment routine is substantially identical to the English oral reading test assessment routine, the second language oral reading test routine is not illustrated herein. Instead, the interested reader is referred to the English oral reading test assessment routine described herein for a full explanation of the second language oral reading test routine.

If the recruiter 12 wishes to review and/or score the results of the applicant's second language listening test, the recruiter 12 selects the second language listening test column. When the recruitment administrator 36 detects selection of the second language listening test column (FIG. 28D, block 1246), the recruitment administrator 36 retrieves the second language listening test record for the selected applicant 14 and calls the second language listening test assessment routine (block 1248). Because the second language listening test assessment routine is substantially identical to the English listening test assessment routine, the second language listening test routine is not illustrated herein. Instead, the interested reader is referred to the English listening test assessment routine described herein for a full explanation of the second language listening test routine.

If the recruiter 12 wishes to review and/or score the results of the applicant's second language oral persuading test, the recruiter 12 selects the second language oral persuading test column. When the recruitment administrator 36 detects selection of the second language oral persuading test column (FIG. 28D, block 1250), the recruitment administrator 36 retrieves the second language oral persuading test record for the selected applicant 14 and calls the second language oral persuading test assessment routine (block 1252). Because the second language oral persuading test assessment routine is substantially identical to the English oral persuading test assessment routine, the second language oral persuading test routine is not illustrated herein. Instead, the interested reader is referred to the English oral persuading test assessment routine described herein for a full explanation of the second language oral persuading test routine.

The details interface 64 of the illustrated example provides various administrative functions. For example, the interface 64 provides a PRINT button and an EXPORT button to enable the recruiter to print displayed records and export records to, for example, a Microsoft Excel spreadsheet, respectively. Thus, if the recruitment administrator 36 detects selection of one of the PRINT, and/or EXPORT buttons (FIG. 28A, block 1260), the recruitment administrator 36 performs the corresponding function (block 1262). Control then returns to block 1200 of FIG. 28A to await further input from the recruiter 12.

If the recruiter 12 wishes to exit the details interface 64 of the illustrated example, the recruiter 12 can select the CLOSE button (FIG. 28B, block 1264). Upon detecting selection of the CLOSE button (block 1264), the recruitment administrator 36 returns control to block 1004 of FIG. 24E.

Assuming, for purposes of discussion, that the recruiter selects the typing test column (block 1210), the recruitment administrator 36 calls the example typing test routine of FIG. 29. The example typing test routine of FIG. 29 begins at block 1300 where the assessor 30 displays the example typing test assessment interface 120 of FIG. 12. If the assessor 30 detects selection of one of the scoring criteria 120 (block 1302), the assessor 30 compares the applicant's typing test score to a threshold (block 1304) and updates the local copy of the applicant's typing test results to reflect a recommended or not recommended status based on that comparison (block 1305). Control then returns to block 1300 to await further input from the recruiter 12.

If the recruiter 12 selects the SAVE button (block 1306), the assessor 30 saves the local copy of the typing test results record to the database 22 (block 1308). Control then returns to block 1300 to await another user input.

If the recruiter 12 wishes to exit the typing test assessment interface 120 of the illustrated example, the recruiter 12 can select the CLOSE button (block 1310). Upon detecting selection of the CLOSE button (block 1310), the assessor 30 displays a message asking if the recruiter 12 wants to exit the assessment process and close the current record without saving any changes made to the same (block 1312). If the recruiter 12 selects a YES button, control returns to block 1200 of FIG. 28A. If, on the other hand, the recruiter 12 selects the NO button (block 1312), control returns to block 1300 (FIG. 29) to await a further input from the recruiter 12.

Assuming, for purposes of discussion, that the recruiter selects the English written test column (FIG. 28A, block 1214) or the second language written test column (FIG. 28C, block 1238), the recruitment administrator 36 calls the example written test assessment routine of FIG. 30. The example written test assessment routine of FIG. 30 begins at block 1400 where the recruitment administrator 36 displays the example written test assessment interface 130 of FIG. 13 including the test data for the default language (e.g., English) of the corresponding applicant. If the recruitment administrator 36 detects selection of the second language tab (block 1402), the recruitment administrator 36 retrieves and displays the applicant's test results for the second language (block 1400). Control then returns to block 1404 to await further input from the recruiter 12.

If the recruiter 12 wishes to exit the written test assessment interface 130 of the illustrated example, the recruiter 12 can select the CLOSE button (block 1406). Upon detecting selection of the CLOSE button (block 1406), the recruitment administrator 36 returns control to block 1200 of FIG. 28A.

Assuming, for purposes of discussion, that the recruiter selects the English oral reading test column (FIG. 28B, block 1210), the recruitment administrator 36 calls the example oral reading assessment routine of FIG. 31. The example oral reading assessment routine of FIG. 31 begins at block 1500 where the oral screener 34 displays the example oral reading assessment interface 140 of FIGS. 15A-15B. If the oral screener 34 detects selection of the PLAY button (block 1502), the oral screener 34 plays the next unscored recorded answer from the applicant's oral reading test results record (block 1504). (In some implementations, the recruiter is able to select which answer he/she wishes to score such that the answers may be scored in any order). If the oral screener 34 detects selection of the STOP button (block 1506), the oral screener 34 stops playing the recorded answer from the applicant's test results record (block 1506), and control returns to block 1500. If the STOP button is not selected (block 1506), the oral screener 34 continues to play the recording until the end of the recording is reached (block 1508). Control then returns to block 1500 to await further input from the recruiter 12.

The recruiter 12 may score the answer as the answer is played. If the oral screener 34 detects an assessment selection (block 1510), the oral screener 34 updates the local copy of the applicant's oral reading test record (block 1512). Control then returns to block 1500 to await further input from the recruiter 12.

If the recruiter 12 selects the SAVE button (block 1520), the oral screener 34 saves the local copy of the applicant's oral reading test record to the database 22 (block 1522). Control then returns to block 1500 to await another user input.

If the recruiter 12 wishes to exit the oral reading assessment interface 140 of the illustrated example, the recruiter 12 can select the CLOSE button (block 1524). Upon detecting selection of the CLOSE button (block 1524), the oral screener 34 displays a message asking if the recruiter 12 wants to exit the assessment process and close the current record without saving any changes made to the same since the last save (block 1526). If the recruiter 12 selects a YES button, control returns to block 1200 of FIG. 28A. If, on the other hand, the recruiter 12 selects the NO button (block 1526), control returns to block 1500 (FIG. 31) to await a further input from the recruiter 12.

Assuming, for purposes of discussion, that the recruiter selects the English oral persuasion test column (FIG. 28B, block 1230), the recruitment administrator 36 calls the example oral persuasion assessment routine of FIG. 32. The example oral persuasion assessment routine of FIG. 32 begins at block 1600 where the oral screener 34 displays the example oral persuasion assessment interface 148 of FIGS. 16A-16B. If the oral screener 34 detects selection of the PLAY button (block 1602), the oral screener 34 plays the next unscored recorded answer from the applicant's oral persuasion test results record (block 1604). (In some implementations, the recruiter is able to select which answer he/she wishes to score such that the answers may be scored in any order). If the oral screener 34 detects selection of the STOP button (block 1606), the oral screener 34 stops playing the recorded answer from the applicant's test results record (block 1606), and control returns to block 1600. If the STOP button is not selected (block 1606), the oral screener 34 continues to play the recording until the end of the recording is reached (block 1608). Control then returns to block 1600 to await further input from the recruiter 12.

If the oral screener 34 detects an assessment selection (block 1610), the oral screener 34 updates the local copy of the applicant's oral persuasion test record (block 1612). Control then returns to block 1600 to await further input from the recruiter 12.

If the recruiter 12 selects the SAVE button (block 1620), the oral screener 34 saves the local copy of the applicant's oral reading test record to the database 22 (block 1622). Control then returns to block 1600 to await another user input.

If the recruiter 12 wishes to exit the oral persuasion assessment interface 148 of the illustrated example, the recruiter 12 can select the CLOSE button (block 1624). Upon detecting selection of the CLOSE button (block 1624), the oral screener 34 displays a message asking if the recruiter 12 wants to exit the assessment process and close the current record without saving any changes made to the same (block 1626). If the recruiter 12 selects a YES button, control returns to block 1200 of FIG. 28A. If, on the other hand, the recruiter 12 selects the NO button (block 1626), control returns to block 1600 (FIG. 32) to await a further input from the recruiter 12.

Assuming, for purposes of discussion, that the recruiter selects the English listening test column (FIG. 28C, block 1234), the recruitment administrator 36 calls the example English listening evaluation assessment routine of FIG. 33. The example English listening evaluation routine of FIG. 33 begins at block 1700 where the assessor 30 displays the example English listening assessment interface 132 of FIG. 14 including the multiple choice answers of the corresponding applicant.

If the recruiter 12 wishes to exit the English listening assessment interface 132 of the illustrated example, the recruiter 12 can select the CLOSE button (block 1702). Upon detecting selection of the CLOSE button (block 1702), the recruitment administrator 36 returns control to block 1200 of FIG. 28A.

Returning to FIG. 24E, if the recruiter 12 selects the interview tab (block 1008), the recruitment administrator 36 calls the example interview routine of FIGS. 34A-34B. As shown in FIG. 34A, the example interview routine begins at block 1800 where the recruitment administrator 36 displays the example interview interface 70 of FIG. 10 (block 1800). The example interview interface enables the recruiter 12 to record the performance of a personal interview with an applicant 14.

To this end, a recruiter 12 can enter one or more search criteria into the applicant search fields of the interview interface 70 and select the SEARCH button to search for an applicant (FIG. 34B, block 1802). Upon detecting selection of the SEARCH button (FIG. 34B, block 1802), the recruitment administrator 36 searches for and retrieves the record(s) corresponding to the search criteria from the database 22 (block 1804). The recruitment administrator 36 displays the search results in the interface 70 and control returns to block 1800 of FIG. 34A to await further input from the recruiter 12.

The interview interface 70 enables a recruiter 12 to enter the date on which a personal interview is conducted with a given applicant 14. Upon detecting such an input (FIG. 34B, block 1806), the recruitment administrator 36 updates the local record of the corresponding applicant (block 1808). Control then returns to block 1800 of FIG. 34A to await further input from the recruiter 12.

The interview interface 70 enables a recruiter 12 to enter the interview status result (e.g., recommended, not recommended, no show) from the personal interview with a given applicant 14. Upon detecting such an input (FIG. 34A, block 1810), the recruitment administrator 36 updates the local record of the corresponding applicant (block 1812). Control then returns to block 1800 of FIG. 34A to await further input from the recruiter 12.

The interview interface 70 also enables a recruiter 12 to indicate whether a background check is required (e.g., yes, no) based on whether the applicant 14 at issue is to fill a part time or full time position. Upon detecting of such an input (FIG. 34A, block 1814), the recruitment administrator 36 updates the local record of the corresponding applicant (block 1812). Control then returns to block 1800 to await further input from the recruiter 12.

The interview interface 70 also enables the recruiter 12 to refresh the screen by selecting a REFRESH button. Upon detecting selection of the REFRESH button (FIG. 34A, block 1820), the recruitment administrator 36 updates the display of the interview interface 70 to reflect any data changes made in the database 22 and/or locally (block 1822). Control then returns to block 1800 to await further input from the recruiter 12.

The interview interface 70 of the illustrated example provides various administrative functions. For example, the interface 70 provides a PRINT button and an EXPORT button to enable the recruiter to print displayed records and export records to, for example, a Microsoft Excel spreadsheet, respectively. Thus, if the recruitment administrator 36 detects selection of one of the PRINT and/or EXPORT buttons (FIG. 34A, block 1824), the recruitment administrator 36 performs the corresponding function (block 1826). Control then returns to block 1800 to await further input from the recruiter 12.

If the recruiter 12 selects the SAVE button (FIG. 34A, block 1830), the recruitment administrator 36 saves the local copy of any open record(s) to the database 22 (block 1832). Control then returns to block 1800 to await another user input.

If the recruiter 12 wishes to exit the interview interface 70 of the illustrated example, the recruiter 12 can select the CLOSE button (FIG. 34B, block 1834). Upon detecting selection of the CLOSE button (block 1834), the recruitment administrator 36 displays a message asking if the recruiter 12 wants to exit the assessment process and close the current record without saving any changes made to the same (block 1836). If the recruiter 12 selects a YES button, control returns to block 1008 of FIG. 24E. If, on the other hand, the recruiter 12 selects the NO button (block 1836), control returns to block 1800 (FIG. 34A) to await a further input from the recruiter 12.

Returning to FIG. 24E, if the recruiter 12 selects the background check tab (block 1012), the recruitment administrator 36 calls the example background check routine of FIGS. 35A-35B. As shown in FIG. 35A, the example background check routine begins at block 1900 where the recruitment administrator 36 displays the example background check interface 66 of FIG. 9 (block 1900). The example background check interface enables the recruiter 12 to update the background check progress and/or requirements with respect to an applicant 14.

To this end, a recruiter 12 can enter one or more search criteria into the applicant search fields of the background check interface 66 and select the SEARCH button to search for an applicant (FIG. 35A, block 1902). Upon detecting selection of the SEARCH button (block 1902), the recruitment administrator 36 searches for and retrieves the record(s) corresponding to the search criteria from the database 22 (block 1904). The recruitment administrator 36 displays the search results in the interface 66 and control returns to block 1900 to await further input from the recruiter 12.

The background check interface 66 enables a recruiter 12 to update the background check status result (e.g., recommended, not recommended, in progress) for a given applicant 14. Upon detecting of such an input (FIG. 35B, block 1910), the recruitment administrator 36 updates the local record of the corresponding applicant (block 1912). Control then returns to block 1900 of FIG. 35A to await further input from the recruiter 12.

The background check interface 66 enables a recruiter 12 to indicate a reason why the applicant 14 failed the background check (e.g., a discrepancy). Upon detecting of such an input (FIG. 35B, block 1911), the recruitment administrator 36 updates the local record of the corresponding applicant (block 1912). Control then returns to block 1900 of FIG. 35A to await further input from the recruiter 12.

The background check interface 66 also enables a recruiter 12 to indicate whether a background check is required (e.g., yes, no) for a given applicant 14. Upon detecting such an input (FIG. 35A, block 1914), the recruitment administrator 36 updates the local record of the corresponding applicant (block 1916). Control then returns to block 1900 to await further input from the recruiter 12.

The background check interface 66 also enables the recruiter 12 to refresh the screen by selecting a REFRESH button. Upon detecting selection of the REFRESH button (FIG. 35A, block 1920), the recruitment administrator 36 updates the display of the background check interface 66 to reflect any data changes made in the database 22 and/or locally (block 1922). Control then returns to block 1900 to await further input from the recruiter 12.

The background check interface 66 of the illustrated example provides various administrative functions. For example, the interface 66 provides a PRINT button and an EXPORT button to enable the recruiter to print displayed records and export records to, for example, a Microsoft Excel spreadsheet, respectively. Thus, if the recruitment administrator 36 detects selection of one of the PRINT and/or EXPORT buttons (FIG. 35A, block 1924), the recruitment administrator 36 performs the corresponding function (block 1926). Control then returns to block 1900 to await further input from the recruiter 12.

If the recruiter 12 selects the SAVE button (FIG. 35A, block 1930), the recruitment administrator 36 saves the local copy of any open record(s) to the database 22 (block 1932). Control then returns to block 1900 to await another user input.

If the recruiter 12 wishes to exit the background check interface 66 of the illustrated example, the recruiter 12 can select the CLOSE button (FIG. 35B, block 1934). Upon detecting selection of the CLOSE button (block 1934), the recruitment administrator 36 displays a message asking if the recruiter 12 wants to exit the assessment process and close the current record without saving any changes made to the same (block 1936). If the recruiter 12 selects a YES button, control returns to block 1012 of FIG. 24E. If, on the other hand, the recruiter 12 selects the NO button (block 1936), control returns to block 1900 (FIG. 35A) to await a further input from the recruiter 12.

Returning to FIG. 24E, if the recruiter 12 selects the offers tab (block 1016), the recruitment administrator 36 calls the example offers routine of FIG. 36. As shown in FIG. 36, the example offers routine begins at block 2000 where the recruitment administrator 36 displays the example offers interface 72 of FIG. 11 (block 2000). The example offers interface enables the recruiter 12 to record the extending of offer(s) and/or the response(s) thereto with respect to applicants 14.

To this end, a recruiter 12 can enter one or more search criteria into the applicant search fields of the offers interface 72 and select the SEARCH button to search for an applicant (block 2002). Upon detecting selection of the SEARCH button (block 2002), the recruitment administrator 36 searches for and retrieves the record(s) corresponding to the search criteria from the database 22 (block 2004). The recruitment administrator 36 displays the search results in the interface 72 and control returns to block 2000 to await further input from the recruiter 12.

The offers interface 72 enables a recruiter 12 to enter the offer details for a given applicant 14. For example, the recruiter 12 can indicate whether an offer has been made, the date the offer was made, whether the offer was accepted or declined, the date of such acceptance or decline, and any reason that the offer was declined. Upon detecting of such an input (block 2010), the recruitment administrator 36 updates the local record of the corresponding applicant (block 2012). Control then returns to block 2000 to await further input from the recruiter 12.

The offers interface 72 of the illustrated example provides various administrative functions. For example, the interface 72 provides a PRINT button and an EXPORT button to enable the recruiter to print displayed records and export records to, for example, a Microsoft Excel spreadsheet, respectively. Thus, if the recruitment administrator 36 detects selection of one of the PRINT and/or EXPORT buttons (block 2024), the recruitment administrator 36 performs the corresponding function (block 2026). Control then returns to block 2000 to await further input from the recruiter 12.

If the recruiter 12 selects the SAVE button (block 2030), the recruitment administrator 36 saves the local copy of any open record(s) to the database 22 (block 2032). Control then returns to block 2000 to await another user input.

If the recruiter 12 wishes to exit the offers interface 72 of the illustrated example, the recruiter 12 can select the CLOSE button (block 2034). Upon detecting selection of the CLOSE button (block 2034), the recruitment administrator 36 displays a message asking if the recruiter 12 wants to exit the assessment process and close the current record without saving any changes made to the same (block 2036). If the recruiter 12 selects a YES button, control returns to block 1016 of FIG. 24E. If, on the other hand, the recruiter 12 selects the NO button (block 2036), control returns to block 2000 (FIG. 36) to await a further input from the recruiter 12.

FIG. 37 is a block diagram of an example computer 2100 capable of implementing the apparatus and methods disclosed herein. The computer 1000 can be, for example, a server, a personal computer, a personal digital assistant (PDA), an Internet appliance, a DVD player, a CD player, a digital video recorder, a personal video recorder, a set top box, or any other type of computing device.

The system 2100 of the instant example includes a processor 2112. For example, the processor 2112 can be implemented by one or more Intel® microprocessors from the Pentium® family, the Itanium® family or the XScale® family. Of course, other processors from other families are also appropriate.

The processor 2112 is in communication with a main memory including a volatile memory 2114 and a non-volatile memory 2116 via a bus 2118. The volatile memory 2114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2116 may be implemented by flash memory and/or any other desired type of memory device. Access to the main memory 2114, 2116 is typically controlled by a memory controller (not shown) in a conventional manner.

The computer 2100 also includes a conventional interface circuit 2120. The interface circuit 2120 may be implemented by any type of well known interface standard, such as an Ethernet interface, a universal serial bus (USB), and/or a third generation input/output (3GIO) interface.

One or more input devices 2122 are connected to the interface circuit 2120. The input device(s) 2122 permit a user to enter data and commands into the processor 2112. The input device(s) can be implemented by, for example, a keyboard, a mouse, a touchscreen, a track-pad, a trackball, isopoint and/or a voice recognition system.

One or more output devices 2124 are also connected to the interface circuit 2120. The output devices 2124 can be implemented, for example, by display devices (e.g., a liquid crystal display, a cathode ray tube display (CRT), a printer and/or speakers). The interface circuit 2120, thus, typically includes a graphics driver card.

The interface circuit 2120 also includes a communication device such as a modem or network interface card to facilitate exchange of data with external computers via a network 2126 (e.g., an Ethernet connection, a digital subscriber line (DSL), a telephone line, coaxial cable, a cellular telephone system, etc.).

The computer 2100 also includes one or more mass storage devices 2128 for storing software and data. Examples of such mass storage devices 2128 include floppy disk drives, hard drive disks, compact disk drives and digital versatile disk (DVD) drives. The mass storage device 1028 may implement the local storage device 62.

From the foregoing, persons of ordinary skill in the art will appreciate that systems and methods to automate a new hiring and assessment process have been disclosed. In an example implementation, system 10 is implemented by a software package (named the Call Center Assessment System (CCAS)) which accommodates all of the assessment formats described above (e.g., the typing skills tests, linguistic skills tests—including capturing voice recordings of the applicants—and the web-based personality inventory). The disclosed example systems and methods are beneficial in that they standardize the assessment for all applicants and provide the ability to score at least portions of the assessment electronically. Further, the results for those portions of the assessment which are scored by human recruiters are also captured electronically and composite scores are created. This composite scoring reduces human error and speeds up the hiring process.

In addition to the CCAS program, an example software package implementation also includes a Call Center Recruitment System (CCRS). This software program (CCRS) provides the recruiter with an automated system for keeping track of the progress of the applicant as he or she proceeds through the complete hiring process from application to hire.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A recruiting system comprising:
an electronic test administrator to present a test to a candidate and to record at least one of the candidate's answers to the test; and
a recruiter interface to provide a recruiter with access to the at least one of the candidate's answers, to facilitate manual scoring of the at least one of the candidate's answers and to receive an assessment of the candidate's speaking voice;
wherein the recruiter interface comprises a voice and speech prescreening interface to receive the assessment of the candidate's speaking voice, and the assessment of the candidate's speaking voice includes an assessment of the candidate's voice quality, articulation, and expression.

2. A system as defined in claim 1 wherein the test comprises a typing test.

3. A system as defined in claim 2 wherein the typing test comprises:
audibly presenting a phrase to the candidate; and
accepting keyboard entries from the candidate, wherein the candidate is requested to type in the audibly presented phrase.

4. A system as defined in claim 3 wherein the phrase comprises at least one of a name and an address.

5. A system as defined in claim 3 wherein the phrase comprises a first phrase spoken in a first geographic accent, and further comprising:
audibly presenting a second phrase to the candidate; and
accepting keyboard entries from the candidate, wherein the candidate is requested to type in the second phrase, and the second phrase is spoken in a second geographic accent.

6. A system as defined in claim 2 wherein the recruiter interface comprises an assessor to provide a typing evaluation interface to facilitate manual scoring of the typing skills test.

7. A system as defined in claim 6 wherein the assessor classifies the candidate as at least one of recommended or not recommended based on the manual scoring of the typing skills test.

8. A system as defined in claim 1 wherein the test comprises an oral reading skills test.

9. A system as defined in claim 8 wherein the oral reading skills test comprises:
presenting a written passage to the candidate;
recording the candidate reading the passage aloud.

10. A system as defined in claim 9 further comprising an oral reading evaluation interface comprising at least one control to at least one of play or stop the recording of the candidate reading the passage aloud and at least one input field to receive a manual score associated with the recording.

11. A system as defined in claim 10 wherein the manual score comprises a score for at least one of articulation, phrasing, pace or tone.

12. A system as defined in claim 10 further comprising an oral screener to classify the candidate as at least one of recommended or not recommended based on the assessment of the manual score associated with the recording.

13. A system as defined in claim 12 wherein the oral screener is to classify the candidate as at least one of recommended or not recommended by converting the assessment of the manual score associated with the recording to a value and comparing the value to a threshold.

14. A system as defined in claim 1 wherein the test comprises an oral listening skills test.

15. A system as defined in claim 14 wherein the oral listening skills test comprises:
audibly presenting a portion of a conversation to the candidate; and
requesting the candidate to select an appropriate answer from a set of answers.

16. A system as defined in claim 15 wherein at least one of the test administrator and an assessor automatically scores the oral listening skills test.

17. A system as defined in claim 1 wherein the test comprises an oral persuading skills test.

18. A system as defined in claim 17 wherein the oral persuading skills test comprises:
presenting the candidate with a set of written responses;
audibly presenting a portion of a conversation to the candidate;
accepting a selection of one of the written responses by the candidate; and
recording the candidate speaking the selected one of the responses.

19. A system as defined in claim 18 further comprising an oral persuasion evaluation interface comprising at least one control to at least one of play or stop the recording of the candidate speaking the selected one of the responses and at least one input field to receive a manual score associated with the recording.

20. A system as defined in claim 19 wherein the manual score comprises a score for at least one of articulation, phrasing, pace or tone.

21. A system as defined in claim 19 further comprising an oral screener to classify the candidate as at least one of recommended or not recommended based on the assessment of the manual score associated with the recording.

22. A system as defined in claim 21 wherein the oral screener is to classify the candidate as at least one of recommended or not recommended by converting the assessment of the manual score associated with the recording to a first value, combining the first value with a second value associated with an automatic scoring of the selection of the written response to create a composite value, and comparing the composite value to a threshold.

23. A system as defined in claim 1 wherein the assessor classifies the candidate as at least one of recommended or not recommended based on the assessment of the candidate's speaking voice.

24. A system as defined in claim 23 wherein the assessor classifies the candidate as at least one of recommended or not recommended by converting the assessment of the candidate's speaking voice to a value and comparing the value to a threshold.

25. A system as defined in claim 1 further comprising:
an assessor to automatically score at least one of: (a) a manual entry of the recruiter, or (b) at least one of the candidate's answers;
a scheduler to facilitate scheduling a test session for the candidate;
an oral screener to facilitate scoring a speaking test; and
a recruitment administrator to provide access to data concerning the at least one candidate.

26. A method of making a hiring recommendation comprising:
presenting a test to a candidate;
recording at least one of the candidate's answers to the test;
providing a recruiter with access to the at least one of the candidate's answers;
receiving an assessment of the candidate's speaking voice.

27. A method as defined in claim 26 wherein the test comprises a typing test and the typing test comprises:
audibly presenting a phrase to the candidate; and
accepting keyboard entries from the candidate, wherein the candidate is requested to type in the audibly presented phrase.

28. A method as defined in claim 27 wherein the phrase comprises at least one of a name and an address.

29. A method as defined in claim 27 wherein the phrase comprises a first phrase spoken in a first geographic accent, and further comprising:
audibly presenting a second phrase to the candidate; and
accepting keyboard entries from the candidate, wherein the candidate is requested to type in the second phrase, and the second phrase is spoken in a second geographic accent.

30. A method as defined in claim 26 wherein the test comprises a written language skills test.

31. A method as defined in claim 26 wherein the test comprises an oral reading skills test, and the oral reading skills test comprises:
presenting a written passage to the candidate;
recording the candidate reading the passage aloud.

32. A method as defined in claim 31 further comprising presenting an oral reading evaluation interface comprising at least one control to at least one of play or stop the recording of the candidate reading the passage aloud and at least one input field to receive a manual score associated with the recording.

33. A method as defined in claim 32 wherein the manual score comprises a score for at least one of articulation, phrasing, pace or tone.

34. A method as defined in claim 32 further comprising classifying the candidate as at least one of recommended or not recommended based on the assessment of the manual score associated with the recording.

35. A method as defined in claim 34 wherein classifying the candidate as at least one of recommended or not recommended comprises converting the assessment of the manual score associated with the recording to a value and comparing the value to a threshold.

36. A method as defined in claim 26 wherein the test comprises an oral listening skills test, and the oral listening skills test comprises:
audibly presenting a portion of a conversation to the candidate; and
requesting the candidate to select an appropriate answer from a set of answers.

37. A method as defined in claim 26 wherein the test comprises an oral persuading skills test, and the oral persuading skills test comprises:
presenting the candidate with a set of written responses;
audibly presenting a portion of a conversation to the candidate;
accepting a selection of one of the written responses by the candidate; and
recording the candidate speaking the selected one of the responses.

38. A method as defined in claim 37 further comprising presenting an oral persuasion evaluation interface comprising at least one control to at least one of play or stop the recording of the candidate speaking the selected one of the responses and at least one input field to receive a manual score associated with the recording.

39. A method as defined in claim 38 wherein the manual score comprises a score for at least one of articulation, phrasing, pace or tone.

40. A method as defined in claim 38 further comprising classifying the candidate as at least one of recommended or not recommended based on the assessment of the manual score associated with the recording.

41. A method as defined in claim 46 wherein classifying the candidate as at least one of recommended or not recommended comprises converting the assessment of the manual score associated with the recording to a first value, combining the first value with a second value associated with an automatic scoring of the selection of the written response to create a composite value, and comparing the composite value to a threshold.

42. A method as defined in claim 26 further comprising presenting a voice and speech prescreening interface to receive the assessment of the candidate's speaking voice, wherein the assessment of the candidate's speaking voice includes an assessment of the candidate's voice quality, articulation, and expression.

43. A method as defined in claim 42 further comprising classifying the candidate as at least one of recommended or not recommended based on the assessment of the candidate's speaking voice.

44. A method as defined in claim 43 wherein classifying the candidate as at least one of recommended or not recommended comprises converting the assessment of the candidate's speaking voice to a value and comparing the value to a threshold.

45. A method as defined in claim 2 wherein the candidate is an applicant for a call center position.

46. A method of facilitating hiring decisions comprising:
presenting a recruiter with a voice quality grading interface to facilitating evaluating a candidate relative to a voice quality criterion;
determining whether to schedule a test session based on the evaluating of the candidate relative to the voice quality criterion;
receiving the candidate's answers to a written test;
automatically scoring the answers to the written test to create an automatic score;
receiving recordings of a candidate's spoken answer to an oral skills test;
presenting the recruiter with an interface to enable manual scoring of the spoken answer;
receiving a manual score of the spoken answer; and
making a hiring recommendation based on the automatic score and the manual score.

47. An article of manufacture comprising machine accessible instructions which, when executed cause a machine to:
present a test to a candidate;
record at least one of the candidate's answers to the test;
provide a recruiter with access to the at least one of the candidate's answers;
receive an assessment of the candidate's speaking voice.
